(19) United States
(12) Patent Application Publication
(10) Pub. No.: US 2022/0241710 A1
(43) Pub. Date: Aug. 4, 2022

(54) CALENDERED NON-WOVEN FIBER WEBS

(71) Applicant: Hollingsworth & Vose Company, East Walpole, MA (US)

(72) Inventors: Narendiran Vitchuli, Roanoke, VA (US); Abdoulaye Doucouré, Roanoke, VA (US); Bruce Smith, Copper Hill, VA (US)

(73) Assignee: Hollingsworth & Vose Company, East Walpole, MA (US)

(21) Appl. No.: 17/165,853

(22) Filed: Feb. 2, 2021

(51) Int. Cl. B01D 39/16

(52) U.S. Cl. CPC B01D 39/1623; B01D 2239/1216; B01D 2239/1233

(57) ABSTRACT

Non-woven fiber webs and articles (e.g., filter media) comprising non-woven fiber webs are generally described. In some embodiments, a non-woven fiber web described herein formed via certain non-wetlaid processes may exhibit enhanced physical properties. For example, a non-woven fiber web may be subjected to a carding (e.g., cross-lapped carding) process. In some cases, the non-woven fiber webs described herein may be calendered to further enhance their physical properties.

### FIELD

The present invention relates generally to non-woven fiber webs, and, more particularly, to non-woven fiber webs comprising synthetic fibers. Some such non-woven fiber webs may be carded and/or calendered.

### BACKGROUND

Non-woven fiber webs may be employed in a variety of applications. For instance, some non-woven fiber webs may be employed in filter media, which themselves may be employed to remove contaminants from fluids. Some non-woven fiber webs may exhibit undesirable properties such as low dust holding capacity, large mean flow pore size, high pore polydispersity, large variation in tensile strength with direction, and/or high surface roughness.

Accordingly, improved non-woven fiber web designs are needed.

### SUMMARY

Non-woven fiber webs, related components, and related methods are generally described.

In some aspects, a carded non-woven fiber web is provided.

In one set of embodiments, the carded non-woven fiber web comprises monocomponent synthetic fibers and multicomponent fibers. The non-woven fiber web has a ratio of maximum pore size to mean flow pore size of less than or equal to 2.5 and the non-woven fiber web comprises fibers having an overall average fiber diameter of less than or equal to 25 microns.

In some aspects, a non-woven fiber web is provided.

In one set of embodiments, the non-woven fiber web comprises monocomponent synthetic fibers and multicomponent fibers. The non-woven fiber web has a ratio of maximum pore size to mean flow pore size of less than or equal to 2.5 and the non-woven fiber web has a ratio of dry tensile strength in a machine direction to dry tensile strength in a cross direction of less than or equal to 2.

In one set of embodiments, the non-woven fiber web comprises monocomponent synthetic fibers and multicomponent fibers. The non-woven fiber web has a ratio of maximum pore size to mean flow pore size of less than or equal to 2.5 and the non-woven fiber web has a surface roughness of less than or equal to 1000 microns.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic depiction of a cross-section of an article, according to one set of embodiments;

FIG. 2 is a schematic depiction of a cross-section of a non-woven fiber web, according to one set of embodiments;

FIG. 3 is a schematic depiction of a cross-section of an article comprising two non-woven fiber webs, according to one set of embodiments;

FIG. 4 is a schematic depiction of a cross-section of an article comprising three non-woven fiber webs, according to one set of embodiments;

FIG. 5A is a schematic depiction of a top-down view of a cross-lapper, according to one set of embodiments;

FIG. 5B is a schematic depiction of a side view of a cross-lapper, according to one set of embodiments; and

FIG. 6 is a schematic depiction showing calendering of a non-woven fiber web, according to one set of embodiments.

### DETAILED DESCRIPTION

Non-woven fiber webs and articles comprising non-woven fiber webs are generally described. In some embodiments, a non-woven fiber web described herein formed via certain non-wetlaid processes may exhibit enhanced physical properties. For example, a non-woven fiber web may be subjected to a carding (e.g., cross-lapped carding) process. In some cases, the non-woven fiber webs described herein may be calendered to further enhance their physical properties.

Non-woven fiber webs (e.g., carded and/or calendered non-woven fiber webs) described herein may have certain advantages that can result in desirable properties for a non-woven fiber web and/or an article (e.g., a filter media). For instance, a non-woven fiber web that has been carded may exhibit enhanced mechanical strength and/or uniformity (e.g., high tensile strength, high tensile strength uniformity in both the cross direction and machine direction) compared to an otherwise identical non-woven fiber web that has not been carded. It is also possible for a non-woven fiber web that has been cross-lapped carded (a process described in further detail below) to exhibit enhanced mechanical strength and/or uniformity in comparison to a non-woven fiber web that has not been cross-lapped carded (e.g., that has been carded but not cross-lapped). In some embodiments, a non-woven fiber web that has been calendered may exhibit enhanced physical properties (e.g., a lower surface roughness, higher water wettability, a more uniform pore size distribution) compared to an otherwise identical non-woven fiber web that has not been calendered. Additionally, when present, these physical properties may result in certain desirable non-woven fiber web and/or article (e.g., filter media) properties (e.g., improved dust holding capacity, improved air permeability, reduced dirt clogging, etc.), as described in more detail below.

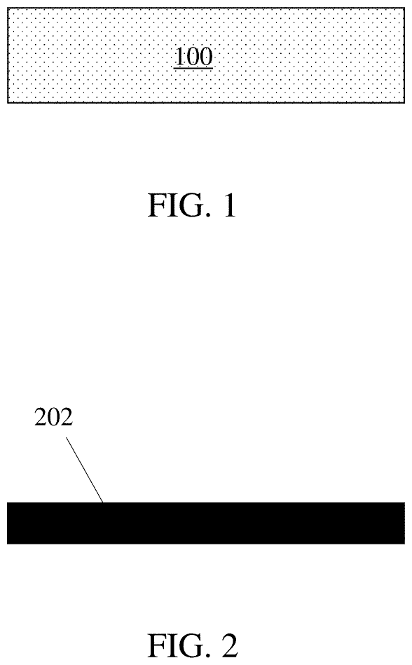

FIG. 1 shows one non-limiting embodiment of an article 100. In some embodiments, the article is a filter media. In some embodiments, an article comprises a non-woven fiber web. FIG. 2 shows one non-limiting example of a non-woven fiber web 202 that may be positioned in an article (e.g., a filter media). The non-woven fiber web 202 may be carded (e.g., cross-lapped carded) and/or calendered.

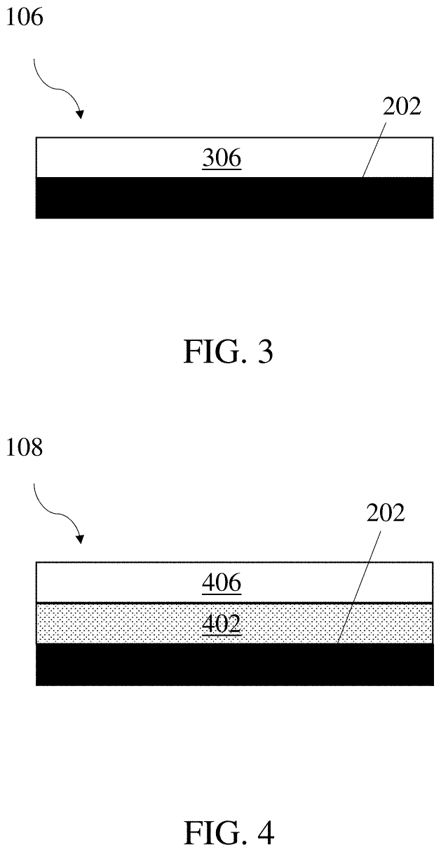

In some embodiments, an article (e.g., filter media) comprises a single layer that is a non-woven fiber web (e.g., as shown in FIG. 2). However, it should be noted that the article may comprise two or more layers that are non-woven fiber webs. For example, in some embodiments, an article comprises two or more layers, one or more of which may be a non-woven fiber web that has been carded and/or calendered. FIG. 3 shows one example of an article (e.g., a filter media) having this property. In FIG. 3, an article 106 comprises a first layer 202 that is a non-woven fiber web and a second layer 306. In some embodiments, an article comprises three or more layers, four or more layers, or even more layers. It should be noted that any additional layers present (e.g., the second layer 306 in FIG. 3) may be non-woven fiber webs or may be types of layers other than non-woven fiber webs. As an example of the former, in some embodiments, an article comprises a solvent spun layer (e.g., an electrospun layer, such as a solution-electrospun layer, a centrifugal spun layer), a melt-electrospun layer, a spunbond layer, and/or a meltblown layer.

It should be noted that the one or more additional layers may be disposed in any suitable location in the article (e.g., filter media). For instance, although FIG. 3 shows an embodiment in which a second layer is disposed directly above a first layer 202 that is a non-woven fiber web, it is also possible for an article to comprise a second layer that is positioned below a first layer that is a non-woven fiber web. In embodiments where an article comprises more than two layers (e.g., three or more layers, etc.), it may comprise one or more non-woven fiber webs (e.g., carded, cross-lapped carded, and/or calendered non-woven fiber webs) disposed between any two layers, on top of one or more layers, and/or below one or more layers. Some, none, or all of these layers may be non-woven fiber webs. As one example, FIG. 4 shows an article 108 (e.g., a filter media) comprising three layers that are non-woven fiber webs. In FIG. 4, a non-woven fiber web 202 is disposed below two other fiber webs 402 and 404. Some articles having the design shown in FIG. 4 may comprise a second non-woven fiber web 402 that is a nanofiber layer and a third non-woven fiber web 406 that is a meltblown or electrospun layer.

One method of fabricating a non-woven fiber web having one or more advantageous properties comprises performing a cross-lapped carding process. During the cross-lapped carding process, non-woven fiber web(s) are first carded and then cross-lapped. Non-woven fiber webs formed by such a process may be referred to herein as “cross-lapped carded non-woven fiber webs”. Without wishing to be bound by any particular theory, it is believed that employing a cross-lapped carding process may allow for the formation of a non-woven fiber web having enhanced strength and/or mechanical properties having enhanced uniformity. For instance, a non-woven fiber web that has been formed by a cross-lapped carding process may exhibit values of tensile strength in the cross direction and machine direction that are fairly similar.

In some embodiments, a method of fabricating a non-woven fiber web having one or more advantageous properties comprises performing a calendering process. Non-woven fiber webs that have been subject to such a process may be referred to as “calendered non-woven fiber webs”. A non-woven fiber web that has been calendered may exhibit enhanced physical properties (e.g., lower surface roughness, higher water wettability, a more uniform distribution of pore sizes) compared to an otherwise identical non-woven fiber web that has not been calendered.

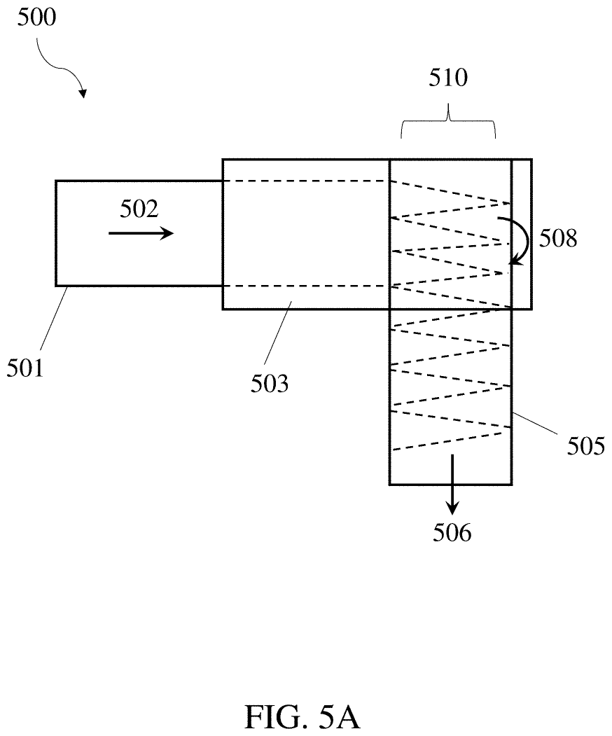

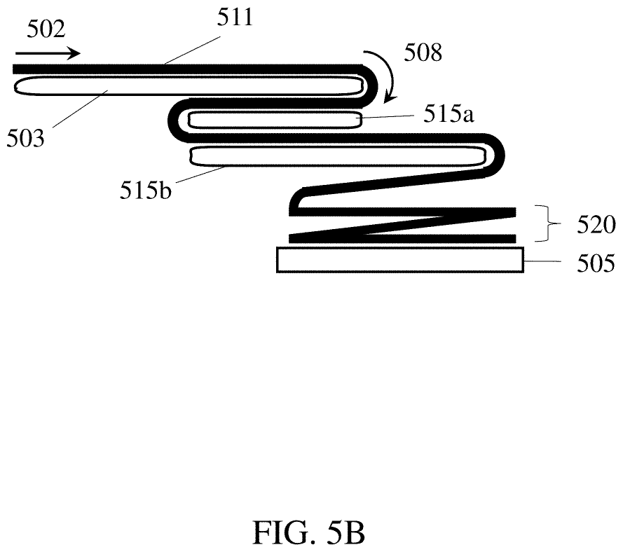

In some embodiments, a non-woven fiber web described herein is manufactured via a dry laid process that uses one or more carding machines. It is also possible for a non-woven fiber web to be manufactured by a process that is non-drylaid and/or that does not use any carding machines. The carding machine(s) may manipulate fibers by rollers and extensions (e.g., hooks, needles) associated with the rollers to form a non-woven fiber web. In some embodiments (e.g., when one carding machine is used), a cross-lapper may also be used. In some such embodiments, a cross-lapper can be used to overlay regions of an intermediate non-woven fiber web produced from a single carding machine to produce a final non-woven fiber web comprising two or more such overlaid regions. During the overlaying process, the cross-lapper may orient the flow of a non-woven fiber web continuously produced by the carding machine such that the overlaying region(s) are oriented perpendicular to region(s) therebeneath. FIG. 5A shows one non-limiting embodiment of an instrument suitable for performing a cross-lapped carding process (a top-down view).

In FIG. 5A, a cross-lapper 500 comprises two conveyor belts 503 and 505 that can be used to overlay regions of an intermediate non-woven fiber web produced by the carding machine 501 to produce a final cross-lapped carded non-woven fiber web. As shown in FIG. 5A, the conveyor belt 503 may translate an intermediate non-woven fiber web in a first direction (e.g., direction 502) at the same time that the conveyor belt 505 translates a cross-lapped carded non-woven fiber web assembled therefrom in a direction perpendicular thereto (e.g., direction 506). The conveyor belt 503 may accept an incoming intermediate non-woven fiber web from the carding machine 501. It may then translate this intermediate non-woven fiber web along the conveyor belt 503 towards the conveyor belt 505 in the direction 502. After being translated by the conveyor belt 503, regions of the intermediate non-woven fiber web may then pass through the folding region 510. The folding region 510 may comprise a series of rolls and/or drums that receive the intermediate non-woven fiber web from the conveyor belt 503. These rolls and/or drums may further comprise wires and/or teeth. Additionally, these rolls and/or drums may be positioned on a support that is configured to further translate the rolls and/or drums along a track parallel to the direction 502. The support may translate the rolls and/or drums along this track in the direction 502 and then, once the end of the track is reached, translate the rolls and/or drums along the track in the reverse direction. This process may be repeated to lay down regions of the incoming intermediate non-woven fiber web on top of each other (e.g., as illustrated by the dotted zigzag lines in FIG. 5A), resulting in formation of a cross-lapped carded non-woven fiber web. Meanwhile, the conveyor belt 505 may serve as a delivery belt that moves the cross-lapped carded non-woven fiber web off of the cross-lapper.

In some embodiments, the cross-lapped carded non-woven fiber web has a machine direction and a cross direction. For example, as used herein, the term “machine direction” refers to a direction (e.g., direction 506) cross-lapped carded non-woven fiber web travels along as it moves off of the cross-lapper, and the term “cross direction” refers to a direction (e.g., a direction that is parallel to direction 502) that is perpendicular to the machine direction. FIG. 5B shows a side-view representation of the instrument described in the preceding paragraph. As shown in FIG. 5B, an incoming intermediate non-woven fiber web 511 may be translated by a conveyor belt 503 and a series of rolls and drums 515a and 515b at a particular line speed in the direction 502. This incoming intermediate non-woven fiber web may be deposited on the conveyor belt 505 such that various regions therein are superimposed on top of each other to form the cross-lapped carded non-woven fiber webs 520.

While FIGS. 5A-5B show one possible arrangement and of a cross-lapper, it should be noted that any appropriate arrangements (e.g., arrangement of conveyor belts, drums and rolls, etc.) may be employed.

It should also be understood that some non-woven fiber webs may be carded but not cross-lapped carded or may be formed by a process other than carding. In such embodiments, the machine direction should be understood to refer to the direction that the non-woven fiber web moves as it moves off of the production line, and the cross direction should be understood to refer to the direction that is perpendicular to the machine direction.

In some embodiments, multiple carding machines may be used during the carding process. In embodiments that utilize multiple carding machines (e.g., 4 or 5 carding machines), the machines may be arranged in series in a carding line. Some carding machines may be designed to separate fibers from impurities, align the fibers, and deliver them to be laid down as a web. The machines can include a series of rolls and/or drums that are covered with multiple projecting wires and/or teeth. Each carding machine in the series can deliver a carded web to a conveyor belt that runs across the series. This conveyor belt may superimpose intermediate carded non-woven fiber webs from successive machines on top of one another to form a final cross-lapped carded non-woven fiber web.

The line speed used during cross-lapped carding may have any of a variety of appropriate values. In some embodiments, the line speed is greater than or equal to 7 ypm (linear yard per minute), greater than or equal to 8 ypm, greater than or equal to 9 ypm, greater than or equal to 10 ypm, greater than or equal to 12.5 ypm, greater than or equal to 15 ypm, or greater than or equal to 20 ypm. In some embodiments, the line speed is less than or equal to 20 ypm, less than or equal to 17.5 ypm, less than or equal to 15 ypm, less than or equal to 12.5 ypm, less than or equal to 10 ypm, less than or equal to 9 ypm, or less than or equal to 8 ypm. Combination of the above-referenced ranges are possible (e.g., greater than or equal to 7 ypm and less than or equal to 20 ypm, greater than or equal to 7 ypm and less than or equal to 15 ypm). Other ranges are also possible.

In some embodiments, the article (e.g., a filter media) and/or non-woven fiber webs described herein (e.g., carded non-woven fiber webs) are calendered. Calendering may involve compressing one or more non-woven fiber webs using calender rolls. In one set of embodiments, calendering may be used to compress a single non-woven fiber web (e.g., a single layer that is a carded non-woven fiber web). In one set of embodiments, calendering may be used to compress two or more non-woven fiber webs (e.g., two or more cross-lapped carded non-woven fiber webs, one or more cross-lapped carded non-woven fiber webs and one or more non-cross-lapped carded non-woven fiber webs) together.

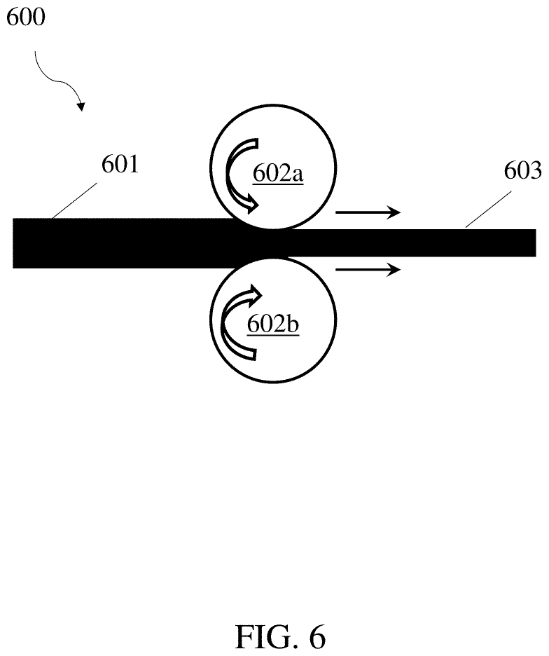

FIG. 6 shows a non-limiting example of a process for calendering one or more non-woven fiber webs. In FIG. 6, the calendering instrument 600 comprises two calender rollers 602a and 602b. In one set of embodiments, the calender rollers may be identical. It is also possible for a calendering process to make use of two dissimilar calender rollers. In one set of embodiments, at least one (e.g., identically one) of the two calender rollers may be crowned. Without wishing to be bound by any particular theory, it is believed that the inclusion of at least one such calender roller may promote the formation of a uniform nip pressure distribution between the rollers. These calender rollers may be positioned parallel to each other and/or rotate in opposite directions at the same angular velocity. When an assembly 601 of one or more non-woven fiber webs is fed into rollers 602a and 602b at, the rollers may compress the assembly 601 into a calendered assembly 603. It should be noted that the assembly 601 fed into the calender rollers may comprise a carded non-woven fiber web (e.g., a cross-lapped carded non-woven fiber web, such as the non-woven fiber web 520 in FIG. 5B), and that the resulting assembly may be used as an article described herein (e.g., filter media) or a component thereof.

A calendered non-woven fiber web (e.g., a non-woven fiber web present in an assembly subject to a calendering process) may have certain advantageous properties. For instance, calendering, in certain cases, may be employed to smooth the surface of non-woven fiber webs, thereby causing them to have relatively low surface roughnesses. Furthermore, calendering may be used to compress non-woven fiber webs to reduce their thicknesses, to reduce their porosities, and/or to form desirable pore structures (e.g., low mean flow pore size, low ratio of maximum pore size to mean flow pore size). A calendered non-woven fiber web may consequently exhibit values of air permeability, air resistance, and/or strength that are improved in comparison to an otherwise-equivalent non-woven fiber web that is uncalendered. Some calendered non-woven fiber webs may exhibit enhanced uniformity in comparison to otherwise-equivalent non-woven fiber webs that are uncalendered.

The working pressure, temperature, and line speed used during calendering may have any of a variety of values. As used herein, the term “working pressure” (or nip pressure) refers to the ratio of the pressure between the calender rolls to the width of the fiber web(s) that are being calendered. In some embodiments, the working pressure applied to the non-woven fiber web(s) may be greater than or equal to 25 N/mm, greater than or equal to 30 N/mm, greater than or equal to 35 N/mm, greater than or equal to 40 N/mm, greater than or equal to 45 N/mm, greater than or equal to 50 N/mm, greater than or equal to 55 N/mm, greater than or equal to 60 N/mm, greater than or equal to 65 N/mm, greater than or equal to 70 N/mm, greater than or equal to 75 N/mm, greater than or equal to 85 N/mm, greater than or equal to 95 N/mm, greater than or equal to 105 N/mm, or greater than or equal to 115 N/mm. In some embodiments, the working pressure applied to the non-woven fiber web(s) may be less than or equal to 120 N/mm, less than or equal to 115 N/mm, less than or equal to 105 N/mm, less than or equal to 95 N/mm, less than or equal to 85 N/mm, less than or equal to 75 N/mm, less than or equal to 70 N/mm, less than or equal to 65 N/mm, less than or equal to 60 N/mm, less than or equal to 55 N/mm, less than or equal to 50 N/mm, less than or equal to 45 N/mm, less than or equal to 40 N/mm, less than or equal to 35 N/mm, or less than or equal to 30 N/mm. Combinations of the above-referenced ranges are also possible (e.g., greater than or equal to 25 N/mm and less than or equal to 120 N/mm, greater than or equal to 35 N/mm and less than or equal to 105 N/mm, or greater than or equal to 40 N/mm and less than or equal to 75 N/mm). Other ranges are also possible.

During calendering, heat may be applied to the non-woven fiber web(s) being calendered. In some embodiments, the heat is applied by one or both of the calender rolls. In some embodiments, the temperature of one or both calender rolls may be greater than or equal to 23° C., greater than or equal to 40° C., greater than or equal to 60° C., greater than or equal to 80° C., greater than or equal to 100° C., greater than or equal to 120° C., greater than or equal to 140° C., greater than or equal to 160° C., greater than or equal to 180° C., greater than or equal to 200° C., or greater than or equal to 220° C. In some embodiments, the temperature of one or both calender rolls may be less than or equal to 240° C., less than or equal to 220° C., less than or equal to 200° C., less than or equal to 180° C., less than or equal to 160° C., less than or equal to 140° C., less than or equal to 120° C., less than or equal to 100° C., less than or equal to 80° C., less than or equal to 60° C., or less than or equal to 40° C. Combinations of the above-referenced ranges are also possible (e.g., greater than or equal to 23° C. and less than or equal to 240° C., greater than or equal to 80° C. and less than or equal to 180° C., or greater than or equal to 100° C. and less than or equal to 160° C.). Other ranges are also possible.

The temperature of a calender roll may be measured at its outer edge.

In some embodiments, the speed at which an assembly is translated during calendering may be greater than or equal to 5 ft/min, greater than or equal to 10 ft/min, greater than or equal to 15 ft/min, greater than or equal to 20 ft/min, greater than or equal to 30 ft/min, greater than or equal to 45 ft/min, greater than or equal to 60 ft/min, greater than or equal to 75 ft/min, or greater than or equal to 90 ft/min. In some embodiments, the speed at which an assembly is translated during calendering may be less than or equal to 100 ft/min, less than or equal to 90 ft/min, less than or equal to 75 ft/min, less than or equal to 60 ft/min, less than or equal to 45 ft/min, less than or equal to 30 ft/min, less than or equal to 20 ft/min, less than or equal to 15 ft/min, or less than or equal to 10 ft/min. Combinations of the above-referenced ranges are also possible (e.g., greater than or equal to 5 ft/min and less than or equal to 100 ft/min, greater than or equal to 10 ft/min and less than or equal to 75 ft/min, or greater than or equal to 20 ft/min and less than or equal to 60 ft/min). Other ranges are also possible.

As described above, in some embodiments, an article comprises one or more non-woven fiber webs that have one or more advantageous physical properties. Such non-woven fiber webs may be referred to herein as non-woven fiber webs of the first type. Some such non-woven fiber webs may be carded, cross-lapped carded, and/or calendered as described above. Some such non-woven fiber webs are not carded, not cross-lapped carded, and/or not calendered. Further details of such non-woven fiber webs are described below.

In some embodiments, a non-woven fiber web of the first type described herein comprises a relatively low overall average fiber diameter. In other words, the average of the diameters of all of the fibers in the non-woven fiber web of the first type may be relatively low. In some embodiments, a non-woven fiber web of the first type has an overall fiber diameter of less than or equal to 25 microns, less than or equal to 23 microns, less than or equal to 21 microns, less than or equal to 19 microns, less than or equal to 17 microns, less than or equal to 15 microns, less than or equal to 13 microns, less than or equal to 11 microns, less than or equal to 9 microns, less than or equal to 7 microns, less than or equal to 5 microns, or less than or equal to 3 microns. In some embodiments, a non-woven fiber web of the first type has an overall fiber diameter of greater than or equal to 2 microns, greater than or equal to 3 microns, greater than or equal to 5 microns, greater than or equal to 7 microns, greater than or equal to 9 microns, greater than or equal to 11 microns, greater than or equal to 13 microns, greater than or equal to 15 microns, greater than or equal to 17 microns, greater than or equal to 19 microns, greater than or equal to 21 microns, or greater than or equal to 23 microns. Combinations of the above-referenced ranges are also possible (e.g., greater than or equal to 2 microns and less than or equal to 25 microns, or greater than or equal to 7 microns and less than or equal to 25 microns). Other ranges are also possible.

When an article comprises two or more non-woven fiber webs of the first type, each non-woven fiber web of the first type may independently have an overall average fiber diameter in one or more of the ranges described above.

Synthetic fibers may make up a variety of suitable amounts of the non-woven fiber webs of the first type described herein. In some embodiments, synthetic fibers make up greater than or equal to 0.1 wt %, greater than or equal to 1 wt %, greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, greater than or equal to 90 wt %, greater than or equal to 95 wt %, greater than or equal to 99 wt %, or greater than or equal to 99.9 wt % of a non-woven fiber web of the first type. In some embodiments, synthetic fibers make up less than or equal to 100 wt %, less than or equal to 99.9 wt %, less than or equal to 95 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, or less than or equal to 1 wt % of a non-woven fiber web of the first type. Combinations of the above-referenced ranges are also possible (e.g., greater than or equal to 0.1 wt % and less than or equal to 100 wt %, or greater than or equal to 95 wt % and less than or equal to 100 wt %, or greater than or equal to 99 wt % and less than or equal to 100 wt %). Other ranges are also possible. In some embodiments, synthetic fibers make up identically 100 wt % of a non-woven fiber web of the first type.

When a non-woven fiber web of the first type comprises two or more types of synthetic fibers, each type of synthetic fiber may independently make up an amount of the non-woven fiber web of the first type in one or more of the ranges described above and/or all of the synthetic fibers in a non-woven fiber web may together make up an amount of the non-woven fiber web of the first type in one or more of the ranges described above. Similarly, when an article comprises two or more non-woven fiber webs of the first type, each non-woven fiber web of the first type may independently comprise an amount of any particular type of synthetic fiber in one or more of the ranges described above and/or may comprise a total amount of synthetic fibers in one or more of the ranges described above.

Non-limiting examples of suitable materials that may be included in synthetic fibers include poly(ester)s and co-poly(ester)s (e.g., poly(ethylene terephthalate), co-poly(ethylene terephthalate), poly(butylene terephthalate), poly(ethylene isophthalate)), poly(lactic acid), poly(carbonate), poly(amide)s and co-poly(amide)s (e.g., various nylon polymers, various aramid polymers), poly(aramid)s, poly(imide)s, poly(olefin)s (e.g., poly(ethylene), poly(propylene), poly(butylene)), poly(ether ether ketone), poly(acrylic)s (e.g., poly(acrylonitrile), dryspun poly(acrylic)), poly(vinyl alcohol), regenerated cellulose (e.g., synthetic cellulose such cellulose acetate, rayon), halogenated and/or fluorinated polymers (e.g., poly(vinylidene difluoride) (PVDF), poly(tetrafluoroethylene)), copolymers of poly(ethylene) and PVDF, poly(ether sulfone)s, epoxy, phenolic resins, and melamine.

Suitable co-poly(ethylene terephthalate)s may comprise repeat units formed by the polymerization of ethylene terephthalate monomers and further comprise repeat units formed by the polymerization of one or more comonomers. Such comonomers may include linear, cyclic, and branched aliphatic dicarboxylic acids having 4-12 carbon atoms (e.g., butanedioic acid, pentanedioic acid, hexanedioic acid, dodecanedioic acid, and 1,4-cyclo-hexanedicarboxylic acid); aromatic dicarboxylic acids having 8-12 carbon atoms (e.g., isophthalic acid and 2,6-naphthalenedicarboxylic acid); linear, cyclic, and branched aliphatic diols having 3-8 carbon atoms (e.g., 1,3-propane diol, 1,2-propanediol, 1,4-butanediol, 3-methyl-1,5-pentanediol, 2,2-dimethyl-1,3-propanediol, 2-methyl-1,3-propanediol, and 1,4-cyclohexanediol); and/or aliphatic and aromatic/aliphatic ether glycols having 4-10 carbon atoms (e.g., hydroquinone bis(2-hydroxyethyl) ether and poly(ethylene ether) glycols having a molecular weight below 460 g/mol, such as diethylene ether glycol).

Synthetic fibers in a non-woven fiber web of the first type may have any of a variety of suitable fiber diameters. In some embodiments, the synthetic fibers have an average fiber diameter of greater than or equal to 5 microns, greater than or equal to 7 microns, greater than or equal to 8 microns, greater than or equal to 9 microns, greater than or equal to 9.5 microns, greater than or equal to 10 microns, greater than or equal to 10.5 microns, greater than or equal to 11 microns, greater than or equal to 11.5 microns, greater than or equal to 12 microns, greater than or equal to 13 microns, greater than or equal to 14 microns, greater than or equal to 15 microns, greater than or equal to 17 microns, greater than or equal to 19 microns, greater than or equal to 21 microns, greater than or equal to 23 microns, greater than or equal to 25 microns, greater than or equal to 30 microns, or greater than or equal to 35 microns. In some embodiments, the synthetic fibers have an average fiber diameter of less than or equal to 40 microns, less than or equal to 35 microns, less than or equal to 30 microns, less than or equal to 25 microns, less than or equal to 23 microns, less than or equal to 21 microns, less than or equal to 19 microns, less than or equal to 17 microns, less than or equal to 15 microns, less than or equal to 14 microns, less than or equal to 13 microns, less than or equal to 12 microns, less than or equal to 11.5 microns, less than or equal to 11 microns, less than or equal to 10.5 microns, less than or equal to 10 microns, less than or equal to 9.5 microns, less than or equal to 9 microns, less than or equal to 8 microns, or less than or equal to 7 microns. Combinations of the above-referenced ranges are also possible (e.g., greater than or equal to 5 microns and less than or equal to 40 microns, greater than or equal to 7 microns and less than or equal to 25 microns, greater than or equal to 7 microns and less than or equal to 11.5 microns, or greater than or equal to 11.5 microns and less than or equal to 25 microns). Other ranges are also possible.

When a non-woven fiber web of the first type comprises two or more types of synthetic fibers, each type of synthetic fiber may independently have an average fiber diameter in one or more of the ranges described above and/or all of the synthetic fibers in a non-woven fiber web may together have an average fiber diameter in one or more of the ranges described above. Similarly, when an article comprises two or more non-woven fiber webs of the first type, each non-woven fiber web of the first type may independently comprise one or more types of synthetic fibers having an average diameter in one or more of the ranges described above and/or may comprise synthetic fibers that together have an average fiber diameter in one or more of the ranges described above.

Monocomponent synthetic fibers may make up a variety of suitable amounts of the non-woven fiber webs of the first type described herein. In some embodiments, monocomponent synthetic fibers make up greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, or greater than or equal to 85 wt % of a non-woven fiber web of the first type. In some embodiments, monocomponent synthetic fibers make up less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, or less than or equal to 15 wt % of a non-woven fiber web of the first type. Combinations of the above-referenced ranges are also possible (e.g., greater than or equal to 10 wt % and less than or equal to 90 wt %, or greater than or equal to 20 wt % and less than or equal to 80 wt %, or greater than or equal to 35 wt % and less than or equal to 45 wt %). Other ranges are also possible.

When a non-woven fiber web of the first type comprises two or more types of monocomponent synthetic fibers, each type of monocomponent synthetic fiber may independently make up an amount of the non-woven fiber web of the first type in one or more of the ranges described above and/or all of the monocomponent synthetic fibers in a non-woven fiber web of the first type may together make up an amount of the non-woven fiber web of the first type in one or more of the ranges described above. Similarly, when an article comprises two or more non-woven fiber webs of the first type, each non-woven fiber web of the first type may independently comprise an amount of any particular type of monocomponent synthetic fiber in one or more of the ranges described above and/or may comprise a total amount of monocomponent synthetic fibers in one or more of the ranges described above.

Monocomponent synthetic fibers in a non-woven fiber web of first type may have a variety of suitable dimensions. In some embodiments, the monocomponent synthetic fibers have an average fiber diameter of greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, greater than or equal to 12 microns, greater than or equal to 13.5 microns, greater than or equal to 15 microns, greater than or equal to 17.5 microns, greater than or equal to 20 microns, greater than or equal to 25 microns, greater than or equal to 30 microns, or greater than or equal to 35 microns. In some embodiments, the monocomponent synthetic fibers an average fiber diameter of less than or equal to 40 microns, less than or equal to 35 microns, less than or equal to 30 microns, less than or equal to 25 microns, less than or equal to 20 microns, less than or equal to 17.5 microns, less than or equal to 15 microns, less than or equal to 13.5 microns, less than or equal to 12 microns, less than or equal to 11 microns, less than or equal to 10 microns, less than or equal to 9 microns, less than or equal to 8 microns, less than or equal to 7 microns, or less than or equal to 6 microns. Combinations of the above-referenced ranges are also possible (e.g., greater than or equal to 5 microns and less than or equal to 40 microns, greater than or equal to 7 microns and less than or equal to 20 microns, or greater than or equal to 9 microns and less than or equal to 12 microns). Other ranges are also possible.

When a non-woven fiber web of the first type comprises two or more types of monocomponent synthetic fibers, each type of monocomponent synthetic fiber may independently have an average fiber diameter in one or more of the ranges described above and/or all of the monocomponent synthetic fibers in a non-woven fiber web of the first type may together have an average fiber diameter in one or more of the ranges described above. Similarly, when an article comprises two or more non-woven fiber webs of the first type, each non-woven fiber web of the first type may independently comprise one or more types of monocomponent synthetic fibers having an average fiber diameter in one or more of the ranges described above and/or may comprise monocomponent synthetic fibers that overall have an average fiber diameter in one or more of the ranges described above.

Monocomponent synthetic fibers may have a variety of suitable average lengths. Some monocomponent fibers suitable for inclusion in the non-woven fiber webs of the first type described herein may be staple fibers. In some embodiments, a non-woven fiber web of the first type comprises monocomponent synthetic fibers having an average length of greater than or equal to 1 inch, greater than or equal to 1.1 inches, greater than or equal to 1.15 inches, greater than or equal to 1.2 inches, greater than or equal to 1.25 inches, greater than or equal to 1.3 inches, greater than or equal to 1.35 inches, greater than or equal to 1.4 inches, greater than or equal to 1.45 inches, greater than or equal to 1.5 inches, greater than or equal to 1.55 inches, greater than or equal to 1.6 inches, greater than or equal to 1.65 inches, greater than or equal to 1.7 inches, greater than or equal to 1.75 inches, greater than or equal to 1.8 inches, greater than or equal to 1.9 inches, greater than or equal to 2 inches, greater than or equal to 2.1 inches, greater than or equal to 2.2 inches, greater than or equal to 2.3 inches, greater than or equal to 2.4 inches, greater than or equal to 2.6 inches, or greater than or equal to 2.8 inches. In some embodiments, a non-woven fiber web of the first type comprises monocomponent synthetic fibers having an average length of less than or equal to 3 inches, less than or equal to 2.8 inches, less than or equal to 2.6 inches, less than or equal to 2.5 inches, less than or equal to 2.4 inches, less than or equal to 2.3 inches, less than or equal to 2.2 inches, less than or equal to 2.1 inches, less than or equal to 2 inches, less than or equal to 1.9 inches, less than or equal to 1.8 inches, less than or equal to 1.75 inches, less than or equal to 1.7 inches, less than or equal to 1.65 inches, less than or equal to 1.6 inches, less than or equal to 1.55 inches, less than or equal to 1.5 inches, less than or equal to 1.45 inches, less than or equal to 1.4 inches, less than or equal to 1.35 inches, less than or equal to 1.3 inches, less than or equal to 1.25 inches, less than or equal to 1.2 inches, less than or equal to 1.15 inches, less than or equal to 1.1 inches, or less than or equal to 1.05 inches. Combinations of the above-referenced ranges are also possible (e.g., greater than or equal to 1 inch and less than or equal to 3 inches, greater than or equal to 1.2 inches and less than or equal to 2 inches, or greater than or equal to 1.45 inches and less than or equal to 1.75 inches). Other ranges are also possible.

It should be understood that a non-woven fiber web of the first type may include a plurality of monocomponent synthetic fibers and that the values above describe the average fiber diameter for the fibers in this plurality. In other words, it is possible for a plurality of monocomponent synthetic fibers having an average fiber diameter in one or more of the above-referenced ranges to comprise monocomponent synthetic fibers shorter than the average (e.g., having a smaller fiber diameter than any of those listed above) and/or monocomponent synthetic fibers longer than the average (e.g., having a larger fiber diameter than any of those listed above.

When a non-woven fiber web of the first type comprises two or more types of monocomponent synthetic fibers, each type of monocomponent synthetic fiber may independently have an average length in one or more of the ranges described above and/or all of the monocomponent synthetic fibers in a non-woven fiber web of the first type may together have an average length in one or more of the ranges described above. Similarly, when an article comprises two or more non-woven fiber webs of the first type, each non-woven fiber web of the first type may independently comprise one or more types of monocomponent synthetic fibers having an average fiber length in one or more of the ranges described above and/or may comprise monocomponent synthetic fibers that overall have an average fiber length in one or more of the ranges described above.

Monocomponent fibers may comprise any one or more of a variety of synthetic fiber materials described elsewhere herein.

In some embodiments, a non-woven fiber web of the first type comprises binder fibers. In some such embodiments, the binder fibers comprise multicomponent fibers. The multicomponent fibers may comprise bicomponent fibers (i.e., fibers including two components), may comprise tricomponent fibers (i.e., fibers including three components), and/or may comprise fibers comprising four or more components. In some such embodiments, the multicomponent fibers may include one type of multicomponent fibers (e.g., exclusively one type of bicomponent fibers, exclusively one type of tricomponent fibers) or more than one type of multicomponent fibers (e.g., both bicomponent fibers and tricomponent fibers, two types of bicomponent fibers, two types of tricomponent fibers). In some such embodiments, a non-woven fiber web of the first type comprises multicomponent fibers that serve as a binder that binds fibers within the non-woven fiber web of the first type together.

The non-woven fiber webs of the first type described herein may comprise multicomponent fibers in a variety of suitable amounts. In some embodiments, multicomponent fibers make up greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, greater than or equal to 90 wt %, or greater than or equal to 95 wt % of a non-woven fiber web of the first type. In some embodiments, multicomponent fibers make up less than or equal to 100 wt %, less than or equal to 95 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, or less than or equal to 15 wt % of a non-woven fiber web of the first type. Combinations of the above-referenced ranges are also possible (e.g., greater than or equal to 10 wt % and less than or equal to 100 wt %, greater than or equal to 20 wt % and less than or equal to 80 wt %, or greater than or equal to 55 wt % and less than or equal to 65 wt %). Other ranges are also possible. In some embodiments, multicomponent fibers make up identically 100 wt % of a non-woven fiber web of the first type.

When a non-woven fiber web of the first type comprises two or more types of multicomponent fibers, each type of multicomponent fiber may independently make up an amount of the non-woven fiber web of the first type in one or more of the ranges described above and/or all of the multicomponent fibers in a non-woven fiber web of the first type may together make up an amount of the non-woven fiber web in one or more of the ranges described above. Similarly, when an article comprises two or more non-woven fiber webs of the first type, each non-woven fiber web of the first type may independently comprise an amount of any particular type of multicomponent fiber in one or more of the ranges described above and/or may comprise a total amount of multicomponent fibers in one or more of the ranges described above.

Multicomponent fibers may have a variety of suitable structures. For instance, a non-woven fiber web of the first type may comprise one or more of the following types of bicomponent fibers: core/sheath fibers (e.g., concentric core/sheath fibers, non-concentric core-sheath fibers), segmented pie fibers, side-by-side fibers, tip-trilobal fibers, split fibers, and “island in the sea” fibers. Core-sheath bicomponent fibers may comprise a sheath that has a lower melting point than that of the core. When heated (e.g., during a binding step), the sheath may melt prior to the core, binding the bicomponent fibers together while the core remains solid. In such embodiments, the bicomponent fibers may serve as a binder for the non-woven fiber web of the first type.

Non-limiting examples of suitable materials that may be included in multicomponent fibers include poly(olefin)s such as poly(ethylene), poly(propylene), and poly(butylene); poly(ester)s and co-poly(ester)s such as poly(ethylene terephthalate), co-poly(ethylene terephthalate), poly(butylene terephthalate), and poly(ethylene isophthalate); poly(amide)s and co-poly(amides) such as nylons and aramids; halogenated polymers such as poly(tetrafluoroethylene); epoxy; phenolic resins; and melamine. Suitable co-poly(ethylene terephthalate)s include those described elsewhere herein with respect to co-poly(ethylene terephthalate)s suitable for inclusion in synthetic fibers.

As can be seen from the preceding paragraph, multicomponent fibers may comprise one or more components that are synthetic. In such embodiments, the multicomponent fibers may be considered to be a type of synthetic fiber.

Non-limiting examples of suitable pairs of materials that may be included in bicomponent fibers include poly(ethylene)/poly(ester) (e.g., poly(ethylene)/poly(ethylene terephthalate)), poly(propylene)/poly(ester) (e.g., poly(propylene)/poly(ethylene terephthalate)), co-poly(ester)/poly(ester) (e.g., co-poly(ethylene terephthalate)/poly(ethylene terephthalate)), poly(butylene terephthalate)/poly(ethylene terephthalate), co-poly(amide)/poly(amide), poly(amide)/poly(propylene), and poly(ethylene)/poly(propylene). In the preceding list, the material having the lower melting point is listed first and the material having the higher melting point is listed second. Core-sheath bicomponent fibers comprising one of the above such pairs may have a sheath comprising the first material and a core comprising the second material. In one set of embodiments, core-sheath bicomponent fibers may comprise a core that comprises a thermoset polymer and a sheath that comprises a thermoplastic polymer.

The multicomponent fibers described herein may comprise components having a variety of suitable melting points. In some embodiments, a multicomponent fiber comprises a component having a melting point of greater than or equal to 70° C., greater than or equal to 80° C., greater than or equal to 90° C., greater than or equal to 100° C., greater than or equal to 110° C., greater than or equal to 120° C., greater than or equal to 130° C., greater than or equal to 140° C., greater than or equal to 150° C., greater than or equal to 160° C., greater than or equal to 170° C., greater than or equal to 180° C., greater than or equal to 190° C., greater than or equal to 200° C., greater than or equal to 210° C., or greater than or equal to 220° C., greater than or equal to 250° C., greater than or equal to 300° C., greater than or equal to 250° C., greater than or equal to 300° C., greater than or equal to 350° C., or greater than or equal to 400° C. In some embodiments, a multicomponent fiber comprises a component having a melting point of less than or equal to 450° C., less than or equal to 400° C., less than or equal to 350° C., less than or equal to 300° C., less than or equal to 250° C., less than or equal to 220° C., less than or equal to 210° C., less than or equal to 200° C., less than or equal to 190° C., less than or equal to 180° C., less than or equal to 170° C., less than or equal to 160° C., less than or equal to 150° C., less than or equal to 140° C., less than or equal to 130° C., less than or equal to 120° C., less than or equal to 110° C., less than or equal to 100° C., less than or equal to 90° C., or less than or equal to 80° C. Combinations of the above-referenced ranges are also possible (e.g., greater than or equal to 70° C. and less than or equal to 450° C., greater than or equal to 80° C. and less than or equal to 450° C., greater than or equal to 80° C. and less than or equal to 230° C., or greater than or equal to 110° C. and less than or equal to 230° C.). Other ranges are also possible. In some embodiments, a multicomponent fiber comprises a component having a melting point of less than or equal to 100° C.

The melting point of the components of a multicomponent fiber may be determined by performing differential scanning calorimetry (DSC) according to standard ASTM D3418 (2015).

Each component of a multicomponent fiber may independently have a melting point in one or more of the above-referenced ranges. Multicomponent fibers may comprise exclusively components having the same melting point, exclusively components having different melting points, or at least one pair of components that have the same melting point and at least one pair of components that have different melting points.

In some embodiments, a multicomponent fiber comprises two components that have melting points that differ by greater than or equal to 50° C., greater than or equal to 75° C., greater than or equal to 100° C., greater than or equal to 125° C., greater than or equal to 150° C., greater than or equal to 175° C., greater than or equal to 200° C., greater than or equal to 225° C., greater than or equal to 250° C., greater than or equal to 275° C., greater than or equal to 300° C., greater than or equal to 325° C., or greater than or equal to 350° C. In some embodiments, a multicomponent fiber comprises two components that have melting points that differ by less than or equal to 380° C., less than or equal to 350° C., less than or equal to 325° C., less than or equal to 300° C., less than or equal to 275° C., less than or equal to 250° C., less than or equal to 225° C., less than or equal to 200° C., less than or equal to 175° C., less than or equal to 150° C., less than or equal to 125° C., less than or equal to 100° C., or less than or equal to 75° C. Combinations of the above-referenced ranges are also possible (e.g., greater than or equal to 50° C. and less than or equal to 75° C.). Other ranges are also possible.

Multicomponent fibers may have a variety of suitable percent crystallinities. In some embodiments, a non-woven fiber web of the first type comprises multicomponent fibers that have a percent crystallinity of greater than or equal to 1%, greater than or equal to 2.5%, greater than or equal to 5%, greater than or equal to 7.5%, greater than or equal to 10%, greater than or equal to 15%, greater than or equal to 20%, greater than or equal to 25%, greater than or equal to 30%, greater than or equal to 35%, greater than or equal to 40%, or greater than or equal to 45%. In some embodiments, a non-woven fiber web of the first type comprises multicomponent fibers that have a percent crystallinity of less than or equal to 50%, less than or equal to 45%, less than or equal to 40%, less than or equal to 35%, less than or equal to 30%, less than or equal to 25%, less than or equal to 20%, less than or equal to 15%, less than or equal to 10%, less than or equal to 7.5%, less than or equal to 5%, or less than or equal to 2.5%. Combinations of the above-referenced ranges are also possible (e.g., greater than or equal to 1% and less than or equal to 50%, greater than or equal to 5% and less than or equal to 40%, greater than or equal to 10% and less than or equal to 20%). Other ranges are also possible.

The percent crystallinity of a multicomponent fiber may be determined by performing differential scanning calorimetry according to standard ASTM F2625-10 (2016).

Each component of a multicomponent fiber may independently have a percent crystallinity in one or more of the above-referenced ranges. Additionally, some multicomponent fibers may have an overall percent crystallinity in one or more of the above-referenced ranges. Multicomponent fibers may comprise exclusively components having the same percent crystallinity, exclusively components having different percent crystallinities, or at least one pair of components that have the same percent crystallinity and at least one pair of components that have different percent crystallinities. In some embodiments, a core/sheath bicomponent fiber comprises a core having a crystallinity in one or more of the above-referenced ranges and a sheath that is identically 0% crystalline.

When an article comprises two or more non-woven fiber webs of the first type, each non-woven fiber web of the first type may independently comprise one or more of the above-described types of multicomponent fibers.

Multicomponent fibers may have a variety of suitable average fiber diameters. In some embodiments, a non-woven fiber web of the first type comprises multicomponent fibers having an average fiber diameter of greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, greater than or equal to 12 microns, greater than or equal to 13.5 microns, greater than or equal to 15 microns, greater than or equal to 17.5 microns, greater than or equal to 20 microns, greater than or equal to 22.5 microns, greater than or equal to 25 microns, greater than or equal to 27.5 microns, greater than or equal to 30 microns, greater than or equal to 32.5 microns, greater than or equal to 35 microns, or greater than or equal to 37.5 microns. In some embodiments, a non-woven fiber web of the first type comprises multicomponent fibers having an average fiber diameter of less than or equal to 40 microns, less than or equal to 37.5 microns, less than or equal to 35 microns, less than or equal to 32.5 microns, less than or equal to 30 microns, less than or equal to 27.5 microns, less than or equal to 25 microns, less than or equal to 22.5 microns, less than or equal to 20 microns, less than or equal to 17.5 microns, less than or equal to 15 microns, less than or equal to 13.5 microns, less than or equal to 12 microns, less than or equal to 11 microns, less than or equal to 10 microns, less than or equal to 9 microns, less than or equal to 8 microns, less than or equal to 7 microns, or less than or equal to 6 microns. Combinations of the above-referenced ranges are also possible (e.g., greater than or equal to 5 microns and less than or equal to 40 microns, greater than or equal to 7 microns and less than or equal to 20 microns, or greater than or equal to 12 microns and less than or equal to 15 microns). Other ranges are also possible.

When a non-woven fiber web of the first type comprises two or more types of multicomponent fibers, each type of multicomponent fiber may independently have an average fiber diameter in one or more of the ranges described above and/or all of the multicomponent fibers in a non-woven fiber web of the first type may together have an average fiber diameter in one or more of the ranges described above. Similarly, when an article comprises two or more non-woven fiber webs of the first type, each non-woven fiber web of the first type may independently comprise one or more types of multicomponent fibers having an average fiber diameter in one or more of the ranges described above and/or may comprise multicomponent fibers that overall have an average fiber diameter in one or more of the ranges described above.

Multicomponent fibers may have a variety of suitable average lengths. Some multicomponent fibers suitable for inclusion in the non-woven fiber webs of the first type described herein may be staple fibers. In some embodiments, a non-woven fiber web of the first type comprises multicomponent fibers having an average length of greater than or equal to 1 inch, greater than or equal to 1.1 inches, greater than or equal to 1.15 inches, greater than or equal to 1.2 inches, greater than or equal to 1.25 inches, greater than or equal to 1.3 inches, greater than or equal to 1.35 inches, greater than or equal to 1.4 inches, greater than or equal to 1.45 inches, greater than or equal to 1.5 inches, greater than or equal to 1.55 inches, greater than or equal to 1.6 inches, greater than or equal to 1.65 inches, greater than or equal to 1.7 inches, greater than or equal to 1.75 inches, greater than or equal to 1.8 inches, greater than or equal to 1.9 inches, greater than or equal to 2 inches, greater than or equal to 2.1 inches, greater than or equal to 2.2 inches, greater than or equal to 2.3 inches, greater than or equal to 2.4 inches, greater than or equal to 2.6 inches, or greater than or equal to 2.8 inches. In some embodiments, a non-woven fiber web of the first type comprises multicomponent fibers having an average length of less than or equal to 3 inches, less than or equal to 2.8 inches, less than or equal to 2.6 inches, less than or equal to 2.5 inches, less than or equal to 2.4 inches, less than or equal to 2.3 inches, less than or equal to 2.2 inches, less than or equal to 2.1 inches, less than or equal to 2 inches, less than or equal to 1.9 inches, less than or equal to 1.8 inches, less than or equal to 1.75 inches, less than or equal to 1.7 inches, less than or equal to 1.65 inches, less than or equal to 1.6 inches, less than or equal to 1.55 inches, less than or equal to 1.5 inches, less than or equal to 1.45 inches, less than or equal to 1.4 inches, less than or equal to 1.35 inches, less than or equal to 1.3 inches, less than or equal to 1.25 inches, less than or equal to 1.2 inches, less than or equal to 1.15 inches, less than or equal to 1.1 inches, or less than or equal to 1.05 inches. Combinations of the above-referenced ranges are also possible (e.g., greater than or equal to 1 inch and less than or equal to 3 inches, greater than or equal to 1.2 inches and less than or equal to 2 inches, or greater than or equal to 1.45 inches and less than or equal to 1.75 inches). Other ranges are also possible.

It should be understood that a non-woven fiber web of the first type may include a plurality of monocomponent synthetic fibers and that the values above describe the average fiber diameter for the fibers in this plurality. In other words, it is possible for a plurality of monocomponent synthetic fibers having an average fiber diameter in one or more of the above-referenced ranges to comprise monocomponent synthetic fibers shorter than the average (e.g., having a smaller fiber diameter than any of those listed above) and/or monocomponent synthetic fibers longer than the average (e.g., having a larger fiber diameter than any of those listed above.

When a non-woven fiber web of the first type comprises two or more types of multicomponent fibers, each type of multicomponent fiber may independently have an average fiber length in one or more of the ranges described above and/or all of the multicomponent fibers in a non-woven fiber web of the first type may together have an average fiber length in one or more of the ranges described above. Similarly, when an article comprises two or more non-woven fiber webs of the first type, each non-woven fiber web of the first type may independently comprise one or more types of multicomponent fibers having an average fiber length in one or more of the ranges described above and/or may comprise multicomponent fibers that overall have an average fiber length in one or more of the ranges described above.

In some embodiments, the non-woven fiber webs of the first type described herein comprise undrawn fibers. Undrawn fibers may be fibers that are not subject to a drawing process after being fabricated. Drawing processes may comprise applying heat and/or mechanical stress to fibers, such as by stretching fibers under a controlled tension and/or in the presence of heat. Some drawing processes may enhance the crystallinity and/or mechanical strength of fibers subject thereto. In some such embodiments, undrawn fibers serve as a binder for a non-woven fiber web of the first type that binds fibers therein together. The undrawn fibers, when processed at an elevated temperature or pressure (e.g., a temperature that exceeds their glass transition temperature, a temperature and/or pressure applied during a calendering process), may soften. During and/or after softening, the undrawn fibers may flatten, fill in a portion of the pores and/or any voids present in the non-woven fiber web of the first type, and/or bind the fibers within the non-woven fiber web of the first type together. In some embodiments, the undrawn fibers are substantially amorphous (e.g., they are substantially made up of one or more glassy materials). Such undrawn fibers may lack a measurable melting point.

The non-woven fiber webs of the first type described herein may comprise undrawn fibers in a variety of suitable amounts. In some embodiments, undrawn fibers make up greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, or greater than or equal to 45 wt % of a non-woven fiber web of the first type. In some embodiments, undrawn fibers make up less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, or less than or equal to 10 wt % of a non-woven fiber web of the first type. Combinations of the above-referenced ranges are also possible (e.g., greater than or equal to 5 wt % and less than or equal to 50 wt %, greater than or equal to 10 wt % and less than or equal to 40 wt %, or greater than or equal to 15 wt % and less than or equal to 25 wt %). Other ranges are also possible.

When a non-woven fiber web of the first type comprises two or more types of undrawn fibers, each type of undrawn fiber may independently make up an amount of the non-woven fiber web of the first type in one or more of the ranges described above and/or all of the undrawn fibers in a non-woven fiber web of the first type may together make up an amount of the non-woven fiber web of the first type in one or more of the ranges described above. Similarly, when an article comprises two or more non-woven fiber webs of the first type, each non-woven fiber web of the first type may independently comprise an amount of any particular type of undrawn fiber in one or more of the ranges described above and/or may comprise a total amount of undrawn fibers in one or more of the ranges described above.

Non-limiting examples of suitable materials that may be included in undrawn fibers include poly(ester)s and co-poly(ester)s (e.g., poly(ethylene terephthalate), co-poly(ethylene terephthalate), poly(butylene terephthalate), poly(ethylene isophthalate)), poly(lactic acid), poly(carbonate), poly(amide)s and co-poly(amide)s (e.g., various nylon polymers, various aramid polymers), poly(aramid)s, poly(imide)s, poly(olefin)s (e.g., poly(ethylene), poly(propylene), poly(butylene)), poly(ether ether ketone), poly(acrylic)s (e.g., poly(acrylonitrile), dryspun poly(acrylic)), poly(vinyl alcohol), regenerated cellulose (e.g., synthetic cellulose such cellulose acetate, rayon), halogenated and/or fluorinated polymers (e.g., poly(vinylidene difluoride) (PVDF), poly(tetrafluoroethylene)), copolymers of poly(ethylene) and PVDF, poly(ether sulfone)s, epoxy, phenolic resins, and melamine. Suitable co-poly(ethylene terephthalate)s include those described elsewhere herein with respect to co-poly(ethylene terephthalate)s suitable for inclusion in synthetic fibers.

Undrawn fibers may have a variety of suitable percent crystallinities. In some embodiments, a non-woven fiber web of the first type comprises undrawn fibers that have a percent crystallinity of greater than or equal to 0%, greater than or equal to 0.5%, greater than or equal to 1%, greater than or equal to 1.5%, greater than or equal to 2%, greater than or equal to 2.5%, greater than or equal to 3%, greater than or equal to 3.5%, greater than or equal to 4%, or greater than or equal to 4.5%. In some embodiments, a non-woven fiber web of the first type comprises undrawn fibers that have a percent crystallinity of less than or equal to 5%, less than or equal to 4.5%, less than or equal to 4%, less than or equal to 3.5%, less than or equal to 3%, less than or equal to 2.5%, less than or equal to 2%, less than or equal to 1.5%, less than or equal to 1%, or less than or equal to 0.5%. Combinations of the above-referenced ranges are also possible (e.g., greater than or equal to 0% and less than or equal to 5%, greater than or equal to 1% and less than or equal to 3%). Other ranges are also possible. In some embodiments, a non-woven fiber web of the first type comprises undrawn fibers that are exactly 0% crystalline.

The percent crystallinity of an undrawn fiber may be determined by performing differential scanning calorimetry according to standard ASTM F2625-10 (2016).

When a non-woven fiber web of the first type comprises two or more types of undrawn fibers, each type of undrawn fiber may independently have percent crystallinity in one or more of the ranges described above and/or all of the undrawn fibers in a non-woven fiber web of the first type may together have a percent crystallinity in one or more of the ranges described above. Similarly, when an article comprises two or more non-woven fiber webs of the first type, each non-woven fiber web of the first type may independently comprise one or more types of undrawn fibers having a percent crystallinity in one or more of the ranges described above and/or may comprise undrawn fibers that overall have an average percent crystallinity in one or more of the ranges described above.

Undrawn fibers may have a variety of suitable average fiber diameters. In some embodiments, a non-woven fiber web of the first type comprises undrawn fibers having an average fiber diameter of greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, greater than or equal to 12 microns, greater than or equal to 13.5 microns, greater than or equal to 15 microns, greater than or equal to 17.5 microns, greater than or equal to 20 microns, greater than or equal to 22.5 microns, greater than or equal to 25 microns, greater than or equal to 27.5 microns, greater than or equal to 30 microns, greater than or equal to 32.5 microns, greater than or equal to 35 microns, or greater than or equal to 37.5 microns. In some embodiments, a non-woven fiber web of the first type comprises undrawn fibers having an average fiber diameter of less than or equal to 40 microns, less than or equal to 37.5 microns, less than or equal to 35 microns, less than or equal to 32.5 microns, less than or equal to 30 microns, less than or equal to 27.5 microns, less than or equal to 25 microns, less than or equal to 22.5 microns, less than or equal to 20 microns, less than or equal to 17.5 microns, less than or equal to 15 microns, less than or equal to 13.5 microns, less than or equal to 12 microns, less than or equal to 11 microns, less than or equal to 10 microns, less than or equal to 9 microns, less than or equal to 8 microns, less than or equal to 7 microns, or less than or equal to 6 microns. Combinations of the above-referenced ranges are also possible (e.g., greater than or equal to 5 microns and less than or equal to 40 microns, greater than or equal to 10 microns and less than or equal to 30 microns, or greater than or equal to 12 microns and less than or equal to 25 microns). Other ranges are also possible.

When a non-woven fiber web of the first type comprises two or more types of undrawn fibers, each type of undrawn fiber may independently have an average fiber diameter in one or more of the ranges described above and/or all of the undrawn fibers in a non-woven fiber web of the first type may together have an average fiber diameter in one or more of the ranges described above. Similarly, when an article comprises two or more non-woven fiber webs of the first type, each non-woven fiber web of the first type may independently comprise one or more types of undrawn fibers having an average fiber diameter in one or more of the ranges described above and/or may comprise undrawn fibers that overall have an average fiber diameter in one or more of the ranges described above.

Undrawn fibers may have a variety of suitable average lengths. Some undrawn fibers suitable for inclusion in the non-woven fiber webs of the first type described herein may be staple fibers. In some embodiments, a non-woven fiber web of the first type comprises undrawn fibers having an average length of greater than or equal to 1 inch, greater than or equal to 1.1 inches, greater than or equal to 1.15 inches, greater than or equal to 1.2 inches, greater than or equal to 1.25 inches, greater than or equal to 1.3 inches, greater than or equal to 1.35 inches, greater than or equal to 1.4 inches, greater than or equal to 1.45 inches, greater than or equal to 1.5 inches, greater than or equal to 1.55 inches, greater than or equal to 1.6 inches, greater than or equal to 1.65 inches, greater than or equal to 1.7 inches, greater than or equal to 1.75 inches, greater than or equal to 1.8 inches, greater than or equal to 1.9 inches, greater than or equal to 2 inches, greater than or equal to 2.1 inches, greater than or equal to 2.2 inches, greater than or equal to 2.3 inches, greater than or equal to 2.4 inches, greater than or equal to 2.6 inches, or greater than or equal to 2.8 inches. In some embodiments, a non-woven fiber web of the first type comprises undrawn fibers having an average length of less than or equal to 3 inches, less than or equal to 2.8 inches, less than or equal to 2.6 inches, less than or equal to 2.5 inches, less than or equal to 2.4 inches, less than or equal to 2.3 inches, less than or equal to 2.2 inches, less than or equal to 2.1 inches, less than or equal to 2 inches, less than or equal to 1.9 inches, less than or equal to 1.8 inches, less than or equal to 1.75 inches, less than or equal to 1.7 inches, less than or equal to 1.65 inches, less than or equal to 1.6 inches, less than or equal to 1.55 inches, less than or equal to 1.5 inches, less than or equal to 1.45 inches, less than or equal to 1.4 inches, less than or equal to 1.35 inches, less than or equal to 1.3 inches, less than or equal to 1.25 inches, less than or equal to 1.2 inches, less than or equal to 1.15 inches, less than or equal to 1.1 inches, or less than or equal to 1.05 inches. Combinations of the above-referenced ranges are also possible (e.g., greater than or equal to 1 inch and less than or equal to 3 inches, greater than or equal to 1.2 inches and less than or equal to 2 inches, or greater than or equal to 1.45 inches and less than or equal to 1.75 inches). Other ranges are also possible.

When a non-woven fiber web of the first type comprises two or more types of undrawn fibers, each type of undrawn fiber may independently have an average length in one or more of the ranges described above and/or all of the undrawn fibers in a non-woven fiber web of the first type may together have an average length in one or more of the ranges described above. Similarly, when an article comprises two or more non-woven fiber webs of the first type, each non-woven fiber web of the first type may independently comprise one or more types of undrawn fibers having an average length in one or more of the ranges described above and/or may comprise undrawn fibers that overall have an average length in one or more of the ranges described above.

In some embodiments, a non-woven fiber web of the first type comprises non-synthetic fibers. For instance, some non-woven fiber webs of the first type comprise natural fibers and/or glass fibers. When present in a non-woven fiber web of the first type, such fibers may make up relatively low amounts thereof. It is also possible for 100 wt % of the fibers in a non-woven fiber web of the first type to be synthetic fibers and/or for a non-woven fiber web of the first type to lack natural fibers and/or glass fibers.

In some embodiments, a non-woven fiber web of the first type lacks binder resin or comprises binder resin in a relatively small amount. In some embodiments, a binder resin makes up less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 5 wt %, less than or equal to 2.5 wt %, less than or equal to 1 wt %, or less than or equal to 0.5 wt % of a non-woven fiber web of the first type. In some embodiments, a binder resin makes up greater than or equal to 0 wt %, greater than or equal to 0.5 wt %, greater than or equal to 1 wt %, greater than or equal to 2.5 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, or greater than or equal to 45 wt % of a non-woven fiber web of the first type. Combinations of the above-referenced ranges are also possible (e.g., greater than or equal to 0 wt % and less than or equal to 50 wt %, greater than or equal to 0.5 wt % and less than or equal to 50 wt %, or greater than or equal to 0 wt % and less than or equal to 10 wt %). Other ranges are also possible. In some embodiments, a binder resin makes up identically 0 wt % of a non-woven fiber web of the first type.

When a non-woven fiber web of the first type comprises two or more types of binder resin, each type of binder resin may independently make up an amount of the non-woven fiber web of the first type in one or more of the ranges described above and/or all of the binder resin in a non-woven fiber web of the first type may together make up an amount of the non-woven fiber web in one or more of the ranges described above. Similarly, when an article comprises two or more non-woven fiber webs of the first type, each non-woven fiber web of the first type may independently comprise an amount of any particular type of binder resin in one or more of the ranges described above and/or may comprise a total amount of binder resin in one or more of the ranges described above.

Binder resins may have a variety of suitable compositions. For instance, in one set of embodiments, an article may comprises binder resin that comprises a thermoplastic polymer (e.g. acrylic, poly(vinyl acetate), poly(ester), poly(amide), poly(vinyl alcohol), etc.), a thermoset polymer (e.g., epoxy, phenolic resin, melamine, etc.), or a combination thereof. In some embodiments, a binder resin includes one or more of a vinyl acetate resin and a poly(vinyl alcohol) resin.

In some embodiments, one or more additives may be incorporated into a non-woven fiber web of the first type described herein. In some such embodiments, a binder resin may also be present that assists with the incorporation of the additive(s) thereinto. It is also possible for a non-woven fiber web of the first type to comprise a binder resin in which one or more additives are dispersed. Non-limiting examples of suitable additives include antimicrobial silver nanoparticles, activated carbon particles, and diatomaceous earth particles.

The non-woven fiber webs of the first type described herein may have a variety of suitable basis weights. In some embodiments, a non-woven fiber web of the first type has a basis weight of greater than or equal to 50 gsm, greater than or equal to 55 gsm, greater than or equal to 60 gsm, greater than or equal to 65 gsm, greater than or equal to 70 gsm, greater than or equal to 75 gsm, greater than or equal to 80 gsm, greater than or equal to 90 gsm, greater than or equal to 100 gsm, greater than or equal to 120 gsm, greater than or equal to 140 gsm, greater than or equal to 160 gsm, greater than or equal to 180 gsm, greater than or equal to 200 gsm, greater than or equal to 250 gsm, greater than or equal to 300 gsm, greater than or equal to 300 gsm, or greater than or equal to 350 gsm. In some embodiments, a non-woven fiber web of the first type has a basis weight of less than or equal to 400 gsm, less than or equal to 350 gsm, less than or equal to 300 gsm, less than or equal to 250 gsm, less than or equal to 200 gsm, less than or equal to 180 gsm, less than or equal to 160 gsm, less than or equal to 140 gsm, less than or equal to 120 gsm, less than or equal to 100 gsm, less than or equal to 90 gsm, less than or equal to 85 gsm, less than or equal to 80 gsm, less than or equal to 75 gsm, less than or equal to 70 gsm, less than or equal to 65 gsm, less than or equal to 60 gsm, or less than or equal to 55 gsm. Combinations of the above-referenced ranges are also possible (e.g., greater than or equal to 50 gsm and less than or equal to 400 gsm, greater than or equal to 75 gsm and less than or equal to 200 gsm, or greater than or equal to 90 gsm and less than or equal to 160 gsm). Other ranges are also possible.

The basis weight of a non-woven fiber web of the first type may be determined in accordance with ISO 536:2012.

When an article comprises two or more non-woven fiber webs of the first type, each non-woven fiber web of the first type may independently have a basis weight in one or more of the above-referenced ranges.

The non-woven fiber webs of the first type described herein may have a variety of suitable thicknesses. In some embodiments, a non-woven fiber web of the first type has a thickness of greater than or equal to 5 mils, greater than or equal to 6 mils, greater than or equal to 7 mils, greater than or equal to 8 mils, greater than or equal to 9 mils, greater than or equal to 10 mils, greater than or equal to 11 mils, greater than or equal to 12 mils, greater than or equal to 13 mils, greater than or equal to 14 mils, greater than or equal to 15 mils, greater than or equal to 16 mils, greater than or equal to 17 mils, greater than or equal to 18 mils, greater than or equal to 19 mils, greater than or equal to 20 mils, greater than or equal to 22 mils, greater than or equal to 24 mils, greater than or equal to 26 mils, or greater than or equal to 28 mils. In some embodiments, a non-woven fiber web of the first type has a thickness of less than or equal to 30 mils, less than or equal to 28 mils, less than or equal to 26 mils, less than or equal to 24 mils, less than or equal to 22 mils, less than or equal to 20 mils, less than or equal to 19 mils, less than or equal to 18 mils, less than or equal to 17 mils, less than or equal to 16 mils, less than or equal to 15 mils, less than or equal to 14 mils, less than or equal to 13 mils, less than or equal to 12 mils, less than or equal to 11 mils, less than or equal to 10 mils, less than or equal to 9 mils, less than or equal to 8 mils, less than or equal to 7 mils, or less than or equal to 6 mils. Combinations of the above-referenced ranges are also possible (e.g., greater than or equal to 5 mils and less than or equal to 30 mils, greater than or equal to 5 mils and less than or equal to 20 mils, greater than or equal to 6 mils and less than or equal to 18 mils, or greater than or equal to 9 mils and less than or equal to 12 mils). Other ranges are also possible.

The thickness of a non-woven fiber web of the first type may be determined in accordance with ASTM D1777 (2015) under an applied pressure of 0.8 kPa.

When an article comprises two or more non-woven fiber webs of the first type, each non-woven fiber web of the first type may independently have a thickness in one or more of the above-referenced ranges.

The non-woven fiber webs of the first type described herein may have a variety of suitable porosities. In some embodiments, the non-woven fiber webs of the first type may have a relatively low porosity. In some embodiments, a non-woven fiber web of the first type has a porosity of greater than or equal to 10%, greater than or equal to 15%, greater than or equal to 20%, greater than or equal to 25%, greater than or equal to 30%, greater than or equal to 35%, greater than or equal to 40%, greater than or equal to 45%, greater than or equal to 50%, greater than or equal to 55%, greater than or equal to 60%, greater than or equal to 65%, greater than or equal to 70%, greater than or equal to 75%, greater than or equal to 80%, or greater than or equal to 85%. In some embodiments, a non-woven fiber web of the first type has a porosity of less than or equal to 90%, less than or equal to 85%, less than or equal to 80%, less than or equal to 75%, less than or equal to 70%, less than or equal to 65%, less than or equal to 60%, less than or equal to 55%, less than or equal to 50%, less than or equal to 45%, less than or equal to 40%, less than or equal to 35%, less than or equal to 30%, less than or equal to 25%, less than or equal to 20%, or less than or equal to 15%. Combinations of the above-referenced ranges are also possible (e.g., greater than or equal to 10% and less than or equal to 90%, greater than or equal to 20% and less than or equal to 60%, or greater than or equal to 25% and less than or equal to 40%). Other ranges are also possible.

The porosity of a non-woven fiber web of the first type is equivalent to 100%−[solidity of the non-woven fiber web of the first type]. The solidity of a non-woven fiber web of the first type is equivalent to the percentage of the interior of the non-woven fiber web of the first type occupied by solid material. One non-limiting way of determining solidity of a non-woven fiber web of the first type is described in this paragraph, but other methods are also possible. The method described in this paragraph includes determining the basis weight and thickness of the non-woven fiber web of the first type and then applying the following formula: solidity=[basis weight of the non-woven fiber web of the first type/(density of the components forming the non-woven fiber web of the first type*thickness of the non-woven fiber web of the first type)]*100%. The density of the components forming the non-woven fiber web of the first type is equivalent to the average density of the material or material(s) forming the components of the non-woven fiber web of the first type (e.g., the fibers therein, any other components therein), which is typically specified by the manufacturer of each material. The average density of the materials forming the components of the non-woven fiber web of the first type may be determined by: (1) determining the total volume of all of the components in the non-woven fiber web of the first type; and (2) dividing the total mass of all of the components in the non-woven fiber web of the first type by the total volume of all of the components in the non-woven fiber web of the first type. If the mass and density of each component of the non-woven fiber web of the first type are known, the volume of all the components in the non-woven fiber web of the first type may be determined by: (1) for each type of component, dividing the total mass of the component in the non-woven fiber web of the first type by the density of the component; and (2) summing the volumes of each component. If the mass and density of each component of the non-woven fiber web of the first type are not known, the volume of all the components in the non-woven fiber web of the first type may be determined in accordance with Archimedes' principle.

The non-woven fiber webs of the first type described herein may a variety of suitable mean flow pore sizes. In some embodiments, the non-woven fiber webs of the first type described herein may have relatively low values of mean flow pore size. In some embodiments, the mean flow pore size of a non-woven fiber web of the first type is greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, greater than or equal to 12 microns, greater than or equal to 13 microns, greater than or equal to 14 microns, greater than or equal to 15 microns, greater than or equal to 16 microns, greater than or equal to 17 microns, greater than or equal to 18 microns, or greater than or equal to 19 microns. In some embodiments, the mean flow pore size of a non-woven fiber web of the first type is less than or equal to 20 microns, less than or equal to 19 microns, less than or equal to 18 microns, less than or equal to 17 microns, less than or equal to 16 microns, less than or equal to 15 microns, less than or equal to 14 microns, less than or equal to 13 microns, less than or equal to 12 microns, less than or equal to 11 microns, less than or equal to 10 microns, less than or equal to 9 microns, less than or equal to 8 microns, less than or equal to 7 microns, or less than or equal to 6 microns. Combinations of the above-referenced ranges are also possible (e.g., greater than or equal to 5 microns and less than or equal to 20 microns, greater than or equal to 8 microns and less than or equal to 16 microns, or greater than or equal to 9 microns and less than or equal to 12 microns). Other ranges are also possible.

The mean flow pore size of a non-woven fiber web of the first type may be determined in accordance with ASTM F316 (2003).

When an article comprises two or more non-woven fiber webs of the first type, each non-woven fiber web of the first type may independently have a mean flow pore size in one or more of the above-referenced ranges.

The non-woven fiber webs of the first type described herein may a variety of suitable maximum pore sizes. In some embodiments, the non-woven fiber webs of the first type described herein may have relatively low values of maximum pore size. In some embodiments, the maximum pore size of a non-woven fiber web of the first type is greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, greater than or equal to 27.5 microns, greater than or equal to 30 microns, greater than or equal to 32.5 microns, greater than or equal to 35 microns, greater than or equal to 37.5 microns, greater than or equal to 40 microns, greater than or equal to 42.5 microns, greater than or equal to 45 microns, or greater than or equal to 47.5 microns. In some embodiments, the maximum pore size of a non-woven fiber web of the first type is less than or equal to 50 microns, less than or equal to 47.5 microns, less than or equal to 45 microns, less than or equal to 42.5 microns, less than or equal to 40 microns, less than or equal to 37.5 microns, less than or equal to 35 microns, less than or equal to 32.5 microns, less than or equal to 30 microns, less than or equal to 27.5 microns, less than or equal to 25 microns, less than or equal to 22.5 microns, less than or equal to 20 microns, less than or equal to 17.5 microns, less than or equal to 15 microns, or less than or equal to 12.5 microns. Combinations of the above-referenced ranges are also possible (e.g., greater than or equal to 10 microns and less than or equal to 50 microns, greater than or equal to 15 microns and less than or equal to 40 microns, or greater than or equal to 20 microns and less than or equal to 30 microns). Other ranges are also possible.

The maximum pore size of a non-woven fiber web of the first type may be determined in accordance with ASTM F316 (2003).

When an article comprises two or more non-woven fiber webs of the first type, each non-woven fiber web of the first type may independently have a maximum pore size in one or more of the above-referenced ranges.

The non-woven fiber webs of the first type described herein may a variety of suitable ratio of maximum pore size to mean flow pore size. In some embodiments, the non-woven fiber webs of the first type described herein may have a relatively small ratio of maximum pore size to mean flow pore size. In some embodiments, the ratio of maximum pore size to mean flow pore size of a non-woven fiber web of the first type is greater than or equal to 1.2, greater than or equal to 1.25, greater than or equal to 1.3, greater than or equal to 1.35, greater than or equal to 1.4, greater than or equal to 1.45, greater than or equal to 1.5, greater than or equal to 1.55, greater than or equal to 1.6, greater than or equal to 1.65, greater than or equal to 1.7, greater than or equal to 1.75, greater than or equal to 1.8, greater than or equal to 1.85, greater than or equal to 1.9, greater than or equal to 1.95, greater than or equal to 2, greater than or equal to 2.05, greater than or equal to 2.1, greater than or equal to 2.15, greater than or equal to 2.2, greater than or equal to 2.25, greater than or equal to 2.3, greater than or equal to 2.35, greater than or equal to 2.4, or greater than or equal to 2.45. In some embodiments, the ratio of maximum pore size to mean flow pore size of a non-woven fiber web of the first type is less than or equal to 2.5, less than or equal to 2.45, less than or equal to 2.4, less than or equal to 2.35, less than or equal to 2.3, less than or equal to 2.25, less than or equal to 2.2, less than or equal to 2.15, less than or equal to 2.1, less than or equal to 2.05, less than or equal to 2, less than or equal to 1.95, less than or equal to 1.9, less than or equal to 1.85, less than or equal to 1.8, less than or equal to 1.75, less than or equal to 1.7, less than or equal to 1.65, less than or equal to 1.6, less than or equal to 1.55, less than or equal to 1.5, less than or equal to 1.45, less than or equal to 1.4, less than or equal to 1.35, less than or equal to 1.3, or less than or equal to 1.25. Combinations of the above-referenced ranges are also possible (e.g., greater than or equal to 1.2 and less than or equal to 2.5, greater than or equal to 1.5 and less than or equal to 2.4, or greater than or equal to 1.75 and less than or equal to 2.25). Other ranges are also possible.

When an article comprises two or more non-woven fiber webs of the first type, each non-woven fiber web of the first type may independently have a ratio of maximum pore size to mean flow pore size in one or more of the above-referenced ranges.

The non-woven fiber webs of the first type described herein may have a variety of suitable air permeabilities. In some embodiments, a non-woven fiber web of the first type has an air permeability of greater than or equal to 5 cfm/sf (CFM), greater than or equal to 6 CFM, greater than or equal to 8 CFM, greater than or equal to 10 CFM, greater than or equal to 12.5 CFM, greater than or equal to 15 CFM, greater than or equal to 17.5 CFM, greater than or equal to 20 CFM, greater than or equal to 22.5 CFM, greater than or equal to 25 CFM, greater than or equal to 27.5 CFM, greater than or equal to 30 CFM, greater than or equal to 32.5 CFM, greater than or equal to 35 CFM, greater than or equal to 37.5 CFM, greater than or equal to 40 CFM, greater than or equal to 45 CFM, greater than or equal to 50 CFM, greater than or equal to 60 CFM, greater than or equal to 70 CFM, greater than or equal to 80 CFM, or greater than or equal to 90 CFM. In some embodiments, a non-woven fiber web of the first type has an air permeability of less than or equal to 100 CFM, less than or equal to 90 CFM, less than or equal to 80 CFM, less than or equal to 70 CFM, less than or equal to 60 CFM, less than or equal to 50 CFM, less than or equal to 45 CFM, less than or equal to 40 CFM, less than or equal to 37.5 CFM, less than or equal to 35 CFM, less than or equal to 32.5 CFM, less than or equal to 30 CFM, less than or equal to 27.5 CFM, less than or equal to 25 CFM, less than or equal to 22.5 CFM, less than or equal to 20 CFM, less than or equal to 17.5 CFM, less than or equal to 15 CFM, less than or equal to 12.5 CFM, less than or equal to 10 CFM, less than or equal to 8 CFM, or less than or equal to 6 CFM. Combinations of the above-referenced ranges are also possible (e.g., greater than or equal to 5 CFM and less than or equal to 100 CFM, greater than or equal to 8 CFM and less than or equal to 40 CFM, greater than or equal to 10 CFM and less than or equal to 30 CFM, or greater than or equal to 20 CFM and less than or equal to 100 CFM). Other ranges are also possible.

The air permeability of a non-woven fiber web of the first type may be determined in accordance with ASTM D737-04 (2016) at a pressure of 125 Pa.

When an article comprises two or more non-woven fiber webs of the first type, each non-woven fiber web of the first type may independently have an air permeability in one or more of the above-referenced ranges.

The non-woven fiber webs of the first type described herein may have relatively high values of dry tensile strength in the machine direction. In some embodiments, a non-woven fiber web of the first type has a dry tensile strength in the machine direction of greater than or equal to 10 lb/in, greater than or equal to 15 lb/in, greater than or equal to 20 lb/in, greater than or equal to 25 lb/in, greater than or equal to 30 lb/in, greater than or equal to 35 lb/in, greater than or equal to 40 lb/in, greater than or equal to 45 lb/in, greater than or equal to 50 lb/in, greater than or equal to 55 lb/in, greater than or equal to 60 lb/in, greater than or equal to 65 lb/in, greater than or equal to 70 lb/in, greater than or equal to 75 lb/in, greater than or equal to 80 lb/in, greater than or equal to 85 lb/in, greater than or equal to 90 lb/in, or greater than or equal to 95 lb/in. In some embodiments, a non-woven fiber web of the first type has a dry tensile strength in the machine direction of less than or equal to 100 lb/in, less than or equal to 95 lb/in, less than or equal to 90 lb/in, less than or equal to 85 lb/in, less than or equal to 80 lb/in, less than or equal to 75 lb/in, less than or equal to 70 lb/in, less than or equal to 65 lb/in, less than or equal to 60 lb/in, less than or equal to 55 lb/in, less than or equal to 50 lb/in, less than or equal to 45 lb/in, less than or equal to 40 lb/in, less than or equal to 35 lb/in, less than or equal to 30 lb/in, less than or equal to 25 lb/in, less than or equal to 20 lb/in, or less than or equal to 15 lb/in. Combinations of the above-referenced ranges are also possible (e.g., greater than or equal to 10 lb/in and less than or equal to 100 lb/in, greater than or equal to 25 lb/in and less than or equal to 75 lb/in, or greater than or equal to 35 lb/in and less than or equal to 45 lb/in). Other ranges are also possible. The dry tensile strength of a non-woven fiber web of the first type in the machine direction may be determined in accordance with the standard T494 om-96 (1996) test using a test span of 3 inches, a jaw separation speed of 12 in/min, and a specimen having a dimension of 6 inches by 1 inch.

When an article comprises two or more non-woven fiber webs of the first type, each non-woven fiber web of the first type may independently have a dry tensile strength in the machine direction in one or more of the above-referenced ranges.

The non-woven fiber webs of the first type described herein may have relatively high values of dry tensile strength in the cross direction. In some embodiments, a non-woven fiber web of the first type has a dry tensile strength in the cross direction of greater than or equal to 10 lb/in, greater than or equal to 15 lb/in, greater than or equal to 20 lb/in, greater than or equal to 25 lb/in, greater than or equal to 30 lb/in, greater than or equal to 35 lb/in, greater than or equal to 40 lb/in, greater than or equal to 45 lb/in, greater than or equal to 50 lb/in, greater than or equal to 55 lb/in, greater than or equal to 60 lb/in, greater than or equal to 65 lb/in, greater than or equal to 70 lb/in, greater than or equal to 75 lb/in, greater than or equal to 80 lb/in, greater than or equal to 85 lb/in, greater than or equal to 90 lb/in, or greater than or equal to 95 lb/in. In some embodiments, a non-woven fiber web of the first type has a dry tensile strength in the cross direction of less than or equal to 100 lb/in, less than or equal to 95 lb/in, less than or equal to 90 lb/in, less than or equal to 85 lb/in, less than or equal to 80 lb/in, less than or equal to 75 lb/in, less than or equal to 70 lb/in, less than or equal to 65 lb/in, less than or equal to 60 lb/in, less than or equal to 55 lb/in, less than or equal to 50 lb/in, less than or equal to 45 lb/in, less than or equal to 40 lb/in, less than or equal to 35 lb/in, less than or equal to 30 lb/in, less than or equal to 25 lb/in, less than or equal to 20 lb/in, or less than or equal to 15 lb/in. Combinations of the above-referenced ranges are also possible (e.g., greater than or equal to 10 lb/in and less than or equal to 100 lb/in, greater than or equal to 25 lb/in and less than or equal to 75 lb/in, or greater than or equal to 35 lb/in and less than or equal to 45 lb/in). Other ranges are also possible. The dry tensile strength of a non-woven fiber web of the first type in the cross direction may be determined in accordance with the standard T494 om-96 (1996) test using a test span of 3 inches, a jaw separation speed of 12 in/min, and a specimen having a dimension of 6 inches by 1 inch.

When an article comprises two or more non-woven fiber webs of the first type, each non-woven fiber web of the first type may independently have a dry tensile strength in the cross direction in one or more of the above-referenced ranges.

The non-woven fiber webs of the first type described herein may have relatively low values of ratio of dry tensile strength in a first direction to dry tensile strength in a second direction. In some embodiments, a non-woven fiber web of the first type has a ratio of dry tensile strength in a first direction to dry tensile strength in a second direction of less than or equal to 4, less than or equal to 3.8, less than or equal to 3.6, less than or equal to 3.4, less than or equal to 3.2, less than or equal to 3, less than or equal to 2.9, less than or equal to 2.8, less than or equal to 2.7 less than or equal to 2.6, less than or equal to 2.5, less than or equal to 2.4, less than or equal to 2.3, less than or equal to 2.2, less than or equal to 2.1, less than or equal to 2, less than or equal to 1.9, less than or equal to 1.8, less than or equal to 1.7, less than or equal to 1.6, less than or equal to 1.5, less than or equal to 1.4, less than or equal to 1.3, less than or equal to 1.2, less than or equal to 1.1, less than or equal to 1, less than or equal to 0.9, or less than or equal to 0.8. In some embodiments, a non-woven fiber web of the first type has a ratio of dry tensile strength a first direction to dry tensile strength in a second direction of greater than or equal to 0.7, greater than or equal to 0.8, greater than or equal to 0.9, greater than or equal to 1, greater than or equal to 1.1, greater than or equal to 1.2, greater than or equal to 1.3, greater than or equal to 1.4, greater than or equal to 1.5, greater than or equal to 1.6, greater than or equal to 1.7, greater than or equal to 1.8, greater than or equal to 1.9, greater than or equal to 2, greater than or equal to 2.1, greater than or equal to 2.2, greater than or equal to 2.3, greater than or equal to 2.4, greater than or equal to 2.5, greater than or equal to 2.6, greater than or equal to 2.7, greater than or equal to 2.8, greater than or equal to 2.9, greater than or equal to 3, greater than or equal to 3.2, greater than or equal to 3.4, greater than or equal to 3.6, or greater than or equal to 3.8. Combinations of the above-referenced ranges are also possible (e.g., greater than or equal to 0.7 and less than or equal to 4, greater than or equal to 1 and less than or equal to 3, or greater than or equal to 1.5 and less than or equal to 2.5). Other ranges are also possible.

When an article comprises two or more non-woven fiber webs of the first type, each non-woven fiber web of the first type may independently have a ratio of dry tensile strength in a first direction to dry tensile strength in a second direction in one or more of the above-referenced ranges. Additionally, in some embodiments, the first direction in the preceding paragraph refers to the machine direction and the second direction in the preceding paragraph refers to the cross direction. In some embodiments, the first direction in the preceding paragraph refers to the cross direction and the second direction in the preceding paragraph refers to the machine direction.

The non-woven fiber webs of the first type described herein may have relatively high values of dry Mullen burst strength. In some embodiments, the dry Mullen burst strength of a non-woven fiber web of the first type is greater than or equal to 10 lb/in², greater than or equal to 20 lb/in², greater than or equal to 40 lb/in², greater than or equal to 60 lb/in², greater than or equal to 80 lb/in², greater than or equal to 100 lb/in², greater than or equal to 110 lb/in², greater than or equal to 120 lb/in², greater than or equal to 130 lb/in², greater than or equal to 140 lb/in², greater than or equal to 150 lb/in², greater than or equal to 160 lb/in², greater than or equal to 170 lb/in², greater than or equal to 180 lb/in², greater than or equal to 190 lb/in², greater than or equal to 200 lb/in², greater than or equal to 225 lb/in², greater than or equal to 250 lb/in², or greater than or equal to 275 lb/in². The dry Mullen burst strength of a non-woven fiber web of the first type may be less than or equal to 300 lb/in², less than or equal to 275 lb/in², less than or equal to 250 lb/in², less than or equal to 225 lb/in², less than or equal to 200 lb/in², less than or equal to 190 lb/in², less than or equal to 180 lb/in², less than or equal to 170 lb/in², less than or equal to 160 lb/in², less than or equal to 150 lb/in², less than or equal to 140 lb/in², less than or equal to 130 lb/in², less than or equal to 120 lb/in², less than or equal to 110 lb/in², less than or equal to 100 lb/in², less than or equal to 80 lb/in², less than or equal to 60 lb/in², less than or equal to 40 lb/in², or less than or equal to 20 lb/in². Combinations of the above-referenced ranges are also possible (e.g., greater than or equal to 10 lb/in² and less than or equal to 300 lb/in², greater than or equal to 100 lb/in² and less than or equal to 200 lb/in², or greater than or equal to 130 lb/in² and less than or equal to 170 lb/in²). Other ranges are also possible.

The dry Mullen burst strength of a non-woven fiber web of the first type may be determined in accordance with the standard TAPPI T403 (1997) test.

When an article comprises two or more non-woven fiber webs of the first type, each non-woven fiber web of the first type may independently have a dry Mullen burst strength in one or more of the above-referenced ranges.

The non-woven fiber webs of the first type described herein may have relatively high values of dry tensile elongation at break in the cross direction. In some embodiments, the dry tensile elongation at break in the cross direction of a non-woven fiber web of the first type is greater than or equal to 5%, greater than or equal to 6%, greater than or equal to 7%, greater than or equal to 8%, greater than or equal to 9%, greater than or equal to 10%, greater than or equal to 12.5%, greater than or equal to 15%, greater than or equal to 17.5%, greater than or equal to 20%, greater than or equal to 22.5%, greater than or equal to 25%, greater than or equal to 27.5%, greater than or equal to 30%, greater than or equal to 32.5%, greater than or equal to 35%, or greater than or equal to 37.5%. In some embodiments, the dry tensile elongation at break in the cross direction of a non-woven fiber web may be less than or equal to 40%, less than or equal to 37.5%, less than or equal to 35%, less than or equal to 32.5%, less than or equal to 30%, less than or equal to 27.5%, less than or equal to 25%, less than or equal to 22.5%, less than or equal to 20%, less than or equal to 17.5%, less than or equal to 15%, less than or equal to 12.5%, less than or equal to 10%, less than or equal to 9%, less than or equal to 8%, less than or equal to 7%, or less than or equal to 6%. Combinations of the above-referenced ranges are also possible (e.g., greater than or equal to 5% and less than or equal to 40%, greater than or equal to 7% and less than or equal to 30%, or greater than or equal to 10% and less than or equal to 20%). Other ranges are also possible.

The dry tensile elongation at break in the cross direction of a non-woven fiber web of the first type may be determined in accordance with the standard T494 om-96 (1996) test using a test span of 3 inches, a jaw separation speed of 12 in/min, and a specimen having a dimension of 6 inches by 1 inch.

When an article comprises two or more non-woven fiber webs of the first type, each non-woven fiber web of the first type may independently have a dry tensile elongation at break in the cross direction in one or more of the above-referenced ranges.

The non-woven fiber webs of the first type described herein may have relatively high values of dry tensile elongation at break in the machine direction. In some embodiments, the dry tensile elongation at break in the machine direction of a non-woven fiber web of the first type is greater than or equal to 2%, greater than or equal to 3%, greater than or equal to 4%, greater than or equal to 5%, greater than or equal to 6%, greater than or equal to 8%, greater than or equal to 10%, greater than or equal to 12.5%, greater than or equal to 15%, greater than or equal to 17.5%, greater than or equal to 20%, greater than or equal to 22.5%, greater than or equal to 25%, greater than or equal to 27.5%, greater than or equal to 30%, greater than or equal to 32.5%, greater than or equal to 35%, or greater than or equal to 37.5%. In some embodiments, the dry tensile elongation at break in the machine direction of a non-woven fiber web may be less than or equal to 40%, less than or equal to 37.5%, less than or equal to 35%, less than or equal to 32.5%, less than or equal to 30%, less than or equal to 27.5%, less than or equal to 25%, less than or equal to 22.5%, less than or equal to 20%, less than or equal to 17.5%, less than or equal to 15%, less than or equal to 12.5%, less than or equal to 10%, less than or equal to 8%, less than or equal to 6%, less than or equal to 5%, less than or equal to 4%, or less than or equal to 3%. Combinations of the above-referenced ranges are also possible (e.g., greater than or equal to 2% and less than or equal to 40%, greater than or equal to 5% and less than or equal to 30%, or greater than or equal to 6% and less than or equal to 20%). Other ranges are also possible.

The dry tensile elongation at break in the machine direction of a non-woven fiber web of the first type may be determined in accordance with the standard T494 om-96 (1996) test using a test span of 3 inches, a jaw separation speed of 12 in/min, and a specimen having a dimension of 6 inches by 1 inch.

When an article comprises two or more non-woven fiber webs of the first type, each non-woven fiber web of the first type may independently have a dry tensile elongation at break in the machine direction in one or more of the above-referenced ranges.

The non-woven fiber webs of the first type described herein may have any of a variety of average surface roughness. In some embodiments, the non-woven fiber webs of the first type have relatively low values of average surface roughness, e.g., such that the surfaces of the non-woven fiber webs of the first type are relatively smooth. In some such embodiments, a non-woven fiber web of the first type having a relatively smooth surface may exhibit an enhanced resistance to clogging. Without wishing to be bound by any particular theory, it is believed that the enhanced resistance to clogging may be due to the easier of removal of cakes from smooth surfaces in comparison to rough surfaces and/or because rough surfaces may anchor dirt inside a non-woven fiber web to a greater extent than smooth surfaces.

In some embodiments, the average surface roughness of a non-woven fiber web of the first type is greater than or equal to 1 micron, greater than or equal to 2 microns, greater than or equal to 3 microns, greater than or equal to 4 microns, greater than or equal to 5 microns, greater than or equal to 6 microns, greater than or equal to 8 microns, greater than or equal to 10 microns, greater than or equal to 12 microns, greater than or equal to 14 microns, greater than or equal to 16 microns, greater than or equal to 18 microns, greater than or equal to 20 microns, greater than or equal to 25 microns, greater than or equal to 30 microns, greater than or equal to 40 microns, greater than or equal to 60 microns, greater than or equal to 80 microns, greater than or equal to 100 microns, greater than or equal to 200 microns, greater than or equal to 400 microns, greater than or equal to 600 microns, or greater than or equal to 800 microns. In some embodiments, the average surface roughness of a non-woven fiber web of the first type is less than or equal to 1000 microns, less than or less than or equal to 800 microns, less than or equal to 600 microns, less than or equal to 400 microns, less than or equal to 300 microns, less than or equal to 100 microns, less than or equal to 80 microns, less than or equal to 60 microns, less than or equal to 40 microns, less than or equal to 30 microns, less than or equal to 25 microns, less than or equal to 20 microns, less than or equal to 18 microns, less than or equal to 16 microns, less than or equal to 14 microns, less than or equal to 12 microns, less than or equal to 10 microns, less than or equal to 8 microns, less than or equal to 6 microns, less than or equal to 5 microns, less than or equal to 4 microns, less than or equal to 3 microns, or less than or equal to 2 microns. Combinations of the above-referenced ranges are also possible (e.g., greater than or equal to 1 micron and less than or equal to 1000 microns, greater than or equal to 5 microns and less than or equal to 100 microns, or greater than or equal to 6 microns and less than or equal to 18 microns). Other ranges are also possible.

The average surface roughness of a non-woven fiber web may of the first type be determined by performing optical profilometry in a manner based on the description provided in ISO 25178-2 (2012). Briefly, the measurement of surface roughness may comprise: (1) Employing an optical profilometer to scan the center of a portion of the non-woven fiber web that has been cut to form an A4 hand sheet; (2) Applying a low-frequency filter to flatten the measured data; (3) Determining the absolute value of the difference between the height of each point measured during the scan and the median height measured during the scan; (4) Selecting a square having an area of 50 mm² for which the average of the absolute values measured in the preceding step is minimized; (5) Determining the median height of the selected square; (6) Determining the difference in heights between the median height of the selected square and the height of each point in the square that is higher the median height of the selected square; (7) Calculating the root mean square average of these differences; and (8) Taking this root mean square average as equivalent to the average surface roughness of the non-woven fiber web.

When an article comprises two or more non-woven fiber webs of the first type, each non-woven fiber web of the first type may independently have a surface roughness in in one or more of the above-referenced ranges.

In some embodiments, the non-woven fiber webs of the first type described herein may have relatively low values of water contact angles. As used herein, the term “water contact angle” refers the contact angle of a water droplet with a surface of the non-woven fiber web of the first type. In some embodiments, a non-woven fiber web of the first type that is relatively smooth (e.g., having a lower value of surface roughness) may be associated with a non-woven fiber web of the first type having a higher degree of water wettability (or lower water contact angle) compared to a non-woven fiber web of the first type having a surface with a higher surface roughness.

In some embodiments, the water contact angle of a non-woven fiber web of the first type may be greater than or equal to 0°, greater than or equal to 5°, greater than or equal to 10°, greater than or equal to 15°, greater than or equal to 20°, greater than or equal to 25°, greater than or equal to 30°, greater than 30°, greater than or equal to 35°, greater than or equal to 40°, greater than or equal to 45°, greater than or equal to 50°, greater than or equal to 55°, greater than or equal to 60°, greater than or equal to 65°, greater than or equal to 70°, greater than or equal to 75°, greater than or equal to 80°, or greater than or equal to 85°. In some embodiments, the water contact angle of a non-woven fiber web of the first type is less than or equal to 90°, less than or equal to 85°, less than or equal to 80°, less than or equal to 75°, less than or equal to 70°, less than or equal to 65°, less than or equal to 60°, less than or equal to 55°, less than or equal to 50°, less than or equal to 45°, less than or equal to 40°, less than or equal to 35°, less than or equal to 30°, less than or equal to 25°, less than or equal to 20°, less than or equal to 15°, less than or equal to 10°, or less than or equal to 5°. Combinations of the above-referenced ranges are also possible (e.g., greater than or equal to 0° and less than or equal to 90°, greater than or equal to 10° and less than or equal to 70°, or greater than or equal to 20° and less than or equal to 65°). Other ranges are also possible.

The water contact angle may be measured using standard ASTM D5946 (2009). The water contact angle is the angle between the surface of the non-woven fiber web of the first type and the tangent line drawn to the water droplet surface at the three-phase point (solid, liquid, and gas phase point) when a liquid drop is resting on the substrate surface. A contact angle meter or goniometer can be used for this determination.

When an article comprises two or more non-woven fiber webs of the first type, each non-woven fiber web of the first type may independently have a water contact angle in in one or more of the above-referenced ranges.

The non-woven fiber webs of the first type described herein may have a variety of suitable initial NaCl particle penetrations at 0.3 microns and initial air resistances. Penetration, often expressed as a percentage, is defined as follows: Pen (%)=(C/C₀)*100% where C is the particle concentration after passage through the non-woven fiber web of the first type and C₀ is the particle concentration before passage through the non-woven fiber web of the first type. The initial penetration is the penetration measured upon first exposure of the non-woven fiber web of the first type to the particles, and the initial air resistance is the air resistance measured upon first exposure of the non-woven fiber web of the first type to the particles.

The initial penetration and air resistance described herein are those measured using NaCl particles with an average diameter of 0.3 microns. The initial penetration and initial air resistance can both be measured using a variety of suitable instruments. As one example, the initial penetration and air resistance can be measured by employing a TSI 8130 Automated Filter Tester (8130 CertiTest™ Filter Tester from TSI). This instrument has a circular opening with an area of 100 cm² to analyze a flat-sheet article (e.g., filter media).

When measuring initial penetration and air resistance, the TSI 8130 Automated Filter Tester may be employed to blow an NaCl aerosol made up of NaCl particles with an average diameter of 0.3 microns at the non-woven fiber web of the first type. The NaCl particles may be generated from a 2 wt % aqueous solution of NaCl which is caused to form an NaCl aerosol by blowing dilution air through the solution at a rate of 70 L/min at a pressure of 30 psi. The aerosol may then be blown through the non-woven fiber webs at a pressure 30 psi and a rate of 32 L/min, which corresponds to a face velocity of 5.3 cm/s. As the TSI 8130 Automated Filter Tester is blowing the NaCl aerosol, both the air resistance across the non-woven fiber web of the first type and the penetration of the NaCl aerosol may be measured by two condensation nucleus particle counters simultaneously, one of which is upstream of the non-woven fiber web of the first type and one of which is downstream of the non-woven fiber web of the first type. The particle collection efficiency may be reported at the beginning of the test, and is the percentage of upstream challenge particles collected by the non-woven fiber web of the first type at the beginning of the test. The initial air resistance may also be measured at the beginning of the test.

The initial NaCl particle penetration at 0.3 microns for a non-woven fiber web of the first type may be greater than or equal to 0.1%, greater than or equal to 1%, greater than or equal to 2%, greater than or equal to 3%, greater than or equal to 4%, greater than or equal to 5%, greater than or equal to 7.5%, greater than or equal to 10%, greater than or equal to 15%, greater than or equal to 20%, greater than or equal to 25%, greater than or equal to 30%, greater than or equal to 40%, greater than or equal to 50%, greater than or equal to 60%, greater than or equal to 70%, greater than or equal to 80%, greater than or equal to 90%, or greater than or equal to 95%. The initial NaCl penetration at 0.3 microns for a non-woven fiber web of the first type may be less than or equal to 99.9%, less than or equal to 95%, less than or equal to 90%, less than or equal to 80%, less than or equal to 70%, less than or equal to 60%, less than or equal to 50%, less than or equal to 40%, less than or equal to 30%, less than or equal to 25%, less than or equal to 20%, less than or equal to 15%, less than or equal to 10%, less than or equal to 7.5%, less than or equal to 5%, less than or equal to 4%, less than or equal to 3%, less than or equal to 2%, or less than or equal to 1%. Combinations of the above-referenced ranges are also possible (e.g., greater than or equal to 0.1% and less than or equal to 99.9%, greater than or equal to 5% and less than or equal to 95%, or greater than or equal to 10% and less than or equal to 25%). Other ranges are also possible.

In embodiments in which an article comprises two or more non-woven fiber webs of the first type, each non-woven fiber web of the first type may independently have an initial NaCl penetration at 0.3 microns in one or more of the above-referenced ranges.

In some embodiments, the initial air resistance of a non-woven fiber web of the first type is greater than or equal to 1 mm H₂O, greater than or equal to 2 mm H₂O, greater than or equal to 3 mm H₂O, greater than or equal to 4 mm H₂O, greater than or equal to 5 mm H₂O, greater than or equal to 7.5 mm H₂O, greater than or equal to 10 mm H₂O, greater than or equal to 12.5 mm H₂O, greater than or equal to 15 mm H₂O, greater than or equal to 17.5 mm H₂O, greater than or equal to 20 mm H₂O, greater than or equal to 22.5 mm H₂O, greater than or equal to 25 mm H₂O, or greater than or equal to 27.5 mm H₂O. In some embodiments, the air resistance of a non-woven fiber web of the first type is less than or equal to 30 mm H₂O, less than or less than or equal to 27.5 mm H₂O, less than or equal to 25 mm H₂O, less than or equal to 22.5 mm H₂O, less than or equal to 20 mm H₂O, less than or equal to 17.5 mm H₂O, less than or equal to 15 mm H₂O, less than or equal to 12.5 mm H₂O, less than or equal to 10 mm H₂O, less than or equal to 7.5 mm H₂O, less than or equal to 5 mm H₂O, less than or equal to 4 mm H₂O, less than or equal to 3 mm H₂O, or less than or equal to 2 mm H₂O. Combinations of the above-referenced ranges are also possible (e.g., greater than or equal to 1 inch H₂O and less than or equal to 30 mm H₂O, greater than or equal to 2 mm H₂O and less than or equal to 25 mm H₂O, or greater than or equal to 5 mm H₂O and less than or equal to 15 mm H₂O). Other ranges are also possible.

In embodiments in which an article comprises two or more non-woven fiber webs of the first type, each non-woven fiber web of the first type may independently have an air resistance in one or more of the above-referenced ranges.

In some embodiments, a non-woven fiber web of the first type exhibits a relatively high dust holding capacity. The dust holding capacity of the non-woven fiber webs of the first type may be determined with respect to silica dirt and/or polystyrene spheres. Accordingly, further details regarding silica dirt retention and monodisperse polystyrene sphere retention are described in more detail below.

The non-woven fiber webs of the first type described herein may have any of a variety of suitable values of silica dirt retention and silica dirt solution flow rate. Measurements for silica dirt retention and silica dirt solution flow rate may be carried out by passing a 200 mL solution comprising silica dust (ISO121031A2) and having a turbidity level of 30 NTU through a sample of the non-woven fiber web of the first type having an effective area of 40.7 cm² using a gravity filter system. The turbidity of the solution can be measured both upstream of and downstream from this sample using a turbidity meter (one example of which is the MicroTPl System, 0.01-1100 NTU manufactured by HF Scientific). The percentage of silica dirt retention can be calculated according to the following equation: Retention=100%·(Initial Turbidity−Final Turbidity)/(Initial Turbidity), where “Initial Turbidity” is the turbidity of the solution prior to passing through the non-woven fiber web of the first type, and “Final Turbidity” is the turbidity of the solution after passing through the non-woven fiber web of the first type. The silica dirt solution flow rate can be calculated by measuring the time it takes for the entirety of the 200 mL solution to pass through the sample.

In some embodiments, the silica dirt retention for a non-woven fiber web of the first type is greater than or equal to 1%, greater than or equal to 2.5%, greater than or equal to 5%, greater than or equal to 7.5%, greater than or equal to 10%, greater than or equal to 15%, greater than or equal to 20%, greater than or equal to 25%, greater than or equal to 30%, greater than or equal to 40%, greater than or equal to 50%, greater than or equal to 60%, greater than or equal to 70%, greater than or equal to 80%, or greater than or equal to 90%. In some embodiments, the silica dirt retention for a non-woven fiber web of the first type is less than or equal to 100%, less than or equal to 90%, less than or equal to 80%, less than or equal to 70%, less than or equal to 60%, less than or equal to 50%, less than or equal to 40%, less than or equal to 30%, less than or equal to 25%, less than or equal to 20%, less than or equal to 15%, less than or equal to 10%, less than or equal to 7.5%, less than or equal to 5%, or less than or equal to 2.5%. Combinations of the above-referenced ranges are also possible (e.g., greater than or equal to 1% and less than or equal to 100%, greater than or equal to 5% and less than or equal to 50%, or greater than or equal to 10% and less than or equal to 30%). Other ranges are also possible.

In embodiments in which an article comprises two or more non-woven fiber webs of the first type, each non-woven fiber web of the first type may independently have a silica dirt retention in one or more of the above-referenced ranges.

The non-woven fiber webs of the first type described herein may have any of a variety of silica dirt solution flow rates. In some embodiments, the silica dirt solution flow rate for a non-woven fiber web of the first type is greater than or equal to 50 mL/min, greater than or equal to 75 mL/min, greater than or equal to 100 mL/min, greater than or equal to 125 mL/min, greater than or equal to 150 mL/min, greater than or equal to 180 mL/min, greater than or equal to 200 mL/min, greater than or equal to 225 mL/min, greater than or equal to 250 mL/min, greater than or equal to 275 mL/min, greater than or equal to 300 mL/min, greater than or equal to 325 mL/min, greater than or equal to 350 mL/min, or greater than or equal to 375 mL/min. In some embodiments, the silica dirt solution flow rate for a non-woven fiber web of the first type is less than or equal to 400 mL/min, less than or equal to 375 mL/min, less than or equal to 350 mL/min, less than or equal to 325 mL/min, less than or equal to 300 mL/min, less than or equal to 275 mL/min, less than or equal to 250 mL/min, less than or equal to 225 mL/min, less than or equal to 200 mL/min, less than or equal to 180 mL/min, less than or equal to 150 mL/min, less than or equal to 125 mL/min, less than or equal to 100 mL/min, or less than or equal to 75 mL/min. Combinations of the above-referenced ranges are also possible (e.g., greater than or equal to 50 mL/min and less than or equal to 400 mL/min, greater than or equal to 150 mL/min and less than or equal to 350 mL/min, or greater than or equal to 180 mL/min and less than or equal to 250 mL/min). Other ranges are also possible.

In embodiments in which an article comprises two or more non-woven fiber webs of the first type, each non-woven fiber web of the first type may independently have a silica dirt solution flow rate in one or more of the above-referenced ranges.

The non-woven fiber webs of the first type described herein may have any of a variety of suitable values of monodisperse polystyrene sphere retention and monodisperse polystyrene sphere solution flow rate. To measure the monodisperse polystyrene sphere retention and monodisperse polystyrene sphere solution flow rate, a solution comprising monodisperse polystyrene spheres may be flowed through a sample of the non-woven fiber web of the first type using a gravity filter system. The sample may have an effective area of 40.7 cm². The solution may be formed by dispersing monodisperse polystyrene spheres having a diameter of 7.32 microns in deionized water and may be formulated to have a turbidity of 30 NTU. The turbidity of the solution can be measured both upstream of and downstream from this sample using a turbidity meter (one example of which is the MicroTPl System, 0.01-1100 NTU manufactured by HF Scientific). The percentage of monodisperse polystyrene sphere retention can be calculated by using the following equation: Retention=100%·(Initial Turbidity−Final Turbidity)/(Initial Turbidity), where “Initial Turbidity” is the turbidity of the solution prior to passing through the non-woven fiber web of the first type, and “Final Turbidity” is the turbidity of the solution after passing through the non-woven fiber web of the first type. The monodisperse polystyrene sphere solution flow rate can be calculated by measuring the time it takes for 200 mL of the solution to pass through the sample.

In some embodiments, the monodisperse polystyrene sphere retention for a non-woven fiber web of the first type is greater than or equal to 1%, greater than or equal to 2.5%, greater than or equal to 5%, greater than or equal to 7.5%, greater than or equal to 10%, greater than or equal to 15%, greater than or equal to 20%, greater than or equal to 25%, greater than or equal to 30%, greater than or equal to 40%, greater than or equal to 50%, greater than or equal to 60%, greater than or equal to 70%, greater than or equal to 80%, or greater than or equal to 90%. In some embodiments, the monodisperse polystyrene sphere retention for a non-woven fiber web of the first type is less than or equal to 100%, less than or equal to 90%, less than or equal to 80%, less than or equal to 70%, less than or equal to 60%, less than or equal to 50%, less than or equal to 40%, less than or equal to 30%, less than or equal to 25%, less than or equal to 20%, less than or equal to 15%, less than or equal to 10%, less than or equal to 7.5%, less than or equal to 5%, or less than or equal to 2.5%. Combinations of the above-referenced ranges are also possible (e.g., greater than or equal to 1% and less than or equal to 100%, greater than or equal to 5% and less than or equal to 50%, or greater than or equal to 10% and less than or equal to 20%). Other ranges are also possible.

In embodiments in which an article comprises two or more non-woven fiber webs of the first type, each non-woven fiber web of the first type may independently have a monodisperse polystyrene sphere retention in one or more of the above-referenced ranges.

The non-woven fiber webs of the first type described herein may have any of a variety of values of monodisperse polystyrene sphere solution flow rate. In some embodiments, the monodisperse polystyrene sphere solution flow rate for a non-woven fiber web of the first type is greater than or equal to 50 mL/min, greater than or equal to 75 mL/min, greater than or equal to 100 mL/min, greater than or equal to 125 mL/min, greater than or equal to 150 mL/min, greater than or equal to 180 mL/min, greater than or equal to 200 mL/min, greater than or equal to 225 mL/min, greater than or equal to 250 mL/min, greater than or equal to 300 mL/min, greater than or equal to 350 mL/min, greater than or equal to 400 mL/min, or greater than or equal to 450 mL/min. In some embodiments, the monodisperse polystyrene sphere solution flow rate for a non-woven fiber web of the first type is less than or equal to 500 mL/min, less than or equal to 450 mL/min, less than or equal to 400 mL/min, less than or equal to 350 mL/min, less than or equal to 300 mL/min, less than or equal to 250 mL/min, less than or equal to 225 mL/min, less than or equal to 200 mL/min, less than or equal to 180 mL/min, less than or equal to 150 mL/min, less than or equal to 125 mL/min, less than or equal to 100 mL/min, or less than or equal to 75 mL/min. Combinations of the above-referenced ranges are also possible (e.g., greater than or equal to 50 mL/min and less than or equal to 500 mL/min, greater than or equal to 150 mL/min and less than or equal to 450 mL/min, or greater than or equal to 180 mL/min and less than or equal to 350 mL/min). Other ranges are also possible.

In embodiments in which an article comprises two or more non-woven fiber webs of the first type, each non-woven fiber web of the first type may independently have a monodisperse polystyrene sphere solution flow rate in one or more of the above-referenced ranges.

In embodiments in which the article is a filter media, the non-woven fiber webs of the first type may be positioned in a variety of suitable types of filter media and may have a variety of different functionalities. As one example, in some embodiments, a non-woven fiber webs of the first type is used as depth filtration layers in filter media for liquid filtrations. As another example, in some embodiments, a non-woven fiber webs of the first type may be used as a backer to provide structural support for one or more other layers in a filter media (e.g., microfiltration and/or ultrafiltration membranes). Non-limiting examples of further layers that may be employed in filter media with a non-woven fiber web of the first type are described in further detail below.

In some embodiments, a filter media comprises one or more additional layers in addition to one or more non-woven fiber webs of the first type described herein. In some embodiments, a filter media comprises one or more additional layers that are also non-woven fiber webs but differ from the non-woven fiber webs of the first type described herein in one or more ways. The additional layer(s) may include non-woven fiber webs comprising continuous fibers. For instance, in some embodiments, a non-woven fiber web comprises an additional layer that is a meltblown layer and/or an additional layer that is an electrospun layer.

Additional layers may serve a variety of roles in the filter media described herein. In some embodiments, a filter media comprises an additional layer that is an efficiency layer. It is also possible for a filter media to comprise an additional layer that serves as a prefilter layer (e.g., for a different additional layer serving as an efficiency layer). A prefilter layer may be positioned upstream of an efficiency layer and may assist with filtering out large particles from a fluid prior to exposing the fluid to the efficiency layer. In some such embodiments, the one or more additional layers that serve as the prefilter may improve the physical properties (e.g., dust holding capacity, air permeability, etc.) of the filter media. Alternatively or additionally, a filter media may comprise one or more additional layers that serve as backer(s) (e.g., for a non-woven fiber web of the first type, for another layer) to provide mechanical and structural support to the filter media and/or one or more layers therein.

In some embodiments, a non-woven fiber web of the first type serves as a backer. In such embodiments, it may be positioned in a filter media that further comprises one or more efficiency layers, prefilter layers, and/or other layers. In some embodiments, a filter media comprises a non-woven fiber web of the first type, an additional layer of the first type (e.g., a non-woven fiber web, a nanofiber layer) disposed on the non-woven fiber web of the first type, and an additional layer of the second type (e.g., a non-woven fiber web, a support layer) disposed on the additional layer of the first type. A filter media comprising this combination of layers may be particularly well-suited for applications that involve liquid filtration, including microfiltration and ultrafiltration in sterile environments. Additionally, such filter media may also be suitable for microfiltration and ultrafiltration for other applications, such as in the oil and gas, process water, wastewater, semiconductor, desalination, and/or chemical industries. One non-limiting example of a filter media comprising a non-woven fiber web of the first type and two additional layers is shown in FIG. 4. As shown in FIG. 4, a filter media 108 may include an additional layer of the first type 402 (e.g., a non-woven fiber web, a nanofiber layer), an additional layer of the second type 406 (e.g., a non-woven fiber web, a meltblown layer), and a non-woven fiber web of the first type 202. In some embodiments, the additional layer of the first type 402 and the additional layer of the second type 406 may be directly adjacent as shown in FIG. 4. In some such embodiments, the additional layers of the first and second types may be laminated or otherwise adhered together. As shown in FIG. 4, the filter media 108 may further comprise a non-woven fiber web of the first type 202 downstream of the additional layer of the first type 402. In some instances, a non-woven fiber web of the first type is directly adjacent to an additional layer of the first type. In other embodiments, a non-woven fiber web of the first type is indirectly adjacent to an additional layer of the first type, and one or more intervening layers (e.g., one or more non-woven fiber webs) separate the non-woven fiber web of the first type from the additional layer of the first type. For instance, with reference to FIG. 4, the filter media 108, in some embodiments, further comprises one or more additional layers disposed between the additional layer of the first type 402 and the non-woven fiber web of the first type 202. For instance, an additional support layer (e.g., a meltblown non-woven fiber web) that is similar to the additional layer of the second type may be disposed between non-woven fiber web of the first type and the additional layer of the first type.

As used herein, when a layer (e.g., a non-woven fiber web) is referred to as being “adjacent” another layer, it can be directly adjacent the layer, or an intervening layer also may be present. A layer that is “directly adjacent” another fiber web means that no intervening layer is present.

In some embodiments, a filter media comprises two or more additional layers of the first type and/or two or more additional layers of the second type. As one example, in some embodiments, a filter media comprises an additional layer of the first type positioned between two additional layers of the second type. Such a filter media may further comprise a non-woven fiber web of the first type adjacent to one of the additional layers of the second type.

Additionally, in some embodiments, a filter media described herein lacks an additional layer of the first type and/or lacks an additional layer of the second type. For instance, a filter media may comprise an additional layer of the first type and a non-woven fiber web of the first type but not an additional layer of the second type. As another example, a filter media may comprise an additional layer of the second type and a non-woven fiber web of the first type but not an additional layer of the first type.

It is also possible for a filter media to comprise additional layers of further types (e.g., a third type, a fourth type, a fifth type, etc.). Such additional layers may include cover layers, protective layers, support layers, and/or backers. When present, they may be positioned in any suitable location (e.g., external to the layers described herein, between two or more layers described herein). Additional layers of further types may include meltblown layers, wet laid layers, spunbond layers, carded layers, air-laid layers, spunlace layers, forcespun layers, and/or electrospun layers.

As described above, in some embodiments, a filter media comprises an additional layer of the first type. The additional layer of the first type may be a non-woven fiber web, such as a nanofiber layer. In some embodiments, an additional layer of the first type is an electrospun layer (e.g., a solvent electrospun layer, a melt electrospun layer), a meltspun layer, and/or a centrifugal spun layer. Further details regarding the additional layer of the first type are provided below.

When an additional layer of the first type is present, its structural features may be balanced to produce a layer that imparts beneficial properties to the filter media while having certain properties that are similar or substantially the same as another layer also present in the filter media (e.g., a second additional layer). In some embodiments, an additional layer of the first type has a relatively small average fiber diameter. This feature may impart a relatively high particulate efficiency and/or surface area to the filter media. Additionally, in some embodiments, an additional layer of the first type has a relatively low maximum pore size, high permeability, low basis weight, and/or low solidity.

In some embodiments, an additional layer of the first type may have a relatively small maximum pore size. For instance, in some embodiments, an additional layer of the first type has a maximum pore size of less than or equal to 5 microns, less than or equal to 4 microns, less than or equal to 3 microns, less than or equal to 2.5 microns, less than or equal to 2.3 microns, less than or equal to 2 microns, less than or equal to 1.8 microns, less than or equal to 1.5 microns, less than or equal to 1.4 microns, less than or equal to 1.3 microns, less than or equal to 1.2 microns, less than or equal to 1.1 microns, less than or equal to 1 micron, less than or equal to 0.8 microns, less than or equal to 0.5 microns, less than or equal to 0.4 microns, less than or equal to 0.3 microns, less than or equal to 0.2 microns, less than or equal to 0.1 microns, less than or equal to 0.09 microns, less than or equal to 0.08 microns, less than or equal to 0.07 microns, or less than or equal to 0.6 microns. In some instances, an additional layer of the first type has a maximum pore size of greater than or equal to 0.05 microns, greater than or equal to 0.06 microns, greater than or equal to 0.07 microns, greater than or equal to 0.08 microns, greater than or equal to 0.09 microns, greater than or equal to 0.1 microns, greater than or equal to 0.2 microns, greater than or equal to 0.3 microns, greater than or equal to 0.4 microns, greater than or equal to 0.5 microns, greater than or equal to 0.8 microns, greater than or equal to 1 micron, greater than or equal to 1.1 microns, greater than or equal to 1.2 microns, greater than or equal to 1.3 microns, greater than or equal to 1.4 microns, greater than or equal to 1.5 microns, greater than or equal to 1.8 microns, greater than or equal to 2 microns, greater than or equal to 2.3 microns, greater than or equal to 2.5 microns, greater than or equal to 3 microns, or greater than or equal to 4 microns. Combinations of the above-referenced ranges are also possible (e.g., greater than or equal to 0.05 microns and less than or equal to 5 microns, greater than or equal to 0.05 microns and less than or equal to 2.5 microns, greater than or equal to 0.05 microns and less than or equal to 1 micron, greater than or equal to 0.1 microns and less than or equal to 0.8 microns). Other values ranges are also possible.

The maximum pore size of an additional layer of the first type may be determined in accordance with ASTM F316 (2003).

When a filter media comprises two or more additional layers of the first type, each additional layer of the first type may independently have a maximum pore size in one or more of the above-referenced ranges.

In some embodiments, an additional layer of the first type may have a relatively small mean flow pore size. For instance, in some embodiments, an additional layer of the first type has a mean flow pore size of less than or equal to 3 microns, less than or equal to 2.5 microns, less than or equal to 2 microns, less than or equal to 1.5 microns, less than or equal to 1 micron, less than or equal to 0.8 microns, less than or equal to 0.5 microns, less than or equal to 0.4 microns, less than or equal to 0.3 microns, less than or equal to 0.2 microns, less than or equal to 0.1 microns, less than or equal to 0.09 microns, less than or equal to 0.08 microns, less than or equal to 0.07 microns, or less than or equal to 0.6 microns. In some instances, an additional layer of the first type has a mean flow pore size of greater than or equal to 0.05 microns, greater than or equal to 0.06 microns, greater than or equal to 0.07 microns, greater than or equal to 0.08 microns, greater than or equal to 0.09 microns, greater than or equal to 0.1 microns, greater than or equal to 0.2 microns, greater than or equal to 0.3 microns, greater than or equal to 0.4 microns, greater than or equal to 0.5 microns, greater than or equal to 0.8 microns, greater than or equal to 1 micron, greater than or equal to 1.5 microns, greater than or equal to 2 microns, or greater than or equal to 2.5 microns. Combinations of the above-referenced ranges are also possible (e.g., greater than or equal to 0.05 microns and less than or equal to 3 microns, greater than or equal to 0.05 microns and less than or equal to 1 micron, greater than or equal to 0.1 microns and less than or equal to 0.8 microns). Other values ranges are also possible.

The mean flow pore size of an additional layer of the first type may be determined in accordance with ASTM F316 (2003).

When a filter media comprises two or more additional layers of the first type, each additional layer of the first type may independently have a mean flow pore size in one or more of the above-referenced ranges.

In some embodiments, an additional layer of the first type has a relatively low ratio of maximum pore size to mean flow pore size. For instance, in some embodiments, the ratio of maximum pore size to mean flow pore size for an additional layer of the first type is less than or equal to 5.0, less than or equal to 4.8, less than or equal to 4.5, less than or equal to 4.2, less than or equal to 4.0, less than or equal to 3.8, less than or equal to 3.5, less than or equal to 3.2, less than or equal to 3.0, less than or equal to 2.7, less than or equal to 2.5, less than or equal to 2.2, less than or equal to 2.0, less than or equal to 1.8, less than or equal to 1.5, or less than or equal to 1.2. In some instances, the ratio of maximum pore size to mean flow pore size for an additional layer of the first type is greater than or equal to 1, greater than or equal to 1.2, greater than or equal to 1.5, greater than or equal to 1.8, greater than or equal to 2.0, greater than or equal to 2.3, greater than or equal to 2.5, greater than or equal to 2.8, greater than or equal to 3.0, greater than or equal to 3.2, greater than or equal to 3.5, greater than or equal to 3.8, greater than or equal to 4.0, greater than or equal to 4.2, greater than or equal to 4.5, or greater than or equal to 4.8. Combinations of the above-referenced ranges are also possible (e.g., greater than or equal to 1.0 and less than or equal to 5.0, greater than or equal to 2.3 and less than or equal to 2.7). When a filter media comprises two or more additional layers of the first type, each additional layer of the first type may independently have a ratio of maximum pore size to mean flow pore size in one or more of the above-referenced ranges.

In some embodiments, an additional layer of the first type has an average fiber diameter of less than or equal to 5 microns, less than or equal to 4 microns, less than or equal to 3 microns, less than or equal to 2 microns, less than or equal to 1 micron, less than or equal to 0.75 microns, less than or equal to 0.5 microns, less than or equal to 0.4 microns, less than or equal to 0.3 microns, less than or equal to 0.2 microns, less than or equal to 0.1 microns, less than or equal to 0.08 microns, less than or equal to 0.06 microns, less than or equal to 0.05 microns, less than or equal to 0.04 microns, less than or equal to 0.03 microns, or less than or equal to 0.02 microns. In some instances, the average fiber diameter of an additional layer of the first type is greater than or equal to 0.01 microns, greater than or equal to 0.02 microns, greater than or equal to 0.03 microns, greater than or equal to 0.04 microns, greater than or equal to 0.05 microns, greater than or equal to 0.06 microns, greater than or equal to 0.08 microns, greater than or equal to 0.1 microns, greater than or equal to 0.2 microns, greater than or equal to 0.3 microns, greater than or equal to 0.4 microns, greater than or equal to 0.5 microns, greater than or equal to 0.75 microns, greater than or equal to 1 micron, greater than or equal to 2 microns, greater than or equal to 3 microns, or greater than or equal to 4 microns. Combinations of the above-referenced ranges are also possible (e.g., greater than or equal to 0.01 microns and less than or equal to 5 microns, greater than or equal to 0.01 microns and less than or equal to 0.5 microns, or greater than or equal to 0.05 microns and less than or equal to 0.5 microns). Other ranges are also possible.

When a filter media comprises two or more additional layers of the first type, each additional layer of the first type may independently have an average fiber diameter in one or more of the above-referenced ranges.

Additional layers of the first type may have a variety of suitable amounts of fibers having a fiber diameter in one or more of the above-referenced ranges for average fiber diameter. In some embodiments, greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, greater than or equal to 90 wt %, greater than or equal to 95 wt %, or greater than or equal to 99 wt % of the fibers in an additional layer of the first type are in one or more of the above-referenced ranges. In some embodiments, less than or equal to 100 wt %, less than or equal to 99 wt %, less than or equal to 95 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, or less than or equal to 10 wt % of the fibers in an additional layer of the first type are in one or more of the above-referenced ranges for average fiber diameter. Combinations of these ranges are also possible (e.g., greater than or equal to 5 wt % and less than or equal to 100 wt %, greater than or equal to 10 wt % and less than or equal to 100 wt %, or greater than or equal to 80 wt % and less than or equal to 100 wt %). In some embodiments, identically 100 wt % of the fibers in an additional layer of the first type are in one or more of the above-referenced ranges for average fiber diameter.

When a filter media comprises two or more additional layers of the first type, each additional layer of the first type may independently comprise an amount of fibers in one or more of the ranges in the preceding paragraph that have a diameter in one or more of the above-referenced ranges for average fiber diameter.

Fibers in an additional layer of the first type may have a variety of suitable fiber diameter standard deviations. In some embodiments, the standard deviation of the fiber diameter for the fibers in an additional layer of the first type is greater than or equal to 10 nm, greater than or equal to 20 nm, greater than or equal to 30 nm, greater than or equal to 40 nm, greater than or equal to 50 nm, greater than or equal to 60 nm, greater than or equal to 70 nm, greater than or equal to 80 nm, or greater than or equal to 90 nm. In some embodiments, the standard deviation of the fiber diameter for the fibers in an additional layer of the first type is less than or equal to 100 nm, less than or equal to 90 nm, less than or equal to 80 nm, less than or equal to 70 nm, less than or equal to 60 nm, less than or equal to 50 nm, less than or equal to 40 nm, less than or equal to 30 nm, less than or equal to 20 nm, or less than or equal to 15 nm. Combinations of these ranges are also possible (e.g., greater than or equal to 10 nm and less than or equal to 100 nm, greater than or equal to 20 nm and less than or equal to 90 nm, or greater than or equal to 30 nm and less than or equal to 70 nm).

When a filter media comprises two or more additional layers of the first type, each additional layer of the first type may independently have a standard deviation of the fiber diameter in one or more of the above-referenced ranges.

Additional layers of the first type described herein may have a variety of average fiber lengths per weight (i.e., average fiber length of the fibers therein divided by the average weight of the fibers therein). In some embodiments, an additional layer of the first type has an average fiber length per weight of greater than or equal to 2×10⁷ mm/g, greater than or equal to 2×10⁸ mm/g, greater than or equal to 2×10⁹ mm/g, greater than or equal to 1.21×10¹⁰ mm/g, greater than or equal to 3×10¹⁰ mm/g, greater than or equal to 5×10¹⁰ mm/g, greater than or equal to 7×10¹⁰ mm/g, greater than or equal to 9×10¹⁰ mm/g, greater than or equal to 1×10¹¹ mm/g, greater than or equal to 2.8×10¹¹ mm/g, greater than or equal to 5.3×10¹¹ mm/g, greater than or equal to 7×10¹¹ mm/g, greater than or equal to 9×10¹¹ mm/g, or greater than or equal to 1×10¹² mm/g. In some embodiments, an additional layer of the first type has an average fiber length per weight of an average fiber length per weight of less than or equal to 2.28×10¹² mm/g, less than or equal to 1×10¹² mm/g, less than or equal to 9×10¹¹ mm/g, less than or equal to 7.8×10¹¹ mm/g, less than or equal to 5×10¹¹ mm/g, less than or equal to 3×10¹¹ mm/g, less than or equal to 1×10¹¹ mm/g, less than or equal to 9×10¹⁰ mm/g, less than or equal to 7×10¹⁰ mm/g, less than or equal to 5×10¹⁰ mm/g, less than or equal to 3×10¹⁰ mm/g, less than or equal to 3×10⁹ mm/g, or less than or equal to 3×10⁸ mm/g. Combinations of these references are also possible (e.g., greater than or equal to 2×10⁷ mm/g and less than or equal to 2.28×10¹² mm/g, greater than or equal to 1.21×10¹⁰ mm/g and less than or equal to 2.28×10¹² mm/g, greater than or equal to 2.8×10¹¹ mm/g and less than or equal to 1×10¹² mm/g, or greater than or equal to 5.3×10¹¹ mm/g and less than or equal to 7.8×10¹¹ mm/g).

When a filter media comprises two or more additional layers of the first type, each additional layer of the first type may independently have an average fiber length per weight in one or more of the above-referenced ranges.

In some embodiments, a filter media comprises an additional layer of the first type that has one or more properties that are similar or substantially the same as those of an additional layer of the second type also present in the filter media. The similarities between the additional layers may serve to enhance the permeability to certain fluids (e.g., water), the bonding between the additional layers, and/or the structural stability of the filter media under various conditions (e.g., high temperature, high pressure, steam sterilization). For instance, filter media comprising additional layers of the first and second type having substantially the same or similar water contact angle, critical surface tension, and/or critical wetting surface tension may exhibit enhanced wetting characteristics (e.g., fluid absorption and permeability) and/or bonding compared to a filter media comprising additional layers of the first and second type that are dissimilar with respect to these properties.

In some embodiments, an additional layer of the first type comprises an additional layer of the first type comprising substantially the same or similar materials as an additional layer of the second type. This may serve to enhance bonding between additional layers resulting from a heat lamination process. For example, a filter media may comprise additional layers of the first and second types that are both nylon, or any suitable material described herein. In some embodiments, additional layers of the first and/or second type comprise a material (e.g., nylon) such that water has a relatively low water contact angle with the fibers (e.g., less than or equal to 90°, less than or equal to 75°, less than or equal to 60°, less than or equal to 30°). This may facilitate high flow rate of aqueous fluid through the filter media during filtration of the aqueous fluid by the filter media.

In some embodiments, a filter media may comprise additional layers of the first and second types that have similar or substantially the same wettability with respect to a particular fluid. The wettability may be determined using water contact angle, critical surface tension, and/or critical wetting surface tension. In some instances, more than one type of measurement of wettability is needed to fully characterize the wettability of a fiber web.

The water contact angle for an additional layer may be measured using standard ASTM D5946 (2009) as described elsewhere herein with respect to the non-woven fiber web of the first type.

In some embodiments, an additional layer of the first type has a water contact angle that differs from that of an additional layer of the second type also present in the filter media by less than or equal to 40°, less than or equal to 35°, less than or equal to 30°, less than or equal to 25°, less than or equal to 20°, less than or equal to 18°, less than or equal to 15°, less than or equal to 12°, less than or equal to 10°, less than or equal to 8°, less than or equal to 5°, less than or equal to 3°, or less than or equal to 1° and greater than or equal to 0°. In some embodiments, an additional layer of the first type has a water contact angle that is substantially the same as the water contact angle of an additional layer of the second type also present in the filter media. In certain embodiments, the difference in water contact angles may be greater than 0°. In some embodiments, an additional layer of the first type and/or an additional layer of the second type has a water contact angle of greater than or equal to 0°, greater than or equal to 5°, greater than or equal to 10°, greater than or equal to 15°, greater than or equal to 20°, greater than or equal to 25°, greater than or equal to 30°, greater than or equal to 35°, greater than or equal to 40°, greater than or equal to 45°, greater than or equal to 50°, greater than or equal to 55°, greater than or equal to 60°, greater than or equal to 65°, greater than or equal to 70°, greater than or equal to 75°, greater than or equal to 80°, greater than or equal to 85°, greater than or equal to 90°, greater than or equal to 95°, greater than or equal to 100°, greater than or equal to 110°, greater than or equal to 120°, greater than or equal to 130°, or greater than or equal to 140°. In some instances, an additional layer of the first type and/or an additional layer of the second type has a water contact angle of less than or equal to 150°, less than or equal to 140°, less than or equal to 130°, less than or equal to 120°, less than or equal to 110°, less than or equal to 105°, less than or equal to 100°, less than or equal to 95°, less than or equal to 90°, less than or equal to 85°, less than or equal to 80°, less than or equal to 75°, less than or equal to 70°, less than or equal to 65°, less than or equal to 60°, less than or equal to 55°, less than or equal to 50°, less than or equal to 45°, less than or equal to 40°, less than or equal to 35°, less than or equal to 30°, less than or equal to 25°, less than or equal to 20°, less than or equal to 15°, less than or equal to 10°, or less than or equal to 5°. Combinations of the above-referenced ranges are also possible (e.g., greater than or equal to 0° and less than or equal to 150°, greater than or equal to 30° and less than or equal to 150°, greater than or equal to 50° and less than or equal to 130°, or greater than or equal to 90° and less than or equal to 120°). Other ranges are also possible. For example, in some embodiments (when an additional layer of the first type and/or an additional layer of the second type is an electrospun layer), the additional layer of the first type and/or the additional layer of the second type has a water contact angle of greater than or equal to 30°.

When a filter media comprises two or more additional layers, each additional layer may independently have a water contact angle in one or more of the above-referenced ranges.

The critical surface tension of an additional layer may be determined using the wetting tension method, per ASTM D2578-17, at ambient temperature (e.g., 21° C.).

In some embodiments, a filter media comprises first and second additional layers that differ in critical surface tension by less than or equal to 15 dynes/cm, less than or equal to 12 dynes/cm, less than or equal to 10 dynes/cm, less than or equal to 7 dynes/cm, less than or equal to 5 dynes/cm, less than or equal to 3 dynes/cm, or less than or equal to 1 dynes/cm and greater than or equal to 0 dynes/cm. In some embodiments, a filter media comprises first and second additional layers having critical surface tensions that are substantially the same. In some embodiments, a filter media comprises first and second additional layers having critical surface tensions that differ by greater than 0 dynes/cm.

In some embodiments, a filter media comprises an additional layer of the first type and/or an additional layer of the second type having a critical surface tension of greater than or equal to 18 dynes/cm, greater than or equal to 25 dynes/cm, greater than or equal to 50 dynes/cm, greater than or equal to 75 dynes/cm, greater than or equal to 100 dynes/cm, greater than or equal to 150 dynes/cm, greater than or equal to 200 dynes/cm, greater than or equal to 250 dynes/cm, greater than or equal to 300 dynes/cm, or greater than or equal to 350 dynes/cm. In some instances, a filter media comprises an additional layer of the first type and/or an additional layer of the second type having a critical surface tension of less than or equal to 400 dynes/cm, less than or equal to 375 dynes/cm, less than or equal to 350 dynes/cm, less than or equal to 325 dynes/cm, less than or equal to 300 dynes/cm, less than or equal to 250 dynes/cm, less than or equal to 200 dynes/cm, less than or equal to 150 dynes/cm, less than or equal to 100 dynes/cm, or less than or equal to 50 dynes/cm. Combinations of the above-referenced ranges are possible (e.g., greater than or equal to 18 dynes/cm and less than or equal to 400 dynes/cm, greater than or equal to 25 dynes/cm and less than or equal to 400 dynes/cm). Other ranges are also possible.

When a filter media comprises two or more additional layers, each additional layer may independently have a critical surface tension in one or more of the above-referenced ranges.

As used herein, the critical wetting surface tension of an additional layer is defined as the mean of the surface tension of the last liquid in a series that is absorbed by the additional layer and the surface tension of the first liquid in a series that is not absorbed by the additional layer using the test described below. The critical wetting surface tension of an additional layer may be determined by applying a series of liquids in a sequential manner (i.e., from lowest surface tension to highest surface tension) to the surface of the additional layer and observing the absorption or non-absorption of each liquid as described in U.S. Pat. No. 4,880,548, which is incorporated by reference in its entirety. The technique involves placing ten drops of a first liquid and 10 drops of a second liquid onto representative portions of the additional layer and allowing the drops to stand for 10 minutes. The diameter of the droplets is between 3 mm and 5 mm. The two liquids should be selected so that the difference in surface tension between them is 2 dynes/cm. Absorption is defined as the wetting of an additional layer on its top and bottom surface by at least nine of the ten drops within 10 minutes. Non-absorption is defined as the condition when at least nine of the ten drops do not fully penetrate through the additional layer. In other words, the condition when at least nine of the ten drops do not reach the bottom surface of the additional layer. Testing is continued using liquids of successively higher or lower surface tension, until a pair has been identified, one absorbing and one non-absorbing, which are the most closely spaced in surface tension. The critical wetting surface tension is then within that range and the average of the two surface tensions is used as a single number to specify the critical wetting surface tension.

In some embodiments, a filter media comprises first and second additional layers that differ in critical wetting surface tension by less than or equal to 15 dynes/cm, less than or equal to 12 dynes/cm, less than or equal to 10 dynes/cm, less than or equal to 8 dynes/cm, less than or equal to 5 dynes/cm, less than or equal to 3 dynes/cm, or less than or equal to 1 dyne/cm and greater than or equal to 0 dynes/cm. In some embodiments, the critical wetting surface tensions of the first and second additional layers are substantially the same. In certain embodiments, the first and second additional layers have critical wetting surface tensions that differ by more than 0 dynes/cm.

In some embodiments, the critical wetting surface tension of a first and/or second additional layer is greater than or equal to 10 dynes/cm, greater than or equal to 15 dynes/cm, greater than or equal to 25 dynes/cm, greater than or equal to 30 dynes/cm, greater than or equal to 40 dynes/cm, greater than or equal to 50 dynes/cm, greater than or equal to 60 dynes/cm, greater than or equal to 70 dynes/cm, greater than or equal to 80 dynes/cm, or greater than or equal to 90 dynes/cm. In some instances, the critical wetting surface tension of a first and/or second additional layer is less than or equal to 110 dynes/cm, less than or equal to 100 dynes/cm, less than or equal to 90 dynes/cm, less than or equal to 80 dynes/cm, less than or equal to 72 dynes/cm, less than or equal to 60 dynes/cm, less than or equal to 50 dynes/cm, less than or equal to 40 dynes/cm, less than or equal to 30 dynes/cm, or less than or equal to 20 dynes/cm. Combinations of the above-referenced ranges are possible (e.g., greater than or equal to 10 dynes/cm and less than or equal to 110 dynes/cm, greater than or equal to 25 dynes/cm and less than or equal to 72 dynes/cm). Other ranges are also possible.

When a filter media comprises two or more additional layers, each additional layer may independently have a critical wetting surface tension in one or more of the above-referenced ranges.

In some embodiments, an additional layer of the first type has a relatively low basis weight. For instance, in some embodiments, the basis weight of an additional layer of the first type is less than or equal to 25% (e.g., less than or equal to 20%, less than or equal to 15%, less than or equal to 10%, less than or equal to 9%, less than or equal to 8%, less than or equal to 7%, less than or equal to 6%, less than or equal to 5%, less than or equal to 4%, less than or equal to 3%, less than or equal to 2%, or less than or equal to 1% and/or greater than or equal to 0.8%, greater than or equal to 1%, greater than or equal to 2%, greater than or equal to 3%, greater than or equal to 4%, greater than or equal to 5%, greater than or equal to 6%, greater than or equal to 7%, greater than or equal to 9%, greater than or equal to 10%, greater than or equal to 15%, or greater than or equal to 20%) of the basis weight of the filter media (e.g., combined basis weight of the additional layer of the first type and any further layers also present) and/or of an additional layer of the second type also present in the filter media.

In some embodiments, an additional layer of the first type has a basis weight of less than or equal to 10 gsm, less than or equal to 9 gsm, less than or equal to 8 gsm, less than or equal to 7 gsm, less than or equal to 6 gsm, less than or equal to 5 gsm, less than or equal to 4 gsm, less than or equal to 3 gsm, less than or equal to 2 gsm, or less than or equal to 1 gsm. In some instances, an additional layer of the first type has a basis weight of greater than or equal to 0.5 gsm, greater than or equal to 1 gsm, greater than or equal to 2 gsm, greater than or equal to 3 gsm, greater than or equal to 4 gsm, greater than or equal to 5 gsm, greater than or equal to 6 gsm, greater than or equal to 7 gsm, or greater than or equal to 8 gsm. Combinations of the above-referenced ranges are possible (e.g., greater than or equal to 0.5 gsm and less than or equal to 10 gsm, greater than or equal to 1 gsm and less than or equal to 5 gsm). Other ranges are also possible.

The basis weight may be determined according to the standard ISO 536:2012.

When a filter media comprises two or more additional layers of the first type, each additional layer of the first type may independently have a basis weight in one or more of the above-referenced ranges.

As described in more detail below, additional layers of the first type may comprise synthetic fibers, amongst other fiber types. In some instances, an additional layer of the first type comprises a relatively high weight percentage of synthetic fibers (e.g., greater than or equal to 95 wt %, identically 100 wt %). In some instances, the synthetic fibers may be continuous as described further below. For example, an additional layer of the first type may comprise a relatively high percentage (e.g., greater than or equal to 95 wt %, identically 100 wt %) of synthetic fibers formed via an electrospinning process. In general, an additional layer of the first type may comprise synthetic fibers formed by any suitable process including an electrospinning process, a meltblown process, a melt spinning process, and/or a centrifugal spinning process.

When a filter media comprises two or more additional layers of the first type, each additional layer of the first type may independently have a wt % of synthetic fibers in one or more of the above-referenced ranges and/or may be of one or more of the above-referenced types.

In some embodiments, an additional layer of the first type is relatively thin. For instance, in some embodiments, an additional layer of the first type has a thickness of less than or equal to 8 mil, less than or equal to 7 mil, less than or equal to 6 mil, less than or equal to 5 mil, less than or equal to 4.5 mil, less than or equal to 4 mil, less than or equal to 3.5 mil, less than or equal to 3 mil, less than or equal to 2.5 mil, less than or equal to 2 mil, less than or equal to 1.5 mil, less than or equal to 1 mil, less than or equal to 0.9 mil, less than or equal to 0.8 mil, less than or equal to 0.7 mil, less than or equal to 0.6 mil, less than or equal to 0.5 mil, or less than or equal to 0.4 mil. In some instances, an additional layer of the first type has a thickness of greater than or equal to 0.15 mil, greater than or equal to 0.2 mil, greater than or equal to 0.3 mil, greater than or equal to 0.4 mil, greater than or equal to 0.5 mil, greater than or equal to 0.6 mil, greater than or equal to 0.7 mil, greater than or equal to 0.8 mil, greater than or equal to 0.9 mil, greater than or equal to 1 mil, greater than or equal to 1.5 mil, greater than or equal to 2 mil, greater than or equal to 2.5 mil, greater than or equal to 3 mil, greater than or equal to 3.5 mil, greater than or equal to 4 mil, greater than or equal to 5 mil, greater than or equal to 6 mil, or greater than or equal to 7 mil. Combinations of the above-referenced ranges are also possible (e.g., greater than or equal to 0.2 mil and less than or equal to 7 mil, greater than or equal to 0.2 mil and less than or equal to 6 mil, greater than or equal to 0.4 mil and less than or equal to 5 mil, greater than or equal to 0.6 mil and less than or equal to 5 mil). Other values of average thickness are also possible.

The thickness of an additional layer of the first type described may be measured in an uncompressed state, i.e., when the additional layer of the first type has not been subjected to pressure or compression during measurement of the thickness. When a filter media comprises two or more additional layers of the first type, each additional layer of the first type may independently have a thickness in one or more of the above-referenced ranges.

In certain embodiments, an additional layer has a relatively high surface area. For instance, in some embodiments, the first fiber web may have a surface area of greater than or equal to 5 m²/g, greater than or equal to 10 m²/g, greater than or equal to 25 m²/g, greater than or equal to 50 m²/g, greater than or equal to 75 m²/g, greater than or equal to 100 m²/g, greater than or equal to 125 m²/g, greater than or equal to 150 m²/g, greater than or equal to 175 m²/g, greater than or equal to 200 m²/g, greater than or equal to 225 m²/g, greater than or equal to 250 m²/g, greater than or equal to 275 m²/g, or greater than or equal to 300 m²/g. In some instances, an additional layer of the first type has a surface area of less than or equal to 350 m²/g, less than or equal to 325 m²/g, less than or equal to 300 m²/g, less than or equal to 275 m²/g, less than or equal to 250 m²/g, less than or equal to 225 m²/g, less than or equal to 200 m²/g, less than or equal to 175 m²/g, less than or equal to 150 m²/g, less than or equal to 125 m²/g, less than or equal to 100 m²/g, less than or equal to 70 m²/g, less than or equal to 40 m²/g, or less than or equal to 10 m²/g. Combinations of the above-reference ranges are also possible (e.g., greater than or equal to 5 m²/g and less than or equal to 350 m²/g, greater than or equal to 5 m²/g and less than or equal to 70 m²/g). Other ranges are also possible.

The surface area of an additional layer of the first type may be measured through use of a standard BET surface area measurement technique. The BET surface area is measured according to section 10 of Battery Council International Standard BCIS-03a Rev Sep09, “Recommended Battery Materials Specifications Valve Regulated Recombinant Batteries”, section 10 being “Standard Test Method for Surface Area of Recombinant Battery Separator Mat”. Following this technique, the BET surface area may be measured via adsorption analysis using a BET surface analyzer (e.g., Micromeritics Gemini III 2375 Surface Area Analyzer) with nitrogen gas; the sample amount may be between 0.5 and 0.6 grams in, e.g., a ¾″ tube; and, the sample may be allowed to degas at 100° C. for a minimum of 3 hours.

When a filter media comprises two or more additional layers of the first type, each additional layer of the first type may independently have a surface area in one or more of the above-referenced ranges.

In certain embodiments, an additional layer of the first type has a relatively low solidity. For instance, in some embodiments, an additional layer of the first type has a solidity of less than or equal to 30%, less than or equal to 28%, less than or equal to 25%, less than or equal to 22%, less than or equal to 20%, less than or equal to 18%, less than or equal to 15%, less than or equal to 12%, less than or equal to 10%, less than or equal to 8%, or less than or equal to 5%. In some instances, an additional layer of the first type has a solidity of greater than or equal to 2%, greater than or equal to 5%, greater than or equal to 8%, greater than or equal to 10%, greater than or equal to 12%, greater than or equal to 15%, greater than or equal to 18%, greater than or equal to 20%, greater than or equal to 22%, greater than or equal to 25%, or greater than or equal to 28%. Combinations of the above-reference ranges are possible (e.g., greater than or equal to 2% and less than or equal to 30%, or greater than or equal to 10% and less than or equal to 30%). Other ranges are also possible.

The solidity of an additional layer of the first type may be determined by the same technique described above with respect to the non-woven fiber webs of the first type.

When a filter media comprises two or more additional layers of the first type, each additional layer of the first type may independently have a solidity in one or more of the above-referenced ranges.

In some embodiments, the porosity of an additional layer of the first type is greater than or equal to 70%, greater than or equal to 72%, greater than or equal to 75%, greater than or equal to 78%, greater than or equal to 80%, greater than or equal to 82%, greater than or equal to 85%, greater than or equal to 88%, greater than or equal to 90%, greater than or equal to 92%, or greater than or equal to 95%. In some instances, the porosity of an additional layer of the first type is less than or equal to 98%, less than or equal to 95%, less than or equal to 92%, less than or equal to 90%, less than or equal to 88%, less than or equal to 85%, less than or equal to 82%, less than or equal to 80%, less than or equal to 78%, less than or equal to 75%, or less than or equal to 72%. Combinations of the above-referenced ranges are possible (e.g., greater than or equal to 70% and less than or equal to 98%, or greater than or equal to 70% and less than or equal to 90%). Other ranges are also possible.

When a filter media comprises two or more additional layers of the first type, each additional layer of the first type may independently have a porosity in one or more of the above-referenced ranges.

In some embodiments, a filter media comprises an additional layer of the second type. The additional layer of the second type may be a non-woven fiber web, such as a meltblown layer. The additional layer of the second type may be configured to impart beneficial properties (e.g., mechanical support, high dust holding capacity) to the filter media while having relatively minimal or no adverse effects on one or more properties of the filter media that are important for a given application, such as permeability, structural stability, and/or particulate efficiency. Further details regarding the additional layer of the second type are provided below.

In some embodiments, an additional layer of the second type has a maximum pore size of less than or equal to 70 microns, less than or equal to 60 microns, less than or equal to 50 microns, less than or equal to 40 microns, less than or equal to 30 microns, less than or equal to 20 microns, less than or equal to 10 microns, less than or equal to 8 microns, less than or equal to 5 microns, or less than or equal to 2 microns. In some instances, an additional layer of the second type has a maximum pore size of greater than or equal to 1 micron, greater than or equal to 3 microns, greater than or equal to 5 microns, greater than or equal to 10 microns, greater than or equal to 20 microns, greater than or equal to 30 microns, greater than or equal to 40 microns, greater than or equal to 50 microns, or greater than or equal to 60 microns. Combinations of the above-referenced ranges are also possible (e.g., greater than or equal to 1 micron and less than or equal to 70 microns, greater than or equal to 3 microns and less than or equal to 30 microns). Other values ranges are also possible.

The maximum pore size of an additional layer of the second type may be determined in accordance with ASTM F316 (2003).

When a filter media comprises two or more additional layers of the second type, each additional layer of the second type may independently have a maximum pore size in one or more of the above-referenced ranges.

In some embodiments, an additional layer of the second type has a mean flow pore size of greater than or equal to 5 microns, greater than or equal to 8 microns, greater than or equal to 10 microns, greater than or equal to 12 microns, greater than or equal to 15 microns, greater than or equal to 18 microns, greater than or equal to 20 microns, greater than or equal to 22 microns, greater than or equal to 25 microns, or greater than or equal to 28 microns. In some instances, an additional layer of the second type has a mean flow pore size of less than or equal to 30 microns, less than or equal to 28 microns, less than or equal to 25 microns, less than or equal to 22 microns, less than or equal to 20 microns, less than or equal to 18 microns, less than or equal to 15 microns, less than or equal to 12 microns, less than or equal to 10 microns, or less than or equal to 8 microns. Combinations of the above-referenced ranges are also possible (e.g., greater than or equal to 5 microns and less than or equal to 30 microns, greater than or equal to 15 microns and less than or equal to 25 microns).

The mean flow pore size of an additional layer of the second type may be determined in accordance with ASTM F316 (2003).

When a filter media comprises two or more additional layers of the second type, each additional layer of the second type may independently have a mean flow pore size in one or more of the above-referenced ranges.

In some embodiments, an additional layer of the second type has a solidity of less than or equal to 95%, less than or equal to 90%, less than or equal to 85%, less than or equal to 80%, less than or equal to 75%, less than or equal to 70%, less than or equal to 65%, less than or equal to 60%, less than or equal to 55%, less than or equal to 50%, less than or equal to 45%, less than or equal to 40%, less than or equal to 35%, less than or equal to 30%, less than or equal to 25%, less than or equal to 20%, less than or equal to 15%, or less than or equal to 12%. In some instances, an additional layer of the second type has a solidity of greater than or equal to 10%, greater than or equal to 15%, greater than or equal to 20%, greater than or equal to 25%, greater than or equal to 30%, greater than or equal to 35%, greater than or equal to 40%, greater than or equal to 45%, greater than or equal to 50%, greater than or equal to 55%, greater than or equal to 60%, greater than or equal to 65%, greater than or equal to 70%, greater than or equal to 75%, greater than or equal to 80%, greater than or equal to 85%, or greater than or equal to 90%. Combinations of the above-reference ranges are possible (e.g., greater than or equal to 10% and less than or equal to 95%, greater than or equal to 10% and less than or equal to 50%, or greater than or equal to 10% and less than or equal to 30%). Other ranges are also possible.

The solidity of an additional layer of the second type may be determined by the same technique described above with respect to the non-woven fiber webs of the first type. When a filter media comprises two or more additional layers of the second type, each additional layer of the second type may independently have a solidity in one or more of the above-referenced ranges.

In some embodiments, the porosity of an additional layer of the second type is greater than or equal to 5%, greater than or equal to 10%, greater than or equal to 15%, greater than or equal to 20%, greater than or equal to 25%, greater than or equal to 30%, greater than or equal to 35%, greater than or equal to 40%, greater than or equal to 45%, greater than or equal to 50%, greater than or equal to 55%, greater than or equal to 60%, greater than or equal to 65%, greater than or equal to 70%, greater than or equal to 75%, greater than or equal to 80%, or greater than or equal to 85%. In some instances, the porosity of an additional layer of the second type is less than or equal to 90%, less than or equal to 85%, less than or equal to 80%, less than or equal to 75%, less than or equal to 70%, less than or equal to 65%, less than or equal to 60%, less than or equal to 55%, less than or equal to 50%, less than or equal to 45%, less than or equal to 40%, less than or equal to 35%, less than or equal to 30%, less than or equal to 25%, less than or equal to 20%, less than or equal to 15%, or less than or equal to 10%. Combinations of the above-reference ranges are also possible (e.g., greater than or equal to 5% and less than or equal to 90%, greater than or equal to 70% and less than or equal to 90%). Other ranges are also possible.

In some embodiments, a filter media comprises an additional layer of the second type that is a meltblown layer and has a porosity of greater than or equal to 5% and less than or equal to 90%. In some embodiments, a filter media comprises an additional layer of the second type that is an electrospun layer and has a porosity of greater than or equal to 70% and less than or equal to 90%.

When a filter media comprises two or more additional layers of the second type, each additional layer of the second type may independently have a porosity in one or more of the above-referenced ranges.

In some embodiments, an additional layer of the second type has an average fiber diameter of less than or equal to 20 microns, less than or equal to 18 microns, less than or equal to 15 microns, less than or equal to 12 microns, less than or equal to 10 microns, less than or equal to 8 microns, less than or equal to 5 microns, less than or equal to 3 microns, less than or equal to 1 micron, or less than or equal to 0.8 microns. In some instances, the average fiber diameter of an additional layer of the second type is greater than or equal to 0.5 microns, greater than or equal to 0.8 microns, greater than or equal to 1 micron, greater than or equal to 3 microns, greater than or equal to 5 micron, greater than or equal to 8 microns, greater than or equal to 10 microns, greater than or equal to 12 microns, greater than or equal to 15 microns, or greater than or equal to 18 microns. Combinations of the above-referenced ranges are also possible (e.g., greater than or equal to 0.5 microns and less than or equal to 20 microns, greater than or equal to 0.5 microns and less than or equal to 10 microns). Other ranges are also possible.

When a filter media comprises two or more additional layers of the second type, each additional layer of the second type may independently have an average fiber diameter in one or more of the above-referenced ranges.

As described in more detail below, an additional layer of the second type may comprise synthetic fibers, amongst other fiber types. In some instances, an additional layer of the second type comprises a relatively high weight percentage of synthetic fibers (e.g., greater than or equal to 95 wt %, identically 100 wt %).

An additional layer of the second type may have a basis weight that makes up a variety of suitable amounts of the total weight of the filter media. For instance, in some embodiments, the basis weight of an additional layer of the second type is greater than or equal to 30%, greater than or equal to 32%, greater than or equal to 35%, greater than or equal to 38%, greater than or equal to 40%, greater than or equal to 42%, greater than or equal to 45%, greater than or equal to 48%, greater than or equal to 50%, greater than or equal to 52%, or greater than or equal to 55% of the basis weight of the filter media (e.g., combined basis weight of the additional layer of the second type and any further layers also present) and/or of an additional layer of the first type also present in the filter media. In some embodiments, the basis weight of an additional layer of the second type is less than or equal to 60%, less than or equal to 58%, less than or equal to 55%, less than or equal to 52%, less than or equal to 50%, less than or equal to 48%, less than or equal to 45%, less than or equal to 42%, less than or equal to 40%, less than or equal to 38%, or less than or equal to 35% of the basis weight of the filter media (e.g., combined basis weight of the additional layer of the second type and any further layers also present) and/or of an additional layer of the first type also present in the filter media. Combinations of the above-referenced ranges are also possible (e.g., greater than or equal to 30% and less than or equal to 60%). Other ranges are also possible.

In some embodiments, an additional layer of the second type has a basis weight of less than or equal to 70 gsm, less than or equal to 65 gsm, less than or equal to 60 gsm, less than or equal to 55 gsm, less than or equal to 50 gsm, less than or equal to 45 gsm, less than or equal to 40 gsm, less than or equal to 35 gsm, less than or equal to 30 gsm, less than or equal to 25 gsm, less than or equal to 20 gsm, less than or equal to 15 gsm, less than or equal to 10 gsm, or less than or equal to 8 gsm. In some instances, an additional layer of the second type has a basis weight of greater than or equal to 5 gsm, greater than or equal to 10 gsm, greater than or equal to 15 gsm, greater than or equal to 20 gsm, greater than or equal to 25 gsm, greater than or equal to 30 gsm, greater than or equal to 45 gsm, greater than or equal to 50 gsm, greater than or equal to 55 gsm, greater than or equal to 60 gsm, or greater than or equal to 65 gsm. Combinations of the above-referenced ranges are also possible (e.g., greater than or equal to 5 gsm and less than or equal to 70 gsm, or greater than or equal to 10 gsm and less than or equal to 40 gsm). Other ranges are also possible.

The basis weight may be determined according to the standard ISO 536:2012.

When a filter media comprises two or more additional layers of the second type, each additional layer of the second type may independently have a basis weight in one or more of the above-referenced ranges.

In some embodiments, an additional layer of the second type has a thickness of less than or equal to 25 mil, less than or equal to 22 mil, less than or equal to 20 mil, less than or equal to 18 mil, less than or equal to 15 mil, less than or equal to 12 mil, less than or equal to 10 mil, less than or equal to 8 mil, less than or equal to 5 mil, or less than or equal to 3 mil. In some instances, an additional layer of the second type has a thickness of greater than or equal to 1 mil, greater than or equal to 3 mil, greater than or equal to 5 mil, greater than or equal to 8 mil, greater than or equal to 10 mil, greater than or equal to 12 mil, greater than or equal to 15 mil, greater than or equal to 18 mil, or greater than or equal to 20 mil. Combinations of the above-referenced ranges are also possible (e.g., greater than or equal to 1 mil and less than or equal to 25 mil, or greater than or equal to 3 mil and less than or equal to 15 mil). Other ranges are also possible.

The thickness of an additional layer of the second type may be determined according to the standard ASTM D1777 (2015) under an applied pressure of 0.8 kPa.

When a filter media comprises two or more additional layers of the second type, each additional layer of the second type may independently have a thickness in one or more of the above-referenced ranges.

In some embodiments, the average fiber diameter of an additional layer of the second type may be substantially the same as or greater than the average fiber diameter of an average fiber diameter of an additional layer of the first type also positioned in the same filter media. For instance, in some embodiments, the ratio of the average diameter of the fibers in an additional layer of the second type to the average diameter of fibers in an additional layer of the first type is greater than or equal to 1, greater than or equal to 5, greater than or equal to 10, greater than or equal to 15, greater than or equal to 20, greater than or equal to 25, greater than or equal to 30, greater than or equal to 35, greater than or equal to 40, greater than or equal to 45, greater than or equal to 50, greater than or equal to 55, greater than or equal to 60, greater than or equal to 65, greater than or equal to 70, greater than or equal to 75, greater than or equal to 80, greater than or equal to 85, or greater than or equal to 90. In some instances, the ratio of the average diameter of the fibers in an additional layer of the second type to the average diameter of fibers in an additional layer of the first type is less than or equal to 100, less than or equal to 95, less than or equal to 90, less than or equal to 85, less than or equal to 80, less than or equal to 75, less than or equal to 70, less than or equal to 65, less than or equal to 60, less than or equal to 55, less than or equal to 50, less than or equal to 45, less than or equal to 40, less than or equal to 35, less than or equal to 30, less than or equal to 25, less than or equal to 20, less than or equal to 15, less than or equal to 10, or less than or equal to 5. Combinations of the above-referenced ranges are also possible (e.g., greater than or equal to 1 and less than or equal to 100, greater than or equal to 1 and less than or equal to 70). Other ranges are also possible.

In some embodiments, a filter media described herein meets one or more particulate efficiency standards (e.g., ASTM F838-05) while also having desirable structural (e.g., peel strength) and/or performance properties (e.g., water permeability, dust holding capacity). For instance, a filter media may comprise an additional layer of the first type and an additional layer of the second type that are relatively similar to each other and the similarities may impart beneficial properties to the filter media. For instance, in some embodiments, a filter media comprises an additional layer of the first type that has a similar value of water contact angle, critical surface tension, and/or critical wetting surface tension to the value of that parameter for an additional layer of the second type also positioned in the filter media. It is believed that filter media comprising such pairs of layers may exhibit increased adherence between the additional layers of the first and second types before and/or after a bonding process (e.g., a calendering process).

In some instances, a filter media comprises an additional layer of the second type that is strongly adhered to an additional layer of the first type. For instance, a filter media may comprise such layers, and the peel strength therebetween may be greater than or equal to 0.01 lb/in, greater than or equal to 0.05 lb/in, greater than or equal to 1 lb/in, greater than or equal to 1.5 lb/in, greater than or equal to 2 lb/in, greater than or equal to 2.5 lb/in, greater than or equal to 3 lb/in, greater than or equal to 3.5 lb/in, greater than or equal to 4 lb/in, greater than or equal to 4.5 lb/in, greater than or equal to 5 lb/in, greater than or equal to 5.5 lb/in, greater than or equal to 6 lb/in, greater than or equal to 6.5 lb/in, greater than or equal to 7 lb/in, greater than or equal to 7.5 lb/in, greater than or equal to 8 lb/in, greater than or equal to 8.5 lb/in, or greater than or equal to 9 lb/in. In some instances, a filter media may comprise such layers, and the peel strength therebetween is less than or equal to 10 lb/in, less than or equal to 9.5 lb/in, less than or equal to 9 lb/in, less than or equal to 8.5 lb/in, less than or equal to 8 lb/in, less than or equal to 7.5 lb/in, less than or equal to 7 lb/in, less than or equal to 6.5 lb/in, less than or equal to 6 lb/in, less than or equal to 5.5 lb/in, less than or equal to 5 lb/in, less than or equal to 4.5 lb/in, less than or equal to 4 lb/in, less than or equal to 3.5 lb/in, less than or equal to 3 lb/in, less than or equal to 2.5 lb/in, less than or equal to 2 lb/in, less than or equal to 1.5 lb/in, less than or equal to 1 lb/in, or less than or equal to 0.5 lb/in. Combinations of the above-referenced ranges are also possible (e.g., greater than or equal to 0.01 lb/in and less than or equal to 10 lb/in, greater than or equal to 0.01 lb/in and less than or equal to 5 lb/in, or greater than or equal to 0.01 lb/in and less than or equal to 1 lb/in). Other ranges are also possible.

Peel strength between an additional layer of the first type and an additional layer of the second type may be determined with a Thwing-Albert mechanical tester, model QC-1000 by conducting a 180° peel test as per ASTM D3330 (2004). A crosshead speed of 2 inches per minute may be used to separate the additional layers from each other.

In some embodiments, the fibers in an additional layer (e.g., an additional layer of the first type, an additional layer of the second type) comprise synthetic fibers. Synthetic fibers suitable for inclusion in the additional layers of the first and second type described herein may include any suitable type of synthetic polymer. Non-limiting examples of suitable synthetic polymers include poly(imide), aliphatic poly(amide) (e.g., nylon 6), aromatic poly(amide), poly(sulfone), cellulose acetate, poly(ether sulfone), poly(aryl ether sulfone), modified poly(sulfone) polymers, modified poly(ether sulfone) polymers, poly(methyl methacrylate), poly(acrylonitrile), poly(urethane), poly(urea urethane), poly(benzimidazole), poly(etherimide), poly(acrylonitrile), poly(ethylene terephthalate), poly(propylene), silicones, regenerated cellulose (e.g., Lyocell, rayon)), poly(aniline), poly(ethylene oxide), poly(ethylene naphthalate), poly(butylene terephthalate), styrene butadiene rubber, poly(styrene), poly(vinyl chloride), poly(vinyl alcohol), poly(vinylidene fluoride), poly(vinyl butylene) and copolymers or derivative compounds thereof, and combinations thereof. In some embodiments, an additional layer of the first type and/or an additional layer of the second type comprises synthetic fibers that are organic polymer fibers. Additionally, and as described elsewhere herein, synthetic fibers present in a layer may include both monocomponent synthetic fibers and multicomponent synthetic fibers.

To provide further specific examples, in some embodiments (e.g., when an additional layer of the first type is an electrospun layer) an additional layer of the first type comprises fibers that comprise poly(ether sulfone), polyamide (e.g. nylon 6, nylon 66), a fluorinated polymer e.g., (poly(vinylidene fluoride)), and/or another polymer suitable for electrospinning.

In some embodiments, the fibers in an additional layer (e.g., an additional layer of the first type, an additional layer of the second type) comprises synthetic fibers that are continuous fibers. Such continuous fibers may be formed, for instance, by electrospinning (e.g., solvent electro spinning, melt electro spinning), meltblowing, meltspinning, and/or centrifugal spinning. It is also possible for an additional layer to comprise synthetic fibers that are non-continuous.

In some embodiments, an additional layer of the first type and/or an additional layer of the second type comprises continuous fibers that have relatively long lengths. For instance, an additional layer may comprise synthetic fibers that have an average length of at least 5 cm, at least 10 cm, at least 15 cm, at least 20 cm, at least 50 cm, at least 100 cm, at least 200 cm, at least 500 cm, at least 700 cm, at least 1000 cm, at least 1500 cm, at least 2000 cm, at least 2500 cm, at least 5000 cm, at least 10000 cm; and/or less than or equal to 10000 cm, less than or equal to 5000 cm, less than or equal to 2500 cm, less than or equal to 2000 cm, less than or equal to 1000 cm, less than or equal to 500 cm, or less than or equal to 200 cm. Combinations of the above-referenced ranges are also possible (e.g., greater than or equal to 100 cm and less than or equal to 2500 cm). Other ranges are also possible.

When an additional layer comprises two or more types of continuous fibers, each type of continuous fiber may independently have an average length in one or more of the ranges described above and/or all of the continuous fibers in an additional layer may together have an average length in one or more of the ranges described above. Similarly, when a filter media comprises two or more additional layers, each additional layer may independently comprise one or more types of continuous fibers having an average length in one or more of the ranges described above and/or may comprise continuous fibers that overall have an average length in one or more of the ranges described above.

In other embodiments, an additional layer of the first type and/or an additional layer of the second type comprises synthetic fibers that are not continuous (e.g., staple fibers). In general, synthetic non-continuous fibers may be characterized as being shorter than continuous synthetic fibers. For instance, in some embodiments, synthetic fibers in an additional layer have an average length of at least 0.1 mm, at least 0.5 mm, at least 1.0 mm, at least 1.5 mm, at least 2.0 mm, at least 3.0 mm, at least 4.0 mm, at least 5.0 mm, at least 6.0 mm, at least 7.0 mm, at least 8.0 mm, at least 9.0 mm, at least 10.0 mm, at least 12.0 mm, at least 15.0 mm; and/or less than or equal to 15.0 mm, less than or equal to 12.0 mm, less than or equal to 10.0 mm, less than or equal to 5.0 mm, less than or equal to 4.0 mm, less than or equal to 1.0 mm, less than or equal to 0.5 mm, or less than or equal to 0.1 mm. Combinations of the above-referenced ranges are also possible (e.g., at least 1.0 mm and less than or equal to 4.0 mm). Other ranges are also possible.

When an additional layer comprises two or more types of non-continuous fibers, each type of non-continuous fiber may independently have an average length in one or more of the ranges described above and/or all of the non-continuous fibers in an additional layer may together have an average length in one or more of the ranges described above. Similarly, when a filter media comprises two or more additional layers, each additional layer may independently comprise one or more types of non-continuous fibers having an average length in one or more of the ranges described above and/or may comprise non-continuous fibers that overall have an average length in one or more of the ranges described above.

In some embodiments in which synthetic fibers are included in an additional layer (e.g., an additional layer of the first type, an additional layer of the second type), the amount therein is greater than or equal to 1 wt %, greater than or equal to 20 wt %, greater than or equal to 40 wt %, greater than or equal to 60 wt %, greater than or equal to 75 wt %, greater than or equal to 90 wt %, or greater than or equal to 95 wt %. In some instances, the amount of synthetic fibers in an additional layer is less than or equal to 100 wt %, less than or equal to 98 wt %, less than or equal to 85 wt %, less than or equal to 75 wt %, less than or equal to 50 wt %, or less than or equal to 10%. Combinations of the above-referenced ranges are also possible (e.g., greater than or equal to 1 wt % and less than or equal to 100 wt %, greater than or equal to 75 wt % and less than or equal to 100 wt %). Other ranges are also possible. In some embodiments, synthetic fibers make up identically 100 wt % of an additional layer.

When an additional layer comprises two or more types of synthetic fibers, each type of synthetic fiber may independently make up an amount of the additional layer in one or more of the ranges described above and/or all of the synthetic fibers in an additional layer may together make up an amount of the additional layer in one or more of the ranges described above. Similarly, when a filter media comprises two or more additional layers, each additional layer may independently comprise one or more types of synthetic fibers in an amount in one or more of the ranges described above and/or may comprise a total amount of synthetic fibers that is in one or more of the ranges described above.

In one set of embodiments, an additional layer of the first type and/or an additional layer of the second type comprises multicomponent fibers. These multicomponent fibers may have one or more of the characteristics described elsewhere herein with respect to multicomponent fibers that may be included in non-woven fiber webs of the first type.

In some embodiments, an additional layer of the first type and/or an additional layer of the second type comprises multicomponent fibers that have an average length of at least 0.1 mm, at least 0.5 mm, at least 1.0 mm, at least 1.5 mm, at least 2.0 mm, at least 3.0 mm, at least 4.0 mm, at least 5.0 mm, at least 6.0 mm, at least 7.0 mm, at least 8.0 mm, at least 9.0 mm, at least 10.0 mm, at least 12.0 mm, at least 15.0 mm; and/or less than or equal to 15.0 mm, less than or equal to 12.0 mm, less than or equal to 10.0 mm, less than or equal to 5.0 mm, less than or equal to 4.0 mm, less than or equal to 1.0 mm, less than or equal to 0.5 mm, or less than or equal to 0.1 mm. Combinations of the above-referenced ranges are also possible (e.g., at least 1.0 mm and less than or equal to 4.0 mm). Other ranges are also possible.

When an additional layer comprises two or more types of multicomponent fibers, each type of multicomponent fiber may independently have an average length in one or more of the ranges described above and/or all of the multicomponent fibers in an additional layer may together have an average length in one or more of the ranges described above. Similarly, when a filter media comprises two or more additional layers, each additional layer may independently comprise one or more types of multicomponent fibers having an average length in one or more of the ranges described above and/or may comprise multicomponent fibers that overall have an average length in one or more of the ranges described above.

In embodiments in which multicomponent fibers are included in an additional layer (e.g., an additional layer of the first type, an additional layer of the second type), the amount of multicomponent fibers therein may be, for example, greater than or equal to 1 wt %, greater than or equal to 5 wt %, greater than or equal to 10 wt %, greater than or equal to 15 wt %, greater than or equal to 30 wt %, or greater than or equal to 45%. In some instances, the amount of multicomponent fibers in an additional layer is less than or equal to 70 wt %, less than or equal to 50 wt %, less than or equal to 25 wt %, less than or equal to 10 wt %, less than or equal to 5 wt %, or less than or equal to 1 wt %. Combinations of the above-referenced ranges are also possible (e.g., greater than or equal to 1 wt % and less than or equal to 70 wt %, or greater than or equal to 30 wt % and less than or equal to 70 wt %). Other ranges are also possible. In other embodiments, an additional layer of the first type and/or an additional layer of the second type include identically 0 wt % multicomponent fibers.

In some embodiments, an additional layer of the first type comprises a PES material. In some embodiments, the PES material comprises a multiblock polymer or a co-block polymer comprising a poly(ether sulfone) block. It is also possible for the PES material to comprise poly(ether sulfone). In some embodiments, an additional layer of the first type comprises a plurality of fine fibers and that the fine fibers comprise a PES material. Such a layer may comprise other types of fibers in addition to the fine fibers comprising the PES material. In some embodiments, some (e.g., at least 20%, at least 40%, at least 60%, or at least 80%) or all of the fibers in an additional layer of the first type comprising a PES material are produced by electro spinning, force spinning, and/or meltblown spinning.

The PES materials described herein may have any suitable intrinsic viscosity. As noted above, in some embodiments, a PES material has a relatively high intrinsic viscosity. For example, in some embodiments, a PES material has an intrinsic viscosity of greater than or equal to 0.3 dL/g, greater than or equal to 0.35 dL/g, greater than or equal to 0.4 dL/g, greater than or equal to 0.45 dL/g, greater than or equal to 0.5 dL/g, greater than or equal to 0.6 dL/g, greater than or equal to 0.7 dL/g, greater than or equal to 0.8 dL/g, greater than or equal to 0.9 dL/g, greater than or equal to 1 dL/g, greater than or equal to 1.1 dL/g, greater than or equal to 1.2 dL/g, greater than or equal to 1.3 dL/g, greater than or equal to 1.4 dL/g, greater than or equal to 1.5 dL/g, greater than or equal to 1.6 dL/g, greater than or equal to 1.7 dL/g, greater than or equal to 1.8 dL/g, or greater than or equal to 1.9 dL/g. In some embodiments, a PES material has an intrinsic viscosity of less than or equal to 2 dL/g, less than or equal to 1.9 dL/g, less than or equal to 1.8 dL/g, less than or equal to 1.7 dL/g, less than or equal to 1.6 dL/g, less than or equal to 1.5 dL/g, less than or equal to 1.4 dL/g, less than or equal to 1.3 dL/g, less than or equal to 1.2 dL/g, less than or equal to 1.1 dL/g, less than or equal to 1 dL/g, less than or equal to 0.9 dL/g, less than or equal to 0.8 dL/g, or less than or equal to 0.7 dL/g. Combinations of these ranges are also possible (e.g., greater than or equal to 0.3 dL/g and less than or equal to 2 dL/g, greater than or equal to 0.4 dL/g and less than or equal to 2 dL/g, or greater than or equal to 0.5 dL/g and less than or equal to 1 dL/g).

Intrinsic viscosity may be determined using any suitable viscometer, such as a small sample adaptor Brookfield viscometer. One suitable technique for measuring intrinsic viscosity involves first preparing multiple samples (e.g., 4 or more 100 g solutions) of the PES material at various concentrations (e.g., at various concentrations within the range of 20-28 wt % PES material) in dimethylacetamide. The viscosity of each of these samples (ηₛₒₗᵤₜᵢₒₙ) may be obtained from the viscometer. When using the viscometer, the rotation speed at which the viscometer is operated may be selected by starting at 12 rpm and gradually increasing the speed until a torque value between 10% and 90% is obtained. This rotation speed typically falls within the range of 12 rpm to 20 rpm. The viscosity of each sample may be plotted in a chart where the x-axis is the concentration of PES material in the sample (in g PES/dL solvent) and the y-axis is the specific viscosity of the sample (in dL/g). The exponential equation that best fits the viscosities may be determined, and the y-intercept of that exponential equation may be taken to be the intrinsic viscosity of the PES material. The y-intercept may be obtained by evaluating the following equations:

$${η}_{s p} = \frac{{η}_{solution} - {η}_{solvent}}{{η}_{solvent}} \\ {η}_{i n t r i n s i c} = {lim}_{∅ \to 0} \frac{{η}_{solution} - {η}_{solvent}}{{η}_{solvent} * ∅} = {lim}_{∅ \to 0} \frac{{η}_{s p}}{∅} = \frac{c P ( m P a s ) - c P ( m P a s )}{c P ( m P a s ) * \frac{g}{dL}} = The y \text{-} intercept ( dL / g )$$

where ηₛₒₗᵥₑₙₜ is the viscosity of the solvent and may be obtained from databases, ηₛₚ is the specific viscosity of each sample, and 0 is the weight of PES material divided by the weight of the solution.

The intrinsic viscosity of the PES material may be determined by plotting any suitable number of data points from different concentrations of the PES material. In some embodiments, the intrinsic viscosity of the PES material is determined by plotting greater than or equal to 4 data points, greater than or equal to 5 data points, greater than or equal to 6 data points, greater than or equal to 7 data points, greater than or equal to 8 data points, or greater than or equal to 9 data points. In some embodiments, the intrinsic viscosity of the PES material is determined by plotting less than or equal to 15 data points, less than or equal to 12 data points, less than or equal to 10 data points, less than or equal to 8 data points s, less than or equal to 6 data points, or less than or equal to 5 data points. Combinations of these ranges are also possible (e.g., greater than or equal to 4 data points and less than or equal to 15 data points, or greater than or equal to 4 data points and less than or equal to 6 data points).

The exponential equation for determining intrinsic viscosity of a PES material may have any suitable R² value. In some embodiments, the exponential equation has an R² value of greater than or equal to 0.90, greater than or equal to 0.92, greater than or equal to 0.95, greater than or equal to 0.96, greater than or equal to 0.97, greater than or equal to 0.98, greater than or equal to 0.99, or greater than or equal to 0.999. In some embodiments, the exponential equation for determining intrinsic viscosity of a PES material has an R² value of less than or equal to 1, less than or equal to 0.999, less than or equal to 0.99, less than or equal to 0.98, less than or equal to 0.97, less than or equal to 0.96, or less than or equal to 0.95. Combinations of these ranges are also possible (e.g., greater than or equal to 0.90 and less than or equal to 1, greater than or equal to 0.95 and less than or equal to 1, or greater than or equal to 0.99 and less than or equal to 1).

When a filter media comprises two or more additional layers of the first type, each additional layer of the first type may independently comprise a PES material having an intrinsic viscosity in one or more of the above-referenced ranges, from a number of data points in one or more of the above-referenced ranges, and/or by use of an exponential equation having an R² value in one or more of the above-referenced ranges.

In some embodiments, PES materials having higher intrinsic viscosities (such as the intrinsic viscosities described herein) exhibit one or more desirable properties. For example, in some embodiments, a layer comprising fibers comprising such a PES material may have a lower number of macro defects than a layer comprising fibers comprising a PES material with a lower intrinsic viscosity (all other factors being equal). Without wishing to be bound by theory, it is believed that PES materials that have lower intrinsic viscosity have short polymer chains, which may contribute to defect formation, as it is believed that short polymer chains can relax more quickly than long polymer chains. It is also believed that short polymer chains may exhibit an enhanced tendency to form spherical droplets, to deposit on the nanoweb as shot, and/or to form holes.

The PES materials described herein may have any suitable molecular weight. In some embodiments, a PES material has a molecular weight of greater than or equal to 21,000 g/mol, greater than or equal to 23,000 g/mol, greater than or equal to 25,000 g/mol, greater than or equal to 27,000 g/mol, greater than or equal to 29,000 g/mol, greater than or equal to 31,000 g/mol, greater than or equal to 33,000 g/mol, greater than or equal to 35,000 g/mol, greater than or equal to 37,000 g/mol, greater than or equal to 39,000 g/mol, greater than or equal to 41,000 g/mol, greater than or equal to 43,000 g/mol, greater than or equal to 50,000 g/mol, greater than or equal to 60,000 g/mol, greater than or equal to 70,000 g/mol, greater than or equal to 80,000 g/mol, or greater than or equal to 90,000 g/mol. In some embodiments, a PES material has a molecular weight of less than or equal to 100,000 g/mol, less than or equal to 90,000 g/mol, less than or equal to 80,000 g/mol, less than or equal to 70,000 g/mol, less than or equal to 60,000 g/mol, less than or equal to 50,000 g/mol, less than or equal to 43,000 g/mol, less than or equal to 41,000 g/mol, less than or equal to 39,000 g/mol, less than or equal to 37,000 g/mol, less than or equal to 35,000 g/mol, less than or equal to 33,000 g/mol, less than or equal to 31,000 g/mol, less than or equal to 29,000 g/mol, less than or equal to 27,000 g/mol, less than or equal to 25,000 g/mol, or less than or equal to 23,000 g/mol. Combinations of the above-referenced ranges are also possible (e.g., greater than or equal to 21,000 g/mol and less than or equal to 100,000 g/mol, greater than or equal to 27,000 g/mol and less than or equal to 43,000 g/mol, or greater than or equal to 31,000 g/mol and less than or equal to 39,000 g/mol).

The molecular weight of a PES material may be measured using gel permeation chromatography according to ASTM D5296 (2019).

When a filter media comprises two or more additional layers of the first type, each additional layer of the first type may independently comprise a PES material having a molecular weight in one or more of the above-referenced ranges.

The PES materials described herein may have any suitable glass transition temperature. In some embodiments, a PES material has a glass transition temperature of greater than or equal to 185° C., greater than or equal to 190° C., greater than or equal to 195° C., greater than or equal to 200° C., greater than or equal to 205° C., greater than or equal to 210° C., greater than or equal to 215° C., greater than or equal to 220° C., greater than or equal to 225° C., greater than or equal to 230° C., greater than or equal to 235° C., greater than or equal to 240° C., greater than or equal to 245° C., or greater than or equal to 250° C. In some embodiments, the PES material has a glass transition temperature of less than or equal to 255° C., less than or equal to 250° C., less than or equal to 245° C., less than or equal to 240° C., less than or equal to 235° C., less than or equal to 230° C., less than or equal to 225° C., less than or equal to 220° C., less than or equal to 215° C., less than or equal to 210° C., less than or equal to 205° C., less than or equal to 200° C., less than or equal to 195° C., or less than or equal to 190° C. Combinations of these ranges are also possible (e.g., greater than or equal to 185° C. and less than or equal to 255° C., greater than or equal to 200° C. and less than or equal to 240° C., or greater than or equal to 215° C. and less than or equal to 225° C.).

The glass transition temperature of a PES material may be measured using differential scanning calorimetry. The PES material may be heated from 20° C. to 400° C. at a rate of 5° C./minute.

When a filter media comprises two or more additional layers of the first type, each additional layer of the first type may independently comprise a PES material having a glass transition temperature in one or more of the above-referenced ranges.

In some embodiments, an additional layer of the first type further comprises one or more additives added during manufacture of the fibers therein. Non-limiting examples of suitable additives include cationic surfactants, anionic surfactants, non-ionic surfactants, ammonium salts (e.g., tetra ethylene ammonium bromide (TEAB)), sulfonium salts, organic salts, inorganic salts, esters, ethers, and/or polymers (e.g., polymers derived from monomers such as 1-vinylpyrrolid-2-one, N-alkyl-methacrylamide, vinyl acetate, 1-vinylimidazole, 1-vinyl[alkyl]imidazole, 1-vinyl-2-pyridine, 1-vinyl-4-pyridine, acrylamide, N-vinylformamide, and/or N-[alkyl]formamide). In some embodiments, a PES material present in fibers in an additional layer of the first type comprises one or more such additives (e.g., TEAB).

In embodiments where an additional layer of the first type comprises an additive, the additional layer of the first type may include any suitable amount of the additive (e.g., TEAB). In some embodiments, one or more additives make up greater than or equal to 0.05 wt %, greater than or equal to 0.1 wt %, greater than or equal to 0.15 wt %, greater than or equal to 0.2 wt %, greater than or equal to 0.25 wt %, greater than or equal to 0.3 wt %, greater than or equal to 0.35 wt %, greater than or equal to 0.4 wt %, or greater than or equal to 0.45 wt % of additional layer of the first type. In some embodiments, additives make up less than or equal to 5 wt %, less than or equal to 4.5 wt %, less than or equal to 4 wt %, less than or equal to 3.5 wt %, less than or equal to 3 wt %, less than or equal to 2.5 wt %, less than or equal to 2 wt %, less than or equal to 1.5 wt %, less than or equal to 1 wt %, or less than or equal to 0.5 wt % of additional layer of the first type. Combinations of these ranges are also possible (e.g., greater than or equal to 0.05 wt % and less than or equal to 5 wt %).

When a filter media comprises two or more additional layers of the first type, each additional layer of the first type may independently comprise an amount of any particular additive in one or more of the above-referenced ranges. Additionally, each additional layer may independently comprise a total additive content in one or more of the above-referenced ranges.

In some embodiments, an additional layer of the first type comprises an anti-static PES material. In some embodiments, the anti-static PES material comprises an additive (e.g., any additive described herein, a charged additive, or a catalyst). An additional layer of the first type comprising an anti-static PES material exhibits reduced static charge (e.g., at least 10%, at least 25%, or at least 50% reduced; less than or equal to 100% or less than or equal to 50% reduced; combinations of these ranges are also possible) compared to an additional layer of the first type without, or with lower amounts (e.g., at least 10 wt. %, at least 25 wt. %, or at least 50 wt. % lower; less than or equal to 100 wt. % or less than or equal to 50 wt. % lower; combinations are also possible) of the anti-static PES material (all other factors being equal). In some embodiments, the amount of static charge may be determined visually by shredding paper, placing samples of the same size over the same amount of shredded paper, and visually determining how much paper clings to each sample. In some embodiments, static charge may attract dust during formation, which may lead to reduced filtration performance and/or shorter filter media life. Without wishing to be bound by any particular theory, it is believed that anti-static PES materials exhibit reduced static due to use of charged additives and/or catalysts present therein.

In some embodiments, a filter media comprises additional layers of the first and second type whose compositions are selected such that these additional layers have a similar water contact angle, critical surface tension, and/or critical wetting surface tension. Non-limiting examples of fiber compositions for the additional layers of the first and second type (expressed as additional layer of the first type composition/additional layer of the second type composition) include nylon 6/nylon 6, nylon 6/poly(butylene terephthalate), poly(ether sulfone)/poly(butylene terephthalate), poly(ether sulfone)/poly(ethylene terephthalate), poly(vinylidene fluoride)/fluorinated polymer, regenerated cellulose (e.g., rayon, Lyocell)/regenerated cellulose, and poly(propylene)/poly(propylene).

In some embodiments, an additional layer of the first type and/or an additional layer of the second type also includes one or more further components in addition to the fibers. Non-limiting examples of such components include resin, a material present in a surface treatment, and additives. Typically, any further components are present in limited amounts.

When present, any suitable resin may be employed. For example, the resin may be polymeric, water-based, solvent-based, dry strength, and/or wet strength. In some embodiments, at least a portion of the fibers present in an additional layer of the first type and/or an additional layer of the second type is coated with a resin without substantially blocking the pores thereof.

In some embodiments, an additional layer of the first type and/or an additional layer of the second type comprises a resin that is a binder resin. The binder resin may lack fibers and/or may be in a form other than fibers. When present, the binder resin may have any suitable composition. For example, the binder resin may comprise a thermoplastic polymer (e.g., an acrylic, poly(vinylacetate), poly(ester), poly(amide)), a thermoset polymer (e.g., an epoxy, a phenolic resin), or a combination thereof. In some cases, a binder resin includes one or more of a vinyl acetate resin, an epoxy resin, a poly(ester) resin, a copoly(ester) resin, a poly(vinyl alcohol) resin, an acrylic resin (e.g., a styrene acrylic resin), and a phenolic resin. Other resins are also possible.

As described further below, the resin may be added to fibers from which an additional layer of the first type and/or an additional layer of the second type is to be formed. As one example, in some embodiments, a resin is added to such fibers in the wet state. In some embodiments, a resin coats the fibers and is used to adhere fibers to each other to facilitate adhesion between the fibers. Any suitable method and equipment may be used to coat the fibers, for example, using curtain coating, gravure coating, melt coating, dip coating, knife roll coating, and/or spin coating, amongst others. In some embodiments, the binder is precipitated when added to the fibers. When appropriate, any suitable precipitating agent (e.g., epichlorohydrin, a fluorocarbon) may be provided to the fibers, for example, by injection into the blend. In some embodiments, a resin is added to fibers and/or to an additional layer in a manner such that one or more additional layers is impregnated with the resin (e.g., in a manner such that the resin permeates throughout). In a filter media and/or intermediate component thereof comprising two or more layers (e.g., a non-woven fiber web of the first type and an additional layer, two additional layers), a resin may be added to some or all of the layers separately. Then, the layers may be combined. It is also possible for a resin to be added to two or more layers in a filter media and/or an intermediate component thereof in a single step. In some embodiments, a resin is added to fibers while in a dry state, for example, by spraying or saturation impregnation, or any of the above methods. In other embodiments, a resin is added to a wet non-woven fiber web (e.g., a wet non-woven fiber web of the first type, an additional layer of the first type, an additional layer of the second type).

An additional layer described herein (e.g., an additional layer of the first type, an additional layer of the second type) may be produced using suitable processes, such as using a non-wet laid process or a wet laid process. In some embodiments, an additional layer is produced using a non-wet laid process, such as a blowing and/or a spinning process. In some embodiments, an additional layer is formed by an electrospinning process. In some embodiments, electrospinning utilizes a high voltage differential to generate a fine jet of polymer solution from bulk polymer solution. The jet may form as the polymer is charged by the voltage differential and electrostatic repulsion forces overcome the surface tension of the solution. The jet may be drawn into a fine fiber under the effect of repulsive electrical forces applied to the solution. The jet may dry in flight and/or may be collected on a grounded collector. The rapid solvent evaporation during this process may lead to the formation of polymeric nanofibers that are randomly arranged into a non-woven fiber web. In some embodiments, electrospun fibers are made using non-melt fiberization processes. Electrospun fibers can be made with any suitable polymers including but not limiting to, organic polymers as described elsewhere herein. In some embodiments, an additional layer comprises synthetic fibers formed by an electrospinning process.

In some embodiments, an additional layer is formed by a meltblowing system, such as the meltblown system described in U.S. Publication No. 2009/0120048, filed Nov. 7, 2008, and entitled “Meltblown Filter Medium”, and U.S. Publication No. 2012/0152824, filed Dec. 17, 2010, and entitled, “Fine Fiber Filter Media and Processes”, each of which is incorporated herein by reference in its entirety for all purposes. In certain embodiments, an additional layer is formed by a meltspinning or a centrifugal spinning process.

In some embodiments, a non-wet laid process, such as an air laid or carding process, may be used to form one or more additional layers. For example, in an air laid process, synthetic fibers may be mixed, while air is blown onto a conveyor. Suitable carding processes may include processes similar to or different from the carding processes described elsewhere herein as being suitable for forming a non-woven fiber web of the first type. In some cases, forming the fiber webs through a non-wet laid process may be more suitable for the production of a highly porous media. In some embodiments, a non-wet laid process (e.g., an electrospun process, a meltblown process) may be used to form an additional layer of the first type and a wet laid process may be used to from an additional layer of the second type. First and second additional layers may be combined using any suitable process (e.g., lamination, calendering).

In some embodiments, an additional layer of the first type and/or an additional layer of the second type is produced using a wet laid process. In general, a wet laid process involves mixing together of fibers of one or more type; for example, polymeric staple fibers of one type may be mixed together with polymeric staple fibers of another type, and/or with fibers of a different type, to produce a fiber slurry. The slurry may be, for example, aqueous-based slurry. In certain embodiments, fibers, are optionally stored separately, or in combination, in various holding tanks prior to being mixed together (e.g., to achieve a greater degree of uniformity in the mixture).

During or after formation of a filter media, the filter media may be further processed according to a variety of known techniques. For instance, a coating method may be used to include a resin in the filter media. Optionally, further layers can be formed and/or added to a filter media using processes such as lamination, co-pleating, or collation. For example, in some cases, two fiber layers (e.g., an additional layer of the first type and an additional layer of the second type) are formed into a composite article by a wet laid process as described above, and the composite article is then combined with a third layer (e.g., a non-woven fiber web of the first type) by any suitable process (e.g., lamination, co-pleating, or collation). It can be appreciated that a filter media or a composite article formed by the processes described herein may be suitably tailored not only based on the components of each layer, but also according to the effect of using multiple layers having varying properties in appropriate combination to form filter media having the characteristics described herein.

In some embodiments two or more layers (e.g., an additional layer of the first type and an additional layer of the second type) are formed separately and combined by any suitable method such as lamination, calendering, collation, or by use of adhesives. The two or more layers may be formed using different processes, or the same process. For example, a filter media may comprise additional layers of the first and second type that are independently formed by a non-wet laid process (e.g., meltblown process, melt spinning process, centrifugal spinning process, electrospinning process, dry laid process, air laid process), a wet laid process, or any other suitable process.

Different layers may be adhered together by any suitable method. For instance, layers may be adhered using compressive techniques (e.g., lamination). Layers may also be adhered by chemical bonding, may be adhered by adhesives, and/or may be melt-bonded to one another on either side.

Lamination may involve, for example, compressing two or more layers (e.g., an additional layer of the first type and an additional layer of the second type) together using a flatbed laminator or any other suitable device at a particular pressure and temperature for a certain residence time (i.e., the amount of time spent under pressure and heat). For instance, the pressure may be between 5 psi and 150 psi (e.g., between 30 psi and 90 psi, between 60 psi and 120 psi, between 30 and 60 psi, or between 90 psi and 120 psi); the temperature may be between 75° F. and 400° F. (e.g., between 75° F. and 300° F., between 200° F. and 350° F., or between 275° F. and 390° F.); and the residence time may be between 1 second and 60 seconds (e.g., between 1 second and 30 seconds, between 10 second and 25 seconds, or between 20 seconds and 40 seconds). Other ranges for pressure, temperature, and residence time are also possible.

Calendering may be performed as described elsewhere herein.

In one set of embodiments, a filter media includes an additional layer of the first type formed via an electrospinning process that is adhered (e.g., laminated) to an additional layer of the second type formed via a meltblowing process. In such cases, the additional layer of the first type may comprise fibers comprising one or more of: a poly(amide), poly(ether sulfone), poly(vinylidene fluoride), regenerated cellulose, and poly(propylene). The additional layer of the first type may have an average fiber diameter of greater than or equal to 0.01 microns and less than or equal to 0.5 microns (e.g., greater than or equal to 0.05 microns and less than or equal to 0.5 microns) and/or a porosity between 70% and 90%. The basis weight of the additional layer of the first type may be greater than or equal to 0.5 gsm and less than or equal to 10 gsm (e.g., greater than or equal to 1 gsm and less than or equal to 5 gsm) and/or the basis weight of the additional layer of the first type may be less than or equal to 25% of the basis weight of an additional layer of the second type also positioned in the filter media and/or the filter media as a whole. The additional layer of the first type may have a surface area of greater than or equal to 5 m²/g and less than or equal to 350 m²/g (e.g., greater than or equal to 5 m²/g and less than or equal to 70 m²/g) and/or a maximum pore size of greater than or equal to 0.05 microns and less than or equal to 1 micron (e.g., greater than or equal to 0.1 microns and less than or equal to 0.8 microns).

An additional layer of the second type may comprise fibers comprising one or more of: a poly(amide), poly(butylene terephthalate), poly(ethylene terephthalate), a fluorinated polymer, regenerated cellulose, and poly(propylene). In some embodiments, an additional layer of the second type has a maximum pore size of greater than or equal to 1 micron and less than or equal to 70 microns (e.g., greater than or equal to 3 microns and less than or equal to 60 microns, or greater than or equal to 3 microns and less than or equal to 30 microns) and/or the ratio of the average diameter of the fibers in the additional layer of the second type to the average diameter of fibers in the additional layer of the first type is greater than or equal to 1 and less than or equal to 100 (e.g., greater than or equal to 1 and less than or equal to 70). In some embodiments, an additional layer of the second type has an average fiber diameter of greater than or equal to 0.5 microns and less than or equal to 20 microns (e.g., greater than or equal to 0.5 microns and less than or equal to 10 microns) and/or a porosity between 50% and 90% (e.g., greater than or equal to 70% and less than or equal to 90%). An additional layer of the second type may have a basis weight greater than or equal to 5 gsm and less than or equal to 70 gsm (e.g., greater than or equal to 10 gsm and less than or equal to 40 gsm) and/or a surface area of greater than or equal to 5 m²/g and less than or equal to 350 m²/g (e.g., greater than or equal to 5 m²/g to and less than or equal to 70 m²/g).

A filter media may comprise additional layers of the first and second type that have similar critical wetting surface tensions, critical surface tensions, and/or water contact angles. Such similarity between additional layers of the first and second types may serve to enhance the adhesion therebetween, the structural stability of the filter media, and/or the permeability of the filter media to certain fluids. In such cases, the additional layer of the first type may differ in water contact angle from the additional layer of the second type by less than or equal to 20° (e.g., less than or equal to 15°), in critical surface tension by less than or equal to 15 dynes/cm (e.g., less than or equal to 7 dynes/cm), and/or in critical wetting surface tension by less than or equal to 15 dynes/cm (e.g., less than or equal to 5 dynes/cm).

The fiber compositions for the additional layer of the first type and the additional layer of the second type (expressed as additional layer of the first type composition/additional layer of the second type composition) include nylon/nylon, nylon/poly(butylene terephthalate), poly(ether sulfone)/poly(butylene terephthalate), poly(ether sulfone)/poly(ethylene terephthalate), poly(vinylidene fluoride)/fluorinated polymer, regenerated cellulose (e.g., rayon, Lyocell)/regenerated cellulose, and poly(propylene)/poly(propylene). As noted above, the additional layer of the first type may be formed from a electrospinning process and the additional layer of the second type may be formed from a meltblowing process.

In some embodiments, the filter media described herein may be designed for sterile filtration. In some such embodiments, the particulate efficiency may be very high. In some embodiments, the particulate efficiency of the filter media may be expressed in terms of Log Reduction Value (i.e., LRV), which is a quantitative measure of microorganism retention by a filter media. LRV is the logarithm of Pentration⁻¹ and is expressed as follows:

LRV=Log{[CFU]_{challenge}/[CFU]_{effluent}]}

wherein [CFU]_{challenge} is the total number of bacteria in colony forming units in the fluid before passage through the filter media and/or a fiber web and [CFU]_{effluent} is the total number of bacteria in colony forming units in the fluid after passage through the filter media and/or a fiber web.

LRV may be determined using ASTM F838-05. A filter media is considered sterile when the [CFU]_{effluent} is zero; however, if the [CFU]_{effluent} is zero, one is used in the above equation to calculate LRV. Briefly, Brevundimonas diminuta at a concentration of 10⁷ CFU/1 cm² of sample area for a 76 cm² sample area may be used as the challenge. Therefore, the [CFU]challenge is 7.6×10⁸. An LRV of 8.88 is considered sterile. In some embodiments, the filter media described herein may have an LRV of equal to or greater than 8.88.

In some embodiments, the filter media described herein may have a relatively high water permeability under a variety of conditions.

For instance, in some embodiments, the water permeability of a filter media is greater than or equal to 0.1 mL/min·cm²·psi, greater than or equal to 0.2 mL/min·cm²·psi, greater than or equal to 0.3 mL/min·cm²·psi, greater than or equal to 0.5 mL/min·cm²·psi, greater than or equal to 0.8 mL/min·cm²·psi, greater than or equal to 1 mL/min·cm²·psi, greater than or equal to 2 mL/min·cm²·psi, greater than or equal to 3 mL/min·cm²·psi, greater than or equal to 4 mL/min·cm²·psi, greater than or equal to 5 mL/min·cm²·psi, greater than or equal to 6 mL/min·cm²·psi, greater than or equal to 7 mL/min·cm²·psi, or greater than or equal to 8 mL/min·cm²·psi. In some instances, the water permeability of a filter media is less than or equal to 10 mL/min·cm²·psi, less than or equal to 9 mL/min·cm²·psi, less than or equal to 8 mL/min·cm²·psi, less than or equal to 7 mL/min·cm²·psi, less than or equal to 6 mL/min·cm²·psi, less than or equal to 5 mL/min·cm²·psi, less than or equal to 4 mL/min·cm²·psi, less than or equal to 3 mL/min·cm²·psi, less than or equal to 2 mL/min·cm²·psi, less than or equal to 1 mL/min·cm²·psi, or less than or equal to 0.5 mL/min·cm²·psi. Combinations of the above-referenced ranges are possible (e.g., greater than or equal to 0.1 mL/min·cm²·psi and less than or equal to 10 mL/min·cm²·psi, or greater than or equal to 0.3 mL/min·cm²·psi and less than or equal to 7 mL/min·cm²·psi). Other ranges are also possible.

Water permeability is the water flux divided by the pressure (e.g., 20 psi) used to determine the water flow rate. Water flow rate may be measured by a procedure comprising passing deionized water through a filter media having an effective filtration area of 4.8 cm² at a pressure of 20 psi until 1,000 mL of water has been collected. First, the water flow rate may be determined by measuring the time until 1,000 mL of water has been collected and dividing 1,000 mL by this value. Water flux may then be calculated by dividing the flow rate by the effective filtration area (i.e., 4.8 cm²). Prior to the water permeability test, a critical wetting surface tension test, as described herein, may be performed on the filter media. If the sample has a critical wetting surface tension of less than 72 dyne/cm, it may be conditioned prior to measuring the water permeability. The conditioning may comprise soaking the filter media in a 70% isopropanol/water (v/v %) solution for 1 minute, and then soaking it twice in deionized water for 1 minute each time. The media may then be installed in a filter holder and 500 mL of deionized water may be pumped therethrough at 20 psi before proceeding with the water permeability test.

The filter media described herein may retain a relatively high percentage of particles (e.g., microorganisms, virus particles, biological cells) while maintaining a relatively high permeability. The filter media may have a LRV of greater than or equal to 8.88 according to ASTM F838-05 and/or a water permeability of greater than or equal to 0.1 mL/min·cm²·psi and less than or equal to 10 mL/min·cm²·psi (e.g., greater than or equal to 0.3 mL/min·cm²·psi and less than or equal to 7 mL/min·cm²·psi). The filter media may also have a peel strength between an additional layer of the first type and an additional layer of the second type of greater than or equal to 0.01 lb/in and less than or equal to 10 lb/in (e.g., greater than or equal to 0.01 lb/in and less than or equal to 5 lb/in) and/or the maximum pore size may change by less than or equal to 20% (e.g., less than or equal to 10%) when exposed to various conditions (e.g., steam sterilization at 121° C. for 40 minutes at a pressure of 17 psi).

Filter media described herein may be used in an overall filtration arrangement or filter element. In some embodiments, one or more additional fiber webs or components are included with the filter media. Non-limiting examples of additional fiber webs (e.g., an additional layer of a third type, an additional layer of a fourth type) include meltblown non-woven fiber webs, wet laid non-woven fiber webs, spunbond non-woven fiber webs, carded non-woven fiber webs, air-laid non-woven fiber webs, spunlace non-woven fiber webs, forcespun non-woven fiber webs and electrospun non-woven fiber webs.

The articles (e.g., filter media) described herein may have any of a variety of suitable basis weights. In some embodiments, an article has a basis weight of greater than or equal to 50 gsm, greater than or equal to 60 gsm, greater than or equal to 70 gsm, greater than or equal to 80 gsm, greater than or equal to 90 gsm, greater than or equal to 100 gsm, greater than or equal to 125 gsm, greater than or equal to 150 gsm, greater than or equal to 175 gsm, greater than or equal to 200 gsm, greater than or equal to 225 gsm, greater than or equal to 250 gsm, greater than or equal to 300 gsm, greater than or equal to 350 gsm, greater than or equal to 400 gsm, or greater than or equal to 450 gsm. In some embodiments, an article has a basis weight of less than or equal to 500 gsm, less than or equal to 450 gsm, less than or equal to 400 gsm, less than or equal to 350 gsm, less than or equal to 300 gsm, less than or equal to 250 gsm, less than or equal to 225 gsm, less than or equal to 200 gsm, less than or equal to 175 gsm, less than or equal to 150 gsm, less than or equal to 125 gsm, less than or equal to 100 gsm, less than or equal to 90 gsm, less than or equal to 80 gsm, less than or equal to 70 gsm, or less than or equal to 60 gsm. Combinations of the above-referenced ranges are also possible (e.g., greater than or equal to 50 gsm and less than or equal to 500 gsm, greater than or equal to 100 gsm and less than or equal to 300 gsm, or greater than or equal to 125 gsm and less than or equal to 250 gsm). Other ranges are also possible.

The basis weight of an article may be determined in accordance with ISO 536:2012.

The articles (e.g., filter media) described herein may have any of a variety of suitable thicknesses. In some embodiments, an article has a thickness of greater than or equal to 100 microns, greater than or equal to 150 microns, greater than or equal to 200 microns, greater than or equal to 250 microns, greater than or equal to 300 microns, greater than or equal to 400 microns, greater than or equal to 500 microns, greater than or equal to 600 microns, greater than or equal to 800 microns, greater than or equal to 1000 microns, greater than or equal to 1200 microns, greater than or equal to 1400 microns, greater than or equal to 1600 microns, or greater than or equal to 1800 microns. In some embodiments, an article has a thickness of less than or equal to 2000 microns, less than or equal to 1800 microns, less than or equal to 1600 microns, less than or equal to 1400 microns, less than or equal to 1200 microns, less than or equal to 1500 microns, less than or equal to 1400 microns, less than or equal to 1300 microns, less than or equal to 1000 microns, less than or equal to 800 microns, less than or equal to 600 microns, less than or equal to 500 microns, less than or equal to 400 microns, less than or equal to 300 microns, less than or equal to 250 microns, less than or equal to 200 microns, or less than or equal to 150 microns. Combinations of the above-referenced ranges are also possible (e.g., greater than or equal to 100 microns and less than or equal to 2000 microns, greater than or equal to 200 microns and less than or equal to 1000 microns, or greater than or equal to 250 microns and less than or equal to 600 microns). Other ranges are also possible.

The thickness of an article may be determined in accordance with ASTM D1777 (2015) under an applied pressure of 0.8 kPa.

The articles (e.g., filter media) described herein may have any of a variety of suitable mean flow pore sizes. In some embodiments, the article described herein may have a relatively small mean flow pore size. In some embodiments, the mean flow pore size of an article is greater than or equal to 0.1 microns, greater than or equal to 0.2 microns, greater than or equal to 0.3 microns, greater than or equal to 0.4 microns, greater than or equal to 0.5 microns, greater than or equal to 0.6 microns, greater than or equal to 0.7 microns, greater than or equal to 0.8 microns, greater than or equal to 0.9 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 3.5 microns, greater than or equal to 4 microns, or greater than or equal to 4.5 microns. In some embodiments, the mean flow pore size of an article is less than or equal to 5 microns, less than or equal to 4.5 microns, less than or equal to 4 microns, less than or equal to 3.5 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.9 microns, less than or equal to 0.8 microns, less than or equal to 0.7 microns, less than or equal to 0.6 microns, less than or equal to 0.5 microns, less than or equal to 0.4 microns, less than or equal to 0.3 microns, or less than or equal to 0.2 microns. Combinations of the above-referenced ranges are also possible (e.g., greater than or equal to 0.1 microns and less than or equal to 5 microns, greater than or equal to 0.2 microns and less than or equal to 1 micron, or greater than or equal to 0.3 microns and less than or equal to 0.6 microns). Other ranges are also possible.

The mean flow pore size of an article may be determined in accordance with ASTM F316 (2003).

The articles (e.g., filter media) described herein may have any of a variety of suitable maximum pore sizes. In some embodiments, the article described herein has a relatively small maximum pore size. In some embodiments, the maximum pore size of an article is greater than or equal to 0.5 microns, greater than or equal to 0.6 microns, greater than or equal to 0.8 microns, greater than or equal to 1 micron, greater than or equal to 1.2 microns, greater than or equal to 1.4 microns, greater than or equal to 1.6 microns, greater than or equal to 1.8 microns, greater than or equal to 2 microns, greater than or equal to 2.5 microns, greater than or equal to 3 microns, greater than or equal to 3.5 microns, greater than or equal to 4 microns, greater than or equal to 5 microns, greater than or equal to 6 microns, greater than or equal to 7 microns, greater than or equal to 8 microns, or greater than or equal to 9 microns. In some embodiments, the maximum pore size of an article is less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3.5 microns, less than or equal to 3 microns, less than or equal to 2.5 microns, less than or equal to 2 microns, less than or equal to 1.8 microns, less than or equal to 1.6 microns, less than or equal to 1.4 microns, less than or equal to 1.2 microns, less than or equal to 1 micron, less than or equal to 0.8 microns, or less than or equal to 0.6 microns. Combinations of the above-referenced ranges are also possible (e.g., greater than or equal to 0.5 microns and less than or equal to 10 microns, greater than or equal to 0.8 microns and less than or equal to 5 microns, or greater than or equal to 1 micron and less than or equal to 2 microns). Other ranges are also possible.

The maximum pore size of an article may be determined in accordance with ASTM F316 (2003).

The articles (e.g., filter media) described herein may have any of a variety of suitable ratios of maximum pore size to mean flow pore size. In some embodiments, the ratio of maximum pore size to mean flow pore size of an article is greater than or equal to 2, greater than or equal to 2.25, greater than or equal to 2.5, greater than or equal to 2.75, greater than or equal to 3, greater than or equal to 3.25, greater than or equal to 3.5, greater than or equal to 4, greater than or equal to 4.5, greater than or equal to 5, greater than or equal to 5.5, greater than or equal to 6, greater than or equal to 6.5, greater than or equal to 7, greater than or equal to 7.5, greater than or equal to 8, or greater than or equal to 9. In some embodiments, the ratio of maximum pore size to mean flow pore size of an article is less than or equal to 10, less than or equal to 9, less than or equal to 8, less than or equal to 7.5, less than or equal to 7, less than or equal to 6, less than or equal to 6.5, less than or equal to 6, less than or equal to 5.5, less than or equal to 5, less than or equal to 4.5, less than or equal to 4, less than or equal to 3.5, less than or equal to 3.25, less than or equal to 3, less than or equal to 2.75, less than or equal to 2.5, or less than or equal to 2.25. Combinations of the above-referenced ranges are also possible (e.g., greater than or equal to 2 and less than or equal to 10, greater than or equal to 2 and less than or equal to 8, or greater than or equal to 2 and less than or equal to 5). Other ranges are also possible.

The articles (e.g., filter media) described herein may have any of a variety of suitable air permeabilities. In some embodiments, an article has an air permeability of greater than or equal to 5 CFM, greater than or equal to 6 CFM, greater than or equal to 8 CFM, greater than or equal to 10 CFM, greater than or equal to 12.5 CFM, greater than or equal to 15 CFM, greater than or equal to 20 CFM, greater than or equal to 25 CFM, greater than or equal to 30 CFM, greater than or equal to 32.5 CFM, greater than or equal to 35 CFM, greater than or equal to 40 CFM, greater than or equal to 45 CFM, greater than or equal to 50 CFM, greater than or equal to 55 CFM, greater than or equal to 60 CFM, greater than or equal to 65 CFM, greater than or equal to 70 CFM, greater than or equal to 80 CFM, or greater than or equal to 90 CFM. In some embodiments, an article has an air permeability of less than or equal to 100 CFM, less than or equal to 90 CFM, less than or equal to 80 CFM, less than or equal to 70 CFM, less than or equal to 65 CFM, less than or equal to 60 CFM, less than or equal to 55 CFM, less than or equal to 50 CFM, less than or equal to 45 CFM, less than or equal to 40 CFM, less than or equal to 35 CFM, less than or equal to 30 CFM, less than or equal to 25 CFM, less than or equal to 20 CFM, less than or equal to 15 CFM, less than or equal to 12.5 CFM, less than or equal to 10 CFM, less than or equal to 8 CFM, or less than or equal to 6 CFM. Combinations of the above-referenced ranges are also possible (e.g., greater than or equal to 5 CFM and less than or equal to 100 CFM, greater than or equal to 10 CFM and less than or equal to 60 CFM, or greater than or equal to 15 CFM and less than or equal to 45 CFM). Other ranges are also possible.

The air permeability of an article may be determined in accordance with ASTM D737-04 (2016) at a pressure of 125 Pa.

The articles (e.g., filter media) described herein may have relatively high values of dry tensile strength in the machine direction. In some embodiments, an article may have a dry tensile strength in the machine direction of greater than or equal to 10 lb/in, greater than or equal to 15 lb/in, greater than or equal to 20 lb/in, greater than or equal to 25 lb/in, greater than or equal to 30 lb/in, greater than or equal to 35 lb/in, greater than or equal to 40 lb/in, greater than or equal to 45 lb/in, greater than or equal to 50 lb/in, greater than or equal to 55 lb/in, greater than or equal to 60 lb/in, greater than or equal to 65 lb/in, greater than or equal to 70 lb/in, greater than or equal to 75 lb/in, greater than or equal to 80 lb/in, greater than or equal to 85 lb/in, greater than or equal to 90 lb/in, greater than or equal to 100 lb/in, greater than or equal to 120 lb/in, greater than or equal to 140 lb/in, greater than or equal to 160 lb/in, or greater than or equal to 180 lb/in. In some embodiments, an article has a dry tensile strength in the machine direction of less than or equal to 200 lb/in, less than or equal to 180 lb/in, less than or equal to 160 lb/in, less than or equal to 140 lb/in, less than or equal to 120 lb/in, less than or equal to 100 lb/in, less than or equal to 90 lb/in, less than or equal to 85 lb/in, less than or equal to 80 lb/in, less than or equal to 75 lb/in, less than or equal to 70 lb/in, less than or equal to 65 lb/in, less than or equal to 60 lb/in, less than or equal to 55 lb/in, less than or equal to 50 lb/in, less than or equal to 45 lb/in, less than or equal to 40 lb/in, less than or equal to 35 lb/in, less than or equal to 30 lb/in, less than or equal to 25 lb/in, less than or equal to 20 lb/in, or less than or equal to 15 lb/in. Combinations of the above-referenced ranges are also possible (e.g., greater than or equal to 10 lb/in and less than or equal to 200 lb/in, greater than or equal to 25 lb/in and less than or equal to 75 lb/in, or greater than or equal to 35 lb/in and less than or equal to 45 lb/in). Other ranges are also possible.

The dry tensile strength in the machine direction of an article may be determined in accordance with the standard T494 om-96 (1996) test using a test span of 3 inches, a jaw separation speed of 12 in/min, and a specimen having a dimension of 6 inches by 1 inch.

The articles (e.g., filter media) described herein may have relatively high values of dry tensile strength in the cross direction. In some embodiments, an article may have a dry tensile strength in the cross direction of greater than or equal to 10 lb/in, greater than or equal to 15 lb/in, greater than or equal to 20 lb/in, greater than or equal to 25 lb/in, greater than or equal to 30 lb/in, greater than or equal to 35 lb/in, greater than or equal to 40 lb/in, greater than or equal to 45 lb/in, greater than or equal to 50 lb/in, greater than or equal to 55 lb/in, greater than or equal to 60 lb/in, greater than or equal to 65 lb/in, greater than or equal to 70 lb/in, greater than or equal to 75 lb/in, greater than or equal to 80 lb/in, greater than or equal to 85 lb/in, greater than or equal to 90 lb/in, greater than or equal to 100 lb/in, greater than or equal to 120 lb/in, greater than or equal to 140 lb/in, greater than or equal to 160 lb/in, or greater than or equal to 180 lb/in. In some embodiments, an article has a dry tensile strength in the cross direction of less than or equal to 200 lb/in, less than or equal to 180 lb/in, less than or equal to 160 lb/in, less than or equal to 140 lb/in, less than or equal to 120 lb/in, less than or equal to 100 lb/in, less than or equal to 90 lb/in, less than or equal to 85 lb/in, less than or equal to 80 lb/in, less than or equal to 75 lb/in, less than or equal to 70 lb/in, less than or equal to 65 lb/in, less than or equal to 60 lb/in, less than or equal to 55 lb/in, less than or equal to 50 lb/in, less than or equal to 45 lb/in, less than or equal to 40 lb/in, less than or equal to 35 lb/in, less than or equal to 30 lb/in, less than or equal to 25 lb/in, less than or equal to 20 lb/in, or less than or equal to 15 lb/in. Combinations of the above-referenced ranges are also possible (e.g., greater than or equal to 10 lb/in and less than or equal to 200 lb/in, greater than or equal to 25 lb/in and less than or equal to 75 lb/in, or greater than or equal to 35 lb/in and less than or equal to 45 lb/in). Other ranges are also possible.

The dry tensile strength in the cross direction of an article may be determined in accordance with the standard T494 om-96 (1996) test using a test span of 3 inches, a jaw separation speed of 12 in/min, and a specimen having a dimension of 6 inches by 1 inch.

The articles (e.g., filter media) described herein may have any of a variety of ratios of dry tensile strength in the machine direction to dry tensile strength in the cross direction. In some embodiments, an article has a ratio of dry tensile strength in the machine direction to dry tensile strength in the cross direction of greater than or equal to 0.8, greater than or equal to 0.9, greater than or equal to 1, greater than or equal to 1.1, greater than or equal to 1.2, greater than or equal to 1.3, greater than or equal to 1.4, greater than or equal to 1.5, greater than or equal to 1.6, greater than or equal to 1.7, greater than or equal to 1.8, greater than or equal to 1.9, greater than or equal to 2, greater than or equal to 2.1, greater than or equal to 2.2, greater than or equal to 2.3, greater than or equal to 2.4, greater than or equal to 2.5, greater than or equal to 2.6, greater than or equal to 2.7, greater than or equal to 2.8, greater than or equal to 2.9, greater than or equal to 3, greater than or equal to 3.2, greater than or equal to 3.4, greater than or equal to 3.6, or greater than or equal to 3.8. In some embodiments, an article has a ratio of dry tensile strength in the machine direction to dry tensile strength in the cross direction of less than or equal to 4, less than or equal to 3.8, less than or equal to 3.6, less than or equal to 3.4, less than or equal to 3.2, less than or equal to 3, less than or equal to 2.9, less than or equal to 2.8, less than or equal to 2.7 less than or equal to 2.6, less than or equal to 2.5, less than or equal to 2.4, less than or equal to 2.3, less than or equal to 2.2, less than or equal to 2.1, less than or equal to 2, less than or equal to 1.9, less than or equal to 1.8, less than or equal to 1.7, less than or equal to 1.6, less than or equal to 1.5, less than or equal to 1.4, less than or equal to 1.3, less than or equal to 1.2, less than or equal to 1.1, less than or equal to 1, or less than or equal to 0.9. Combinations of the above-referenced ranges are also possible (e.g., greater than or equal to 0.8 and less than or equal to 4, greater than or equal to 1 and less than or equal to 3, or greater than or equal to 1.5 and less than or equal to 2.5). Other ranges are also possible.

The articles (e.g., filter media) described herein may have relatively high values of dry Mullen burst strength. In some embodiments, the dry Mullen burst strength of an article is greater than or equal to 10 lb/in², greater than or equal to 20 lb/in², greater than or equal to 40 lb/in², greater than or equal to 60 lb/in², greater than or equal to 80 lb/in², greater than or equal to 100 lb/in², greater than or equal to 120 lb/in², greater than or equal to 140 lb/in², greater than or equal to 160 lb/in², greater than or equal to 180 lb/in², greater than or equal to 200 lb/in², greater than or equal to 225 lb/in², greater than or equal to 250 lb/in², greater than or equal to 275 lb/in², greater than or equal to 300 lb/in², greater than or equal to 350 lb/in², greater than or equal to 400 lb/in², greater than or equal to 450 lb/in², greater than or equal to 500 lb/in², or greater than or equal to 550 lb/in². In some embodiments, the dry Mullen burst strength of an article is less than or equal to 600 lb/in², less than or equal to 550 lb/in², less than or equal to 500 lb/in², less than or equal to 450 lb/in², less than or equal to 400 lb/in², less than or equal to 350 lb/in², less than or equal to 300 lb/in², less than or equal to 275 lb/in², less than or equal to 250 lb/in², less than or equal to 225 lb/in², less than or equal to 200 lb/in², less than or equal to 180 lb/in², less than or equal to 160 lb/in², less than or equal to 140 lb/in², less than or equal to 120 lb/in², less than or equal to 100 lb/in², less than or equal to 80 lb/in², less than or equal to 60 lb/in², less than or equal to 40 lb/in², or less than or equal to 20 lb/in². Combinations of the above-referenced ranges are also possible (e.g., greater than or equal to 10 lb/in² and less than or equal to 600 lb/in², greater than or equal to 100 lb/in² and less than or equal to 400 lb/in², or greater than or equal to 120 lb/in² and less than or equal to 300 lb/in²). Other ranges are also possible.

The dry Mullen burst strength of an article may be determined in accordance with the standard TAPPI T403 (1997) test.

The articles (e.g., filter media) described herein may have any of a variety of values of dry tensile elongation at break in the machine direction. In some embodiments, the dry tensile elongation at break in the machine direction of an article is greater than or equal to 5%, greater than or equal to 6%, greater than or equal to 7%, greater than or equal to 8%, greater than or equal to 9%, greater than or equal to 10%, greater than or equal to 12.5%, greater than or equal to 15%, greater than or equal to 20%, greater than or equal to 25%, greater than or equal to 30%, greater than or equal to 35%, greater than or equal to 40%, or greater than or equal to 45%. In some embodiments, the dry tensile elongation at break in the machine direction of an article is less than or equal to 50%, less than or equal to 45%, less than or equal to 40%, less than or equal to 35%, less than or equal to 30%, less than or equal to 25%, less than or equal to 20%, less than or equal to 17.5%, less than or equal to 15%, less than or equal to 12.5%, less than or equal to 10%, less than or equal to 9%, less than or equal to 8%, less than or equal to 7%, or less than or equal to 6%. Combinations of the above-referenced ranges are also possible (e.g., greater than or equal to 5% and less than or equal to 50%, greater than or equal to 8% and less than or equal to 40%, or greater than or equal to 10% and less than or equal to 30%). Other ranges are also possible.

The dry tensile elongations at break in the machine direction may be determined in accordance with the standard T494 om-96 (1996) test using a test span of 3 inches, a jaw separation speed of 12 in/min, and a specimen having a dimension of 6 inches by 1 inch.

The articles (e.g., filter media) described herein may have any of a variety of values of dry tensile elongation at break in the cross direction. In some embodiments, the dry tensile elongation at break in the cross direction of an article is greater than or equal to 5%, greater than or equal to 6%, greater than or equal to 7%, greater than or equal to 8%, greater than or equal to 9%, greater than or equal to 10%, greater than or equal to 12.5%, greater than or equal to 15%, greater than or equal to 20%, greater than or equal to 25%, greater than or equal to 30%, greater than or equal to 35%, greater than or equal to 40%, or greater than or equal to 45%. In some embodiments, the dry tensile elongation at break in the cross direction of an article is less than or equal to 50%, less than or equal to 45%, less than or equal to 40%, less than or equal to 35%, less than or equal to 30%, less than or equal to 25%, less than or equal to 20%, less than or equal to 17.5%, less than or equal to 15%, less than or equal to 12.5%, less than or equal to 10%, less than or equal to 9%, less than or equal to 8%, less than or equal to 7%, or less than or equal to 6%. Combinations of the above-referenced ranges are also possible (e.g., greater than or equal to 5% and less than or equal to 50%, greater than or equal to 8% and less than or equal to 40%, or greater than or equal to 10% and less than or equal to 30%). Other ranges are also possible.

The dry tensile elongations at break in the cross direction may be determined in accordance with the standard T494 om-96 (1996) test using a test span of 3 inches, a jaw separation speed of 12 in/min, and a specimen having a dimension of 6 inches by 1 inch.

The initial NaCl particle penetration at 0.3 microns for an article (e.g., filter media) may have any of a variety of suitable values. In some embodiments, the NaCl particle penetration at 0.3 microns for an article is greater than or equal to 0.0001%, greater than or equal to 0.001%, greater than or equal to 0.01%, greater than or equal to 0.1%, greater than or equal to 1%, greater than or equal to 2%, greater than or equal to 3%, greater than or equal to 4%, greater than or equal to 5%, greater than or equal to 7.5%, greater than or equal to 10%, greater than or equal to 15%, greater than or equal to 20%, greater than or equal to 25%, greater than or equal to 30%, greater than or equal to 40%, greater than or equal to 50%, greater than or equal to 60%, greater than or equal to 70%, greater than or equal to 80%, or greater than or equal to 90%. The initial NaCl penetration at 0.3 microns for an article may be less than or equal to 99.9%, less than or equal to 90%, less than or equal to 80%, less than or equal to 70%, less than or equal to 60%, less than or equal to 50%, less than or equal to 40%, less than or equal to 30%, less than or equal to 25%, less than or equal to 20%, less than or equal to 15%, less than or equal to 10%, less than or equal to 7.5%, less than or equal to 5%, less than or equal to 4%, less than or equal to 3%, less than or equal to 2%, less than or equal to 1%, less than or equal to 0.1%, less than or equal to 0.01%, or less than or equal to 0.001%. Combinations of the above-referenced ranges are also possible (e.g., greater than or equal to 0.0001% and less than or equal to 99.9%, greater than or equal to 0.001% and less than or equal to 10%, or greater than or equal to 0.01% and less than or equal to 5%). Other ranges are also possible.

The initial NaCl particle penetration may be determined using a TSI 8130 Automated Filter Tester as described elsewhere herein.

In some embodiments, the air resistance of an article (e.g., a filter media) is greater than or equal to 1 mm H₂O, greater than or equal to 2.5 mm H₂O, greater than or equal to 5 mm H₂O, greater than or equal to 7.5 mm H₂O, greater than or equal to 10 mm H₂O, greater than or equal to 15 mm H₂O, greater than or equal to 20 mm H₂O, greater than or equal to 30 mm H₂O, greater than or equal to 40 mm H₂O, greater than or equal to 50 mm H₂O, greater than or equal to 60 mm H₂O, greater than or equal to 70 mm H₂O, greater than or equal to 80 mm H₂O, or greater than or equal to 90 mm H₂O. In some embodiments, the air resistance of an article is less than or equal to 100 mm H₂O, less than or less than or equal to 90 mm H₂O, less than or equal to 80 mm H₂O, less than or equal to 70 mm H₂O, less than or equal to 60 mm H₂O, less than or equal to 50 mm H₂O, less than or equal to 40 mm H₂O, less than or equal to 30 mm H₂O, less than or equal to 20 mm H₂O, less than or equal to 15 mm H₂O, less than or equal to 10 mm H₂O, less than or equal to 7.5 mm H₂O, less than or equal to 5 mm H₂O, or less than or equal to 2.5 mm H₂O. Combinations of the above-referenced ranges are also possible (e.g., greater than or equal to 1 mm H₂O and less than or equal to 100 mm H₂O, greater than or equal to 5 mm H₂O and less than or equal to 80 mm H₂O, or greater than or equal to 10 mm H₂O and less than or equal to 60 inches H₂O). Other ranges are also possible.

The air resistance may be determined using the standard ASTM D2 986-91 testing using a TSI 8130 Automated Filter Tester as described elsewhere herein.

The articles (e.g., filter media) described herein may have any of a variety of suitable values of average filtration efficiency. In some embodiments, the article has an average filtration efficiency of greater than or equal to 1%, greater than or equal to 5%, greater than or equal to 10%, greater than or equal to 20%, greater than or equal to 30%, greater than or equal to 40%, greater than or equal to 50%, greater than or equal to 60%, greater than or equal to 70%, greater than or equal to 80%, greater than or equal to 90%, greater than or equal to 95%, greater than or equal to 98%, greater than or equal to 99%, greater than or equal to 99.99%, or greater than or equal to 99.9999%. In some embodiments, the article has an average filtration efficiency of less than 100%, less than or equal to 99.9999%, less than or equal to 99.99%, less than or equal to 99%, less than or equal to 98%, less than or equal to 95%, less than or equal to 90%, less than or equal to 80%, less than or equal to 70%, less than or equal to 60%, less than or equal to 50%, less than or equal to 40%, less than or equal to 30%, less than or equal to 20%, or less than or equal to 10%. Combinations of these ranges are also possible (e.g., greater than or equal to 1% and less than or equal to 100%, greater than or equal to 10% and less than or equal to 99.9999%, or greater than or equal to 90% and less than 99.99%).

Average filtration efficiency may be measured according to EN-13443-2 (2007). EN-13443-2 (2007) efficiency testing may be carried out by measuring a diluted feed stream over a 2-hour period, using a blend of latex particles having 4 different mean particle diameters (0.2 micron, 0.4 micron, 0.6 micron, and 0.8 micron) dispersed in clean water, with a particle count concentration of 2,200 counts/mL, at a 15 L/min flow rate and a temperature of 23° C. (±2° C.). Upstream and downstream measurements may be taken at 30 minutes, 60 minutes, 90 minutes, and 120 minutes after the commencement of the test. These values may be averaged to find the average filtration efficiency.

The articles (e.g., filter media) described herein may have any of a variety of suitable values of silica dirt retention. In some embodiments, the silica dirt retention for an article is greater than or equal to 1%, greater than or equal to 5%, greater than or equal to 10%, greater than or equal to 15%, greater than or equal to 20%, greater than or equal to 25%, greater than or equal to 30%, greater than or equal to 40%, greater than or equal to 50%, greater than or equal to 60%, greater than or equal to 70%, greater than or equal to 80%, greater than or equal to 90%, greater than or equal to 95%, greater than or equal to 99%, or greater than or equal to 99.5%. In some embodiments, the silica dirt retention for an article is less than or equal to 100%, less than or equal to 99.5%, less than or equal to 99%, less than or equal to 95%, less than or equal to 90%, less than or equal to 80%, less than or equal to 70%, less than or equal to 60%, less than or equal to 50%, less than or equal to 40%, less than or equal to 30%, less than or equal to 25%, less than or equal to 20%, less than or equal to 15%, less than or equal to 10%, or less than or equal to 5%. Combinations of the above-referenced ranges are also possible (e.g., greater than or equal to 1% and less than or equal to 100%, greater than or equal to 10% and less than or equal to 99%, or greater than or equal to 40% and less than or equal to 95%). Other ranges are also possible.

The silica dirt retention may be determined as described elsewhere herein with respect to the non-woven fiber webs of the first type.

The articles (e.g., filter media) described herein may have relatively high values of silica dirt solution flow rate. In some embodiments, the silica dirt solution flow rate for an article is greater than or equal to 10 mL/min, greater than or equal to 25 mL/min, greater than or equal to 50 mL/min, greater than or equal to 75 mL/min, greater than or equal to 100 mL/min, greater than or equal to 125 mL/min, greater than or equal to 150 mL/min, greater than or equal to 175 mL/min, greater than or equal to 200 mL/min, greater than or equal to 225 mL/min, greater than or equal to 250 mL/min, greater than or equal to 275 mL/min, greater than or equal to 300 mL/min, greater than or equal to 325 mL/min, greater than or equal to 350 mL/min, or greater than or equal to 375 mL/min. In some embodiments, the silica dirt solution flow rate for an article is less than or equal to 400 mL/min, less than or equal to 375 mL/min, less than or equal to 350 mL/min, less than or equal to 325 mL/min, less than or equal to 300 mL/min, less than or equal to 275 mL/min, less than or equal to 250 mL/min, less than or equal to 225 mL/min, less than or equal to 200 mL/min, less than or equal to 175 mL/min, less than or equal to 150 mL/min, less than or equal to 125 mL/min, less than or equal to 100 mL/min, less than or equal to 75 mL/min, less than or equal to 50 mL/min, or less than or equal to 25 mL/min. Combinations of the above-referenced ranges are also possible (e.g., greater than or equal to 10 mL/min and less than or equal to 400 mL/min, greater than or equal to 25 mL/min and less than or equal to 350 mL/min, or greater than or equal to 50 mL/min and less than or equal to 250 mL/min). Other ranges are also possible.

The silica dirt solution flow rate may be determined as described elsewhere herein with respect to the non-woven fiber webs of the first type.

The articles (e.g., filter media) described herein may have any of a variety of suitable values of monodisperse polystyrene sphere retention. In some embodiments, the monodispersed polystyrene sphere retention for an article is greater than or equal to 1%, greater than or equal to 5%, greater than or equal to 10%, greater than or equal to 15%, greater than or equal to 20%, greater than or equal to 25%, greater than or equal to 30%, greater than or equal to 40%, greater than or equal to 50%, greater than or equal to 60%, greater than or equal to 70%, greater than or equal to 80%, greater than or equal to 90%, greater than or equal to 95%, greater than or equal to 99%, or greater than or equal to 99.5%. In some embodiments, the monodisperse polystyrene sphere retention for an article is less than or equal to 100%, less than or equal to 99.5%, less than or equal to 99%, less than or equal to 95%, less than or equal to 90%, less than or equal to 80%, less than or equal to 70%, less than or equal to 60%, less than or equal to 50%, less than or equal to 40%, less than or equal to 30%, less than or equal to 25%, less than or equal to 20%, less than or equal to 15%, less than or equal to 10%, or less than or equal to 5%. Combinations of the above-referenced ranges are also possible (e.g., greater than or equal to 1% and less than or equal to 100%, greater than or equal to 10% and less than or equal to 99%, or greater than or equal to 40% and less than or equal to 95%). Other ranges are also possible.

The monodisperse polystyrene sphere retention may be determined as described elsewhere herein with respect to the non-woven fiber webs of the first type except that the monodisperse polystyrene spheres may have a diameter of 0.5 microns and the solution may have a turbidity of 180 NTU.

The articles (e.g., filter media) described herein may have relatively high values of monodisperse polystyrene sphere solution flow rate. In some embodiments, the monodisperse polystyrene sphere solution flow rate for an article is greater than or equal to 10 mL/min, greater than or equal to 25 mL/min, greater than or equal to 50 mL/min, greater than or equal to 75 mL/min, greater than or equal to 100 mL/min, greater than or equal to 125 mL/min, greater than or equal to 150 mL/min, greater than or equal to 200 mL/min, greater than or equal to 250 mL/min, greater than or equal to 300 mL/min, greater than or equal to 350 mL/min, greater than or equal to 400 mL/min, or greater than or equal to 450 mL/min. In some embodiments, the monodisperse polystyrene sphere solution flow rate for an article is less than or equal to 500 mL/min, less than or equal to 450 mL/min, less than or equal to 400 mL/min, less than or equal to 350 mL/min, less than or equal to 300 mL/min, less than or equal to 250 mL/min, less than or equal to 200 mL/min, less than or equal to 150 mL/min, less than or equal to 125 mL/min, less than or equal to 100 mL/min, less than or equal to 75 mL/min, less than or equal to 50 mL/min, or less than or equal to 25 mL/min. Combinations of the above-referenced ranges are also possible (e.g., greater than or equal to 10 mL/min and less than or equal to 500 mL/min, greater than or equal to 25 mL/min and less than or equal to 450 mL/min, or greater than or equal to 50 mL/min and less than or equal to 350 mL/min). Other ranges are also possible.

The monodisperse polystyrene sphere solution flow rate may be determined as described elsewhere herein with respect to the non-woven fiber webs of the first type except that the monodisperse polystyrene spheres may have a diameter of 0.5 microns and the solution may have a turbidity of 180 NTU.

As discussed previously, the non-woven fiber webs of the first type described herein may be used in a filter media. It is also possible for the non-woven fiber webs of the first type described herein to be used for various other applications. In such applications, the non-woven fiber webs of the first type may function as fabrics for agricultural irrigation and/or nets.

For example, in one set of embodiments, a non-woven fiber web of the first type may be used as a fabric for agricultural irrigation (e.g., drip irrigation). In some such cases, the non-woven fiber web of the first type may advantageously allow precise control of liquid flowrate (e.g., water flowrate) therethrough and/or may facilitate filtration of undesirable solids from the liquid. Such non-woven fiber webs of the first type may advantageously provide water that is relatively pure at a flow rate suitable for irrigating plants (e.g., such that the water drips through the non-woven fiber web of the first type).

As another example, in one set of embodiments, a non-woven fiber web of the first type may be used in a net and/or a related system for solid capturing. For instance, when used in a net, the non-woven fiber web of the first type may be used to capture materials having a relatively small size (e.g., microplastics) from a liquid (e.g., wastewater, seawater from the ocean, etc.).

In some embodiments, a non-woven fiber web of the first type may be used as a backer for a membrane. For instance, a non-woven fiber web of the first type, as a backer, may provide support for one or more membranes. In some embodiments, the membrane described herein is a solution cast membrane, such as a solution cast membrane for microfiltration and/or a solution cast membrane for ultrafiltration. Some such membranes may comprise polymers, such as poly(ether sulfone), poly(acrylonitrile), poly(vinylidene fluoride), a poly(olefin), poly(ether ether ketone), and/or a poly(amide).

When a filter media comprises two or more membranes, each membrane may independently comprise one or more of the above-referenced materials.

The membranes described herein may have any of a variety of suitable basis weights. In some embodiments, a membrane has a basis weight of greater than or equal to 20 gsm, greater than or equal to 30 gsm, greater than or equal to 40 gsm, greater than or equal to 60 gsm, greater than or equal to 80 gsm, greater than or equal to 100 gsm, greater than or equal to 120 gsm, greater than or equal to 140 gsm, greater than or equal to 160 gsm, or greater than or equal to 180 gsm. In some embodiments, a membrane has a basis weight of less than or equal to 200 gsm, less than or equal to 180 gsm, less than or equal to 160 gsm, less than or equal to 140 gsm, less than or equal to 120 gsm, less than or equal to 100 gsm, less than or equal to 80 gsm, less than or equal to 60 gsm, less than or equal to 40 gsm, or less than or equal to 30 gsm. Combinations of the above-referenced ranges are also possible (e.g., greater than or equal to 20 gsm and less than or equal to 200 gsm). Other ranges are also possible.

The basis weight of a membrane described herein may be determined in accordance with ISO 536:2012.

When a filter media comprises two or more membranes, each membrane may independently have a basis weight in one or more of the above-referenced ranges.

The membranes described herein may have any of a variety of suitable thicknesses. In some instances, a membrane has a thickness of greater than or equal to 1 mil, greater than or equal to 2 mils, greater than or equal to 3 mils, greater than or equal to 4 mils, greater than or equal to 5 mils, greater than or equal to 6 mils, greater than or equal to 7 mils, greater than or equal to 8 mils, or greater than or equal to 9 mils. In some embodiments, a membrane has a thickness of less than or equal to 10 mils, less than or equal to 9 mils, less than or equal to 8 mils, less than or equal to 7 mils, less than or equal to 6 mils, less than or equal to 5 mils, less than or equal to 4 mils, less than or equal to 3 mils, or less than or equal to 2 mils. Combinations of the above-referenced ranges are also possible (e.g., greater than or equal to 1 mil and less than or equal to 10 mil). Other ranges are also possible.

The thickness of a membrane may be determined according to the standard ASTM D1777 (2015) under an applied pressure of 0.8 kPa.

When a filter media comprises two or more membranes, each membrane may independently have a thickness in one or more of the above-referenced ranges.

In some embodiments, a membrane described herein is a solution cast membrane for microfiltration. In some embodiments, a membrane for microfiltration has a mean flow pore size of greater than or equal to 0.1 microns, greater than or equal to 0.5 microns, greater than or equal to 1 micron, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, or greater than or equal to 9 microns. In some embodiments, a membrane for microfiltration has a mean flow pore size of less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, less than or equal to 2 microns, less than or equal to 1 micron, or less than or equal to 0.5 microns. Combinations of the above-referenced ranges are also possible (e.g., greater than or equal to 0.1 microns and less than or equal to 10 microns). Other ranges are also possible.

The mean flow pore size of a membrane for microfiltration may be determined in accordance with ASTM F316 (2003).

When a filter media comprises two or more membranes for microfiltration, each membrane for microfiltration may independently have a mean flow pore size in one or more of the above-referenced ranges.

In some embodiments, a membrane described herein is a solution cast membrane for ultrafiltration. In some embodiments, a membrane for ultrafiltration has a mean flow pore size of greater than or equal to 0.01 microns, greater than or equal to 0.02 microns, greater than or equal to 0.03 microns, greater than or equal to 0.04 microns, greater than or equal to 0.05 microns, greater than or equal to 0.06 microns, greater than or equal to 0.07 microns, greater than or equal to 0.08 microns, or greater than or equal to 0.09 microns. In some embodiments, a membrane for ultrafiltration has a mean flow pore size of less than or equal to 0.1 microns, less than or equal to 0.09 microns, less than or equal to 0.08 microns, less than or equal to 0.07 microns, less than or equal to 0.06 microns, less than or equal to 0.05 microns, less than or equal to 0.04 microns, less than or equal to 0.03 microns, or less than or equal to 0.02 microns. Combinations of the above-referenced ranges are also possible (e.g., greater than or equal to 0.01 microns and less than or equal to 0.1 microns). Other ranges are also possible.

The mean flow pore size of a membrane for ultrafiltration may be determined in accordance with ASTM F316 (2003).

When a filter media comprises two or more membranes for ultrafiltration, each membrane for ultrafiltration may independently have a mean flow pore size in one or more of the above-referenced ranges.

In some embodiments (when the article described herein is a filter media), the filter media can be incorporated into a variety of filter elements for use in various filtering applications. Exemplary types of filters include bioprocessing filters, chemical processing filters, industrial processing filters, medical filters (e.g., filters for blood), vent filters, air filters, and water filters. The filter media may be suitable for filtering gases or liquids. The water and/or air filters may be used for the removal of microorganisms, virus particles, and/or other contaminants. For instance, filter media suitable for water filtration may be used for the treatment of municipal water, waste water, residential water, and/or industrial water (e.g., mining water, cooling tower/boiler water, nuclear water, ultra-pure water production for the semiconductor and biopharmaceutical industries). During use, the filter media may mechanically trap contaminant particles on the filter media as fluid (e.g., water) flows through the filter media.

In some embodiments (when the article described herein is a filter media), the filter media described herein is a component of a filter element. That is, the filter media may be incorporated into an article suitable for use by an end user.

Non-limiting examples of suitable filter elements include flat panel filters, cartridge filters, cylindrical filters, and conical filters. Filter elements may have any suitable height (e.g., between 2 in and 124 in for flat panel filters, between 1 in and 124 in for cartridge and cylindrical filter media). Filter elements may also have any suitable width (between 2 in and 124 in for flat panel filters). Some filter media (e.g., cartridge filter media, cylindrical filter media) may be characterized by a diameter instead of a width; these filter media may have a diameter of any suitable value (e.g., between 1 in and 124 in). Filter elements typically comprise a frame, which may be made of one or more materials such as cardboard, aluminum, steel, alloys, wood, and polymers.

In some embodiments, a filter media described herein is a component of a filter element and is pleated. The pleat height and pleat density (number of pleats per unit length of the filter media) may be selected as desired. In some embodiments, the pleat height is greater than or equal to 3 mm, greater than or equal to 5 mm, greater than or equal to 10 mm, greater than or equal to 15 mm, greater than or equal to 20 mm, greater than or equal to 25 mm, greater than or equal to 30 mm, greater than or equal to 35 mm, greater than or equal to 40 mm, greater than or equal to 45 mm, greater than or equal to 50 mm, greater than or equal to 53 mm, greater than or equal to 55 mm, greater than or equal to 60 mm, greater than or equal to 65 mm, greater than or equal to 70 mm, greater than or equal to 75 mm, greater than or equal to 80 mm, greater than or equal to 85 mm, greater than or equal to 90 mm, greater than or equal to 95 mm, greater than or equal to 100 mm, greater than or equal to 125 mm, greater than or equal to 150 mm, greater than or equal to 175 mm, greater than or equal to 200 mm, greater than or equal to 225 mm, greater than or equal to 250 mm, greater than or equal to 275 mm, greater than or equal to 300 mm, greater than or equal to 325 mm, greater than or equal to 350 mm, greater than or equal to 375 mm, greater than or equal to 400 mm, greater than or equal to 425 mm, greater than or equal to 450 mm, greater than or equal to 475 mm, or greater than or equal to 500 mm. In some embodiments, the pleat height is less than or equal to 510 mm, less than or equal to 500 mm, less than or equal to 475 mm, less than or equal to 450 mm, less than or equal to 425 mm, less than or equal to 400 mm, less than or equal to 375 mm, less than or equal to 350 mm, less than or equal to 325 mm, less than or equal to 300 mm, less than or equal to 275 mm, less than or equal to 250 mm, less than or equal to 225 mm, less than or equal to 200 mm, less than or equal to 175 mm, less than or equal to 150 mm, less than or equal to 125 mm, less than or equal to 100 mm, less than or equal to 95 mm, less than or equal to 90 mm, less than or equal to 85 mm, less than or equal to 80 mm, less than or equal to 75 mm, less than or equal to 70 mm, less than or equal to 65 mm, less than or equal to 60 mm, less than or equal to 55 mm, less than or equal to 53 mm, less than or equal to 50 mm, less than or equal to 45 mm, less than or equal to 40 mm, less than or equal to 35 mm, less than or equal to 30 mm, less than or equal to 25 mm, less than or equal to 20 mm, less than or equal to 15 mm, less than or equal to 10 mm, or less than or equal to 5 mm. Combinations of the above-referenced ranges are also possible (e.g., greater than or equal to 3 mm and less than or equal to 510 mm, greater than or equal to 10 mm and less than or equal to 510 mm, or greater than or equal to 10 mm and less than or equal to 100 mm). Other ranges are also possible.

In some embodiments, a filter media has a pleat density of greater than or equal to 5 pleats per 100 mm, greater than or equal to 6 pleats per 100 mm, greater than or equal to 10 pleats per 100 mm, greater than or equal to 15 pleats per 100 mm, greater than or equal to 20 pleats per 100 mm, greater than or equal to 25 pleats per 100 mm, greater than or equal to 28 pleats per 100 mm, greater than or equal to 30 pleats per 100 mm, or greater than or equal to 35 pleats per 100 mm. In some embodiments, a filter media has a pleat density of less than or equal to 40 pleats per 100 mm, less than or equal to 35 pleats per 100 mm, less than or equal to 30 pleats per 100 mm, less than or equal to 28 pleats per 100 mm, less than or equal to 25 pleats per 100 mm, less than or equal to 20 pleats per 100 mm, less than or equal to 15 pleats per 100 mm, less than or equal to 10 pleats per 100 mm, or less than or equal to 6 pleats per 100 mm. Combinations of the above-referenced ranges are also possible (e.g., greater than or equal to 5 pleats per 100 mm and less than or equal to 100 pleats per 100 mm, greater than or equal to 6 pleats per 100 mm and less than or equal to 100 pleats per 100 mm, or greater than or equal to 25 pleats per 100 mm and less than or equal to 28 pleats per 100 mm). Other ranges are also possible.

Other pleat heights and densities may also be possible. For instance, filter media within flat panel filters may have pleat heights between ¼ in and 24 in, and/or pleat densities between 1 pleat/in and 50 pleats/in. As another example, filter media within cartridge filters or conical filters may have pleat heights between ¼ in and 24 in and/or pleat densities between ½ pleats/in and 100 pleats/in. In some embodiments, pleats are separated by a pleat separator made of, e.g., polymer, glass, aluminum, and/or cotton. In other embodiments, the filter element lacks a pleat separator. The filter media may be wire-backed, or it may be self-supporting.

### Example 1

This Example describes cross-lapped carded and calendered non-woven fiber webs of the first type and compares their physical properties to other layers.

Four non-woven fiber webs (Sample 1, Sample 2, Sample 3, and Sample 4) were formed from the furnishes shown in Table 1 by performing a cross-lapped carding process followed by a calendering process. The samples were calendered at elevated temperatures (e.g., as shown in Table 1) using a line speed of 9 ypm and a working or nip pressure of 70 N/mm.

TABLE 1

| Fiber Type | Sample 1 | Sample 2 | Sample 3 | Sample 4 |
|---|---|---|---|---|
| Bicomponent PET fibers (14.3 micron | 60% | 60% | 60% | — |
| diameter; 1.5 inch length) | | | | |
| Monocomponent PET fibers (9.6 micron | 40% | 40% | 40% | 40% |
| diameter; 1.5 inch length) | | | | |
| Bicomponent PET fibers (12.4 micron | — | — | — | 40% |
| diameter; 1.5 inch length) | | | | |
| Average fiber diameter (microns) | 12.64 | 12.64 | 12.64 | 11.36 |
| Calender temperature (° C.) | 140 | 140 | 120 | 120 |

Table 2 shows selected physical properties of Samples 1-4 and of a commercially available woven PET mesh of a type designed for use as a single layer filter for wastewater applications in which a high flow rate of contaminated water is desirable and for which it is desirable to remove small contaminant particles. As shown in Table 2, Samples 1-4 exhibited higher retentions of silica dirt and monodisperse polystyrene spheres compared to the commercially available woven PET mesh. Accordingly, cross-lapped carded non-woven fiber webs may exhibit enhanced performance in comparison to single layer meshes for certain applications.

TABLE 2

| | Commercial | | | | |
|---|---|---|---|---|---|
| | PET mesh | Sample 1 | Sample 2 | Sample 3 | Sample 4 |
| Basis weight (gsm) | 48.5 | 157 | 132 | 161 | 131 |
| Thickness (mils) | 2.3 | 14.6 | 12.3 | 16.6 | 10.3 |
| Air permeability (CFM) | 54.3 | 29.3 | 36.5 | 37 | 27.5 |
| Dry Mullen burst strength (lb/in²) | — | 152 | 155 | 115 | 161 |
| Tensile strength in the | 36.2 | 42.3 | 38.9 | 24.5 | 42.2 |
| machine direction (lb/in) | | | | | |
| Elongation at break in the | 25.1 | 10 | 10.3 | 6.9 | 10.1 |
| machine direction (%) | | | | | |
| Tensile strength in the | 36 | 45.1 | 44.4 | 32.2 | 45.5 |
| cross direction (lb/in) | | | | | |
| Dry elongation at break | 24.8 | 13.6 | 12.8 | 10.4 | 11.7 |
| in the cross direction (%) | | | | | |
| Mean flow pore size (microns) | 8.5 | 14.4 | 14.1 | 14.4 | 12.5 |
| Maximum pore size (microns) | 14.2 | 35 | 35.5 | 37 | 29.1 |
| Silica dirt retention (%) | 14.5 | 14.9 | 20.5 | 22.2 | 23.1 |
| Silica dirt solution | 353 | 231 | 190 | 207 | 194 |
| flow rate (mL/min) | | | | | |
| Monodisperse polystyrene | 0.2 | 15.3 | 11.8 | 10.5 | 15.4 |
| sphere retention (%)* | | | | | |
| Monodisperse polystyrene sphere | 480 | 186 | 229 | 320 | 233 |
| solution flow rate (mL/min) | | | | | |

*Measured by the method described for non-woven fiber webs of the first type.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A carded non-woven fiber web, comprising:
monocomponent synthetic fibers; and
multicomponent fibers, wherein:
the carded non-woven fiber web has a ratio of maximum pore size to mean flow pore size of less than or equal to 2.5; and
the carded non-woven fiber web comprises fibers having an overall average fiber diameter of less than or equal to 25 microns.

2. A non-woven fiber web, comprising:
monocomponent synthetic fibers; and
multicomponent fibers, wherein:
the non-woven fiber web has a ratio of maximum pore size to mean flow pore size of less than or equal to 2.5; and
the non-woven fiber web has a ratio of dry tensile strength in a machine direction to dry tensile strength in a cross direction of less than or equal to 2.

3. A non-woven fiber web, comprising:
monocomponent synthetic fibers; and
multicomponent fibers, wherein:
the non-woven fiber web has a ratio of maximum pore size to mean flow pore size of less than or equal to 2.5; and
the non-woven fiber web has a surface roughness of less than or equal to 1000 microns.

4. A carded non-woven fiber web as in claim 1, wherein the carded non-woven fiber web is cross-lapped carded.

5. A carded non-woven fiber web as in claim 1, wherein the carded non-woven fiber web is calendered.

6. A carded non-woven fiber web as in claim 1, wherein synthetic fibers make up 100 wt % of the fibers in the carded non-woven fiber web.

7. A carded non-woven fiber web as in claim 1, wherein the monocomponent synthetic fibers have an average diameter of less than or equal to 40 microns.

8. A carded non-woven fiber web as in claim 1, wherein the monocomponent synthetic fibers comprise a poly(olefin) and/or a poly(ester).

9. (canceled)

10. A carded non-woven fiber web as in claim 1, wherein the multicomponent fibers have an average diameter of less than or equal to 40 microns.

11. A carded non-woven fiber web as in claim 1, wherein the carded non-woven fiber web has a mean flow pore size of less than 20 microns.

12. A carded non-woven fiber web as in claim 1, wherein the carded non-woven fiber web has a ratio of a dry tensile strength in the machine direction to a dry tensile strength in the cross direction of less than or equal to 2.

13. A carded non-woven fiber web as in claim 1, wherein the carded non-woven fiber web has an air permeability of greater than or equal to 20 CFM.

14. (canceled)

15. A carded non-woven fiber web as in claim 1, wherein the carded non-woven fiber web has a dry tensile strength of greater than or equal to 25 lb/in in a machine direction and/or in a cross direction.

16. (canceled)

17. A carded non-woven fiber web as in claim 1, wherein the carded non-woven fiber web has a basis weight of greater than or equal to 50 gsm and less than or equal to 400 gsm.

18. A carded non-woven fiber web as in claim 1, wherein the carded non-woven fiber web has a thickness of greater than or equal to 5 mils and less than or equal to 20 mils.

19. (canceled)

20. A carded non-woven fiber web as in claim 1, wherein the carded non-woven fiber web has a surface roughness of less than or equal to 1000 microns.

21. (canceled)

22. A carded non-woven fiber web as in claim 1, wherein the carded non-woven fiber web further comprises undrawn fibers.

23-36. (canceled)

37. A filter media comprising the carded non-woven fiber web of claim 1, further comprising:
a first non-woven fiber web disposed on the carded non-woven fiber web; and
a second non-woven fiber web disposed on the first non-woven fiber web.

38-39. (canceled)

40. A filter media as in claim 37, wherein the first non-woven fiber web comprises fibers having an average fiber diameter of less than or equal to 0.5 microns and a maximum pore size of less than or equal to 5 microns.

41. (canceled)

42. A filter media as in claim 37, wherein the second non-woven fiber web has a maximum pore size of greater than or equal to 3 microns and less than or equal to 70 microns and an average fiber diameter of greater than or equal to 0.5 microns and less than or equal to 10 microns.

43-54. (canceled)
